(19) United States
(12) Patent Application Publication
(10) Pub. No.: US 2001/0025377 A1
(43) Pub. Date: Sep. 27, 2001

(54) High bandwidth transmission system and method having local insertion, delay play and demand play

(76) Inventor: Larry W. Hinderks, Reno, NV (US)

Correspondence Address: NIXON & VANDERHYE P.C., 8th Floor, 1100 North Glebe Road, Arlington, VA, 22201, US

(21) Appl. No.: 09/750,181

(22) Filed: Dec. 29, 2000

Related U.S. Application Data
(60) Provisional application No. 60/173,834, filed on Dec. 30, 1999.

(51) Int. Cl. H04N 7/173

(52) U.S. Cl. 725/109; 725/32

(57) ABSTRACT

Digital data for broadcasting or multicasting is placed in IP protocol to generate IP digital data which is then transmitted from a multicast content source site to a remote Internet point-of-presence (POP) through a dedicated transmission channel substantially separate from the Internet backbone. Local commercials and/or other IP digital data may be inserted into the received IP digital data stream at the remote Internet POP. The IP digital data signal stream received at the POP may also be stored and/or delayed at the POP for later playback and broadcasting/multicasting to recipients having a computer or other IP data receiving equipment connected to the Internet but distal from the POP. Further aspects of the invention encompass methods and apparatus for scheduling and recording IP multicast information for later “on demand” playback to a recipient user/customer.

### RELATED APPLICATIONS

This application claims the benefit of U.S. Provisional Application, entitled “High Bandwidth Transmission System And Method Having Local Insertion, Delay Play And Demand Play”, to Larry W. Hinderks, Ser. No. 06/173,834, filed Dec. 30, 1999, the entire content of which is hereby incorporated by reference into this specification.

### BACKGROUND OF THE INVENTION

During the 1970's and 1980's, the defense industry encouraged and developed an interconnecting network of computers as a backup for transmitting data and messages in the event that established traditional methods of communication fails. University mainframe computers were networked in the original configurations, with many other sources being added as computers became cheaper and more prevalent. With a loose interconnection of computers hardwired or telephonically connected across the country, the defense experts reasoned that many alternative paths for message transmission would exist at any given time. In the event that one message path was lost, an alternative message path could be established and utilized in its place. Hence, it was the organized and non-centralized qualities of this communications system which made it appealing to the military as a backup communication medium. If any one computer or set of computers was attacked or disconnected, many other alternative paths could eventually be found and established.

This interconnection of computers has since been developed by universities and businesses into a worldwide network that is presently known as the Internet. The Internet, as configured today, is a publicly accessible digital data transmission network which is primarily composed of terrestrial communications facilities. Access to this worldwide network is relatively low cost, and hence, it has become increasingly popular for such tasks as electronic mailing and weather page browsing. Both such functions are badge or file transfer oriented. Electronic mail, for instance, allows a user to compose a letter and transmit it over the Internet to an electronic destination. For Internet transfers, it s relatively unimportant how long each file transfer takes as long a˜ it is reasonable. The Internet messages are routed, not through a fixed path, but rather through various interconnected computers until they have reached their destination. During heavy message load periods, messages will be held at various internal network computers until the pathways cleared for new transmissions. Accordingly, Internet transmissions are effective, but cannot be relied upon for time sensitive applications.

Web pages are collections of data including text, audio, video/audio, and interlaced computer programs. Each web page has a specific electronic site destination which is accessed through a device known as a web server, and can be accessed by anyone through via Internet. Web page browsing allows a person to inspect the contents of a web page on a remote server to glean various information contained therein, including for instance product data, company backgrounds, and other such information which can be digitized. The remote server data is access by a local browser and the information is displayed as text, graphics, audio, and video.

The web browsing process, therefore, is a two-way data communication between the browsing user who has a specific electronic address or destination, and the web page, which also has a specific electronic destination. In this mode of operation, as opposed to electronic mail functions, responsiveness of the network is paramount since the user expects a quick response to each digital request. As such, each browsing user establishes a two-way data communication, which ties up an entire segment of bandwidth on the Internet system.

Recent developments on the Internet include telephone, videophone, conferencing and broadcasting applications. Each of these technologies places a similar real-time demand on the Internet. Real-time Internet communication involves a constant two-way throughput of data between the users, and the data must be received by each user nearly immediately after its transmission by the other user. However, the original design of the Internet to did not anticipate such real-time data transmission requirements. As such, these new applications have serious technical hurdles to overcome in order to become viable.

Products which place real-time demands on the Internet will be aided by the introduction of and updated hardware interconnection configuration, or backbone,” which provides wider bandwidth transmission capabilities. For instance, the MCI backbone was recently upgraded to 622 megabytes per second. Regardless of such increased bandwidth, the interconnection configuration is comprised of various routers which may still not be fast enough, and can therefore significantly degrade the overall end performance of the traffic on the Internet. Moreover, even with a bandwidth capability of 622 megabytes per second, the Internet backbone can maximally carry only the following amounts of data: 414-1.5 mbs data streams; 4,859-128 kbs data streams; 21597-28.8 kbs data streams; or combinations thereof. While this has anticipated as being sufficient by various Internet providers, it will quickly prove to be inadequate for near-future applications.

Internal networks, or Intranet sites, might also be used for data transfer and utilize the same technology as the Internet. Intranets, however, are privately owned and operated and are not accessible by the general public. Message and data traffic in such private networks is generally much lower than more crowded public networks. Intranets are typically much more expensive for connect time, and therefore any related increase in throughput comes at a significantly higher price to the user.

To maximize accessibility of certain data, broadcasts of radio shows, sporting events, and the like are currently provided via Internet connections whereby the broadcast is accessible through a specific web page connection. However, as detailed above, each web page connection requires a high throughput two-way connection through the standard Internet architecture. A given Internet backbone will be quickly overburdened with users if the entire set of potential broadcasters across world began to provide broadcast services via such web page connections. Such broadcast methods through the Internet thereby prove to be ineffective given the two-way data throughput needed to access web pages and real-time data.

Furthermore, broadcasts are typically funded and driven by advertising concerns. However, a broadcast provided through a centralized location, such as a web page for a real-time Internet connection, will be limited by practical concerns to offering only nationally advertised products, such as Coke or Pepsi. Since people might be connected to this web page from around the world, local merchants would have little incentive to pay to advertise to distant customers outside of their marketing area. Local merchants, on the other hand, would want to inject their local advertising into the data transmission or broadcasts in such a way not currently available the Internet.

There is an enormous demand for the delivery of large amounts of video/audio content to a large number of listeners. Unfortunately, conventional broadcast systems, such as radio and TV, can only deliver a relatively small number of “channels” to a large number of listeners. The conventional delivery mechanism of such content used is well known to most consumers: the broadcaster transmits programs and the listener must “tune in” at the proper time and channel to receive a desired show.

An alternative arrangement which is much more appealing to consumers is a method of content delivery that provides audio/video content to a consumer “on demand.” This arrangement transports an audio/video program or show from a central repository (server) to an individual user (client) in direct response to the user's request. Such “on Demand” systems have been attempted by the cable industry. For example, to initiate a request, the cable user selects from a published list of candidate programs and requests that the system deliver the selected program.

This “on demand” model of content delivery has placed two significant requirements on the delivery system. First, there is typically a direct connection between each content storage device (server) and each listener (client). The phone system is an example of such a point-to-point interconnection system. Another example of such an interconnection system is the Internet, which is also largely based on the terrestrial telecommunications networks. Second, the server typically seeks to provide the capability of delivering all the programs to the requesting clients at the time that the client demands the programming.

Although the these foregoing requirements can be met using the Internet, the Internet is not particularly suitable for many types of high bandwidth or on-demand systems. On the Internet, users most often share a terrestrial or perhaps even extraterrestrial or wireless communications infrastructure and, as a result, the total overall throughput at any time is limited. In other words, the Internet is a type of communications “party line” that is shared by a large number of users and each subscriber must wait for the “line” to be free before he/she can send data. Since the signal from a server is generally a high bandwidth signal that includes multimedia content, any degradation of the throughput bandwidth from the server to the clients can result in an annoying disruption in the continuity of streamed video/audio and/or audio content as perceived by the clients.

Successful transmission of real-time streaming multimedia content, therefore, requires sufficient transmission bandwidth between the server and the client to prevent signal degradation and disruption. Since standard IP transmission facilities are a party line, attempts have been made to impose a quality of service (QOS) into this dominantly party-line transmission structure. One such QOS feature is the bandwidth reservation protocol called “RSVP.” The RSVP protocol must be active in each network element along the path from the client to the server for it to be effective. Until RSVP is fully enabled, QOS cannot be guaranteed.

Once RSVP is fully deployed, then the mechanical process of reserving bandwidth will be possible to some degree. Nevertheless, even with RSVP, the problem remains that the Internet infrastructure provides limited transmission bandwidth. In this regard, consider the case where the sum of all bandwidth reservations exceeds available transmission bandwidth. To reduce the excessive use of bandwidth reservation, transmission providers anticipate transmission charges based on the amount of bandwidth reserved. This bandwidth charge is not in the spirit of today's free connectivity.

Another example of the limitations inherent in the finite throughput of the Internet is the generally limited audience size for a given transmission link. For example, if there is a 622 megabit/second (mbs) link from an Internet server in New York to a number of clients in Los Angeles and each client requires a separate 28.8 kilobitsec (kbs) connection to the server, then this link can only support about 22,000 clients, a relatively small number of clients when compared to the cost of a server capable of supplying the 622 mbs data content. The costs further escalate and the client audience size capability further diminishes as each client connects to the server using higher bandwidth modems or the like. Still further, the same large demand is placed on the server if each of the 22,000 clients requests the same program but at different times or if each of the clients request a different program at the same, or nearly the same time. The large bandwidth requirements (622 mbs) to supply a relatively small number of clients (22,000) coupled with the stringent requirements placed on the server to supply the content to each client has created problems that “on-demand” systems have yet to economically overcome.

A recent development in LAN/WAN technology is called “multicasting.” multicasting in LAN/WAN parlance means that only one copy of a signal is used until the last possible moment. For example, if a server in New York wants to deliver the same data to someone in Kansas City, Dallas, San Francisco, and Los Angeles then only one signal needs to be sent o Kansas City. There it would be replicated and sent separately to San Francisco, Los Angeles, and Dallas. Thus the transmission costs and bandwidth used by the transmission would be minimized and the server in New York would only have to send one copy of the signal to Kansas City. This scenario is illustrated in FIG. 1A.

Multicasting helps to somewhat mitigate the transmission costs but there are still a great number of cases where it provides little optimization. For example, if there is one person in each city in the US that wants to view the same program generated by the server in New York, then the server must send the signal to all those cities, effectively multiplying the amount of bandwidth used on the network. As such, the transmission is still expensive. Further, the multicast system model breaks down at high bandwidths and during periods of low data throughput within the Internet infrastructure, resulting in annoying degradation of the transmission content.

Another issue is distribution of information between autonomous systems. This is called peering. FIG. 1B shows three autonomous simple systems labeled ASO, AS1 and AS2. These autonomous systems are self contained networks consisting of host computers (clients and servers) interconnected by transmission facilities. Each autonomous system is connected to other autonomous systems by peering links. These are shown in FIG. 1B by the transmission facilities labeled PLO1, PLO2 and PL12.

Peering allows a host in one autonomous system to communicate with a host in a different autonomous system. This requires that the routers at the end of the peering links know how to route traffic from one system to the other. Special routing protocols, such as boundary gateway protocol, enable the interconnection of autonomous systems. For the purpose of this explanation, assume that host H1 in ASO wants to communicate with host H2 in AS1 and H3 in AS2. To accomplish such, H1 communicates with PLO1 to reach H2 and PLO2 to reach H3. If host H1 wants to multicast a message to multiple hosts in each of the autonomous systems, then boundary routers involved must understand the multicast protocols. Backbone providers that form each of autonomous systems are reluctant to enable multicast over their peering links because of the unknown load placed on boundary routers and billing issues related to this new traffic which originates outside of their autonomous systems.

The inventors of the present invention have recognized that a different approach must be taken to provide a large amount of content to a large number of listeners. In their prior art published European patent application, the present inventors proposed a system that abandons the “on-demand’ model and point-to-point connection models. In their place, the present inventors combined, among other things, a particular, unique “broadcast” model with localized multicast connections that selectively allow a client to receive the high bandwidth content of the broadcast.

As described and explained in commonly assigned U.S. Pat. No. 6,101,180 to Donahue et al., entitled “High Bandwidth Broadcast System Having Localized multicast Access To Broadband Content”, the entire content of which is incorporated by reference into this specification, a conventional “broadcast model” assumes that a server delivers specific content at specific times on a specific channel, for example, as is currently done for conventional radio and television broadcasts. A “near on demand” content delivery model can be affected by playing the same content at staggered times on different transmission channels, such as for example, dedicated satellite broadcast channels. Localized receivers may receive the satellite broadcast channels and convey the content over a network using a multicast protocol that allows any client on the network to selectively access the broadcast content from the single broadcast. This single broadcast arrangement provides, in effect, an overlay network that bypasses congestion and other problems in the existing Internet infrastructure.

As also explained in the above referenced Donahue et al. patent, FIG. 1C shows how host H1 may multicast directly to recipients H2 and H3 via satellite or another dedicated link separate from the backbone of the Internet. This type of interconnection bypasses the peering links and the resulting congestion and billing issues. However, this type of interconnection maintains a “party-line” type sharing of bandwidth in the dedicated link. It is also, in essence, generally part of a two-way connection adapted to provide TCP/IP information exchange in cooperation with, typically, a terrestrial back channel from the satellite reception entity to the entity providing the content for transmission through the satellite or other dedicated link.

A commonly assigned prior European application, EP ______, was based at least partially on the discovery that the use of a separate dedicated link has certain advantages and implements a solution in a unique manner. Accordingly, the present invention provides a data transmission system capable of sending multiple channels of broadcast or multicast data or “content” to receiving computers without being delayed or impaired by the bandwidth and constraints of two-way Internet connections.

The inventors of the presently disclosed invention have also recognized that one problem with such a system is that, although “near-on-demand” delivery is very advantageous, it does not by itself allow for the level of flexibility an Internet user may desire in playing or accessing content on demand and, for example, long after the near-on-demand delivery has terminated for any given content.

Another problem recognized by the inventors is that the broadcast model itself is unduly limited in its ability to meet the demands, and satisfy the needs of, providers of localized or regionalized advertising and similar types of localized content. The satellite broadcast model, for example, typically delivers the same content to all users nationally. This creates a significant problem for distribution of localized content, such as locally tailored advertising, through such a non-localized broadcast system. The providers of such locally tailored advertising frequently do not purchase advertising in such non-localized broadcasts, and the potential market demand for advertising through such mediums is correspondingly limited.

Similarly, those who seek to provide locally-tailored advertising have had to seek other avenues (such as dealing individually with localized broadcasters in each localized market) in order to advertise. Such effort is time consuming and expensive. Moreover, even when pursuing locally-tailored advertising, advertisers are often forced by the available traditional media to purchase advertising in unnecessarily large regions or for delivery to recipients who are not as targeted as might be desired by the advertiser. The method and system of the present invention provides a much needed solution to the above mentioned problems and other problems encountered in the high bandwidth multicasting environment.

### SUMMARY OF THE INVENTION

The applicants have developed novel arrangements for multicasting and/or broadcasting digital data to client/user recipients having an Internet connection or Internet access. These arrangements include methods and apparatus for placing digital data for multicasting in IP protocol to generate IP digital data which is then transmitted from a multicast content source site to a remote Internet point-of-presence (POP) through a dedicated transmission channel substantially separate from the Internet backbone. The dedicated transmission channel may be, for example, a satellite communications channel. Local commercials and/or other IP digital data may be inserted into the received IP digital data stream at the remote Internet POP. The IP digital data signal stream received at the POP may also be stored and/or delayed at the POP for later playback and broadcasting/multicasting to one or more recipients having a computer or other IP data receiving equipment connected to the Internet but distal from the POP. Further aspects of the invention encompass methods and apparatus for scheduling and recording IP multicast information for later “on demand” playback to a recipient user/customer.

As will be readily recognized, the disclosed method and apparatus eliminate, or reduce the severity of, problems discussed above in connection with existing multicast or broadcasting systems. Moreover, since the principal equipment used to implement the present invention is disposed at the point of presence of the Internet Service Provider, additional user/recipient-end equipment is not required and, hence, the common psychological reluctance of an Internet user to purchase extraneous multicast equipment is avoided. Other aspects and features of the system and method of the present invention will become apparent upon further review of the specification and drawings disclosed herein and include such exemplary advantages as:

support for millions of simultaneous viewers of join-in-progress video/audio channels and/or listeners to audio channels in conjunction with the Internet;

operates without need of Internet users to have satellite receivers, satellite antennas, or satellite cabling;

works within existing Internet web browser technologies;

provides a branded “open portal” to allow aggregation of multicast content providers through hyperlinks to their web sites;

provides conditional access for subscription and PPV revenue models;

permits data tracking of content usage by recipient consumers;

enables broadband data rates to users;

automatically determines the recipient user's data rate;

displays video/audio embedded within a web page and/or allows the received video/audio to be “torn away” from the web page;

provides live and/or pre-recorded “national” and “local” video/audio content distribution;

allows “national” and “local” advertisement insertion and/or other IP digital data insertion into live and prerecorded video/audio content;

provides local capture and replay of broadcast content at a later time;

allows interactivity through Internet application technology such as web pages and chat;

allows national, regional, and localized content, advertisement, and web pages in conjunction with Internet distribution of content; and

provides a multicast and/or broadcast system for IP digital data content that is easily and economically scalable without requiring replacement of existing equipment (and with possibly only minimal expansion of existing equipment, e.g., adding only additional satellite receiver and localized routing equipment at each receiving location) when upward scaled by, for example, addition of audio and/or video channels exceeding the capability of the existing receiver and routing network at the receiving locale.

### BRIEF DESCRIPTION OF THE DRAWINGS

FIGS. 1A and 1B illustrate example conventional inter-city Internet communications links between host computers;

FIG. 1C illustrates an example alternative data delivery arrangement to the system of FIG. 1B;

FIG. 1D illustrates an example conventional digital communications network architecture;

FIG. 2 illustrates an example hybrid broadcast multicast network arrangement in accordance with one aspect of the present invention;

FIG. 3 illustrates an example Internet Protocol address mapping arrangement at an Internet Service Provider;

FIG. 4 is a block diagram illustrating an example file server station arrangement suitable for use with conventional Internet communications systems;

FIG. 5 is a block diagram illustrating an example embodiment of a routing station arrangement and its connection within a network domain in accordance with one aspect of the present invention;

FIGS. 6 and 7 are schematic block diagrams illustrating an example routing station and its connection at an Internet Service Provider in accordance with an aspect of the present invention;

FIG. 8a is a schematic block diagram illustrating an example of an uplink site suitable for use in the network of FIG. 2;

FIG. 8b is a schematic block diagram illustrating an example of a downlink site suitable for use in the network of FIG. 2;

FIGS. 9-11 are schematic block diagrams illustrating example downlink sites suitable for use in the network of FIG. 2;

FIGS. 12 and 13 are block diagrams illustrating the modularization of components at a downlink site and example interconnection arrangements;

FIGS. 14A and 14B are schematic block diagram s illustrating example multicast system arrangements for an ISP having distributed POPs that are interconnected with one another;

FIGS. 15 and 16 are schematic block diagrams illustrating the basic functional components of an example IPMS;

FIG. 17 illustrates a packet protocol that may be used by the controller unit to communicate through the monitor and control interface software;

FIG. 18 is a schematic block diagram illustrating the basic functional components of an example transponder unit;

FIG. 19 is a schematic block diagram illustrating the basic functional components of an example transponder unit including a descrambler;

FIG. 20 is a schematic block diagram illustrating the basic functional components of an example of a packet filter used in the transponder unit of FIG. 18;

FIGS. 21-26 are schematic block diagrams illustrating example configurations for digital communications networks having an IPMS in accordance with an aspect of the present invention;

FIG. 27 is a schematic block diagram illustrating a conventional simple ISP configuration;

FIG. 28 is a schematic block diagram illustrating a conventional large ISP configuration;

FIG. 29 is a schematic block diagram illustrating an example configuration of a large ISP having multimedia insertion capabilities in accordance with one aspect of the present invention;

FIG. 30 is a block diagram illustrating an example web page layout for multicast content display and control at a user/recipient computer in accordance with one aspect of the present system;

FIG. 31 is a schematic block diagram illustrating a simple video/audio content distribution system arrangement;

FIG. 32 is a schematic block diagram illustrating a video/audio content distribution system arrangement having local servers for video/audio distribution;

FIG. 33 is a schematic block diagram illustrating example hardware configuration of a local server for insertion of video/audio content;

FIG. 34 is a schematic block diagram illustrating an example arrangement for local multicast content insertion;

FIG. 35 is a schematic block diagram illustrating an example arrangement for local content insertion in a multicast and Internet system;

FIG. 36 is a diagram illustrating an example “delay play” multicast system arrangement;

FIG. 37 is a schematic block diagram illustrating an example arrangement of satellite uplink equipment for a multicast system;

FIG. 38 is a schematic block diagram illustrating an example arrangement of satellite downlink equipment for a multicast system;

FIG. 39 is a schematic block diagram illustrating an example equipment configuration for a satellite backbone multicast system;

FIG. 40 is a functional diagram illustrating an example arrangement for a basic simple multicast transmission system;

FIG. 41 is a time line diagram illustrating reception timing for a single packet measurement system;

FIG. 42 is a time line diagram illustrating reception timing for a multi-packet measurement system;

FIG. 43 is a schematic block diagram illustrating an basic configuration for an example local replay audio/video content distribution system in accordance with one aspect of the present invention;

FIG. 44 is a block diagram illustrating an example configuration of client/recipient software components for a local replay multicast system in accordance with an aspect of the present invention;

FIG. 45 is a schematic block diagram illustrating an example satellite uplink system configuration in accordance with the present invention;

FIG. 46 is an equipment list for an example satellite uplink;

FIG. 47 is a schematic block diagram illustrating example ISP connected satellite downlink equipment arrangement in accordance with the present invention;

FIG. 48 is a schematic block diagram illustrating example NSP connected satellite downlink equipment arrangement in accordance with the present invention;

FIG. 49 is an equipment list for an example satellite downlink;

FIG. 50 is a schematic block diagram illustrating an example national video/audio content distribution architecture arrangement in accordance with the present invention;

FIG. 51 is a schematic block diagram illustrating an example system arrangement for the local co-branding of “national” content in accordance with the present invention;

FIG. 52 is a schematic block diagram illustrating another example system arrangement for the local co-branding of “national” content in accordance with the present invention;

FIG. 53 is a schematic block diagram illustrating an example of local content insertion with local co-branding in accordance with the present invention; and

FIG. 54 is a schematic block diagram illustrating an example of local content and local ad insertion with local co-branding in accordance with the present invention.

### DETAILED DESCRIPTION OF EXAMPLE EMBODIMENTS OF THE INVENTION

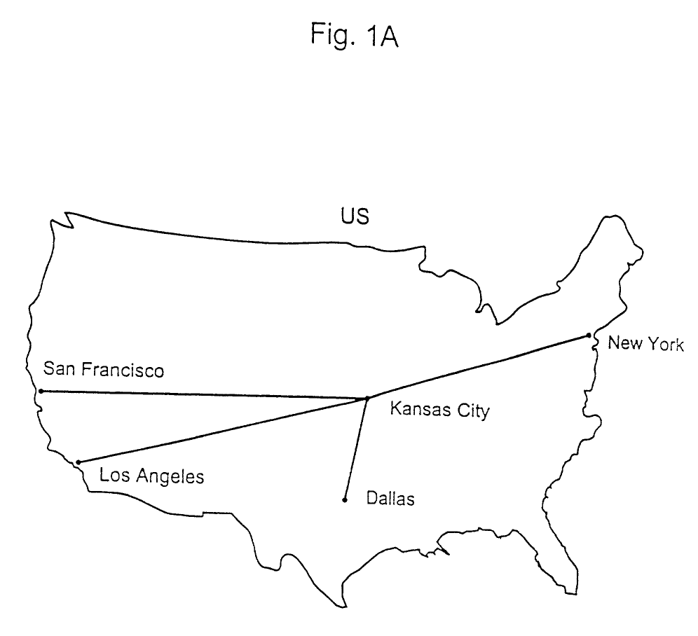

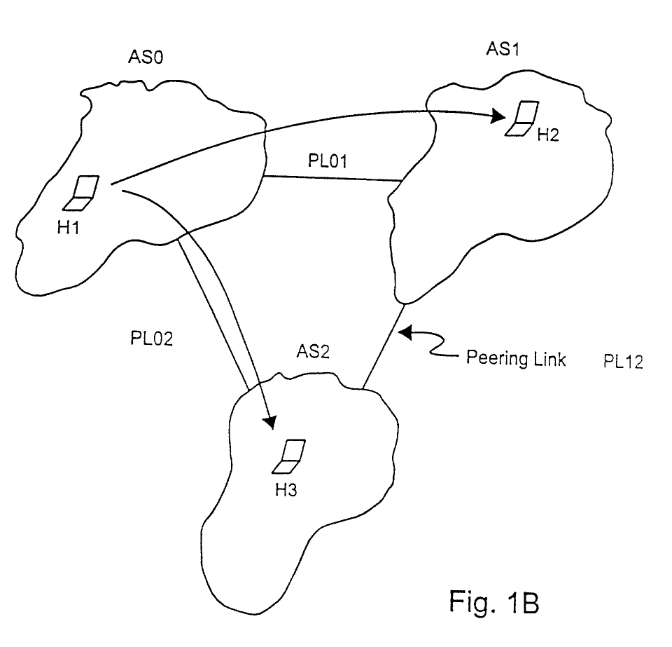

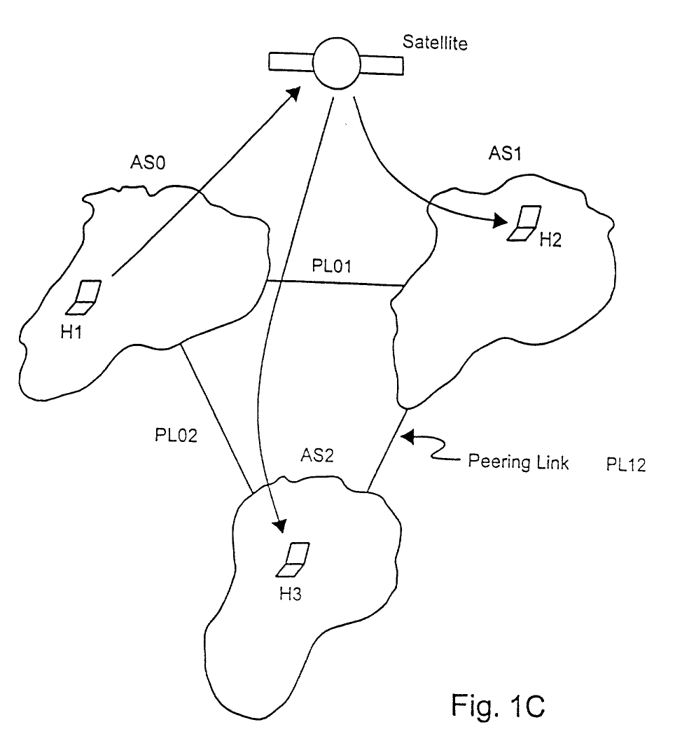

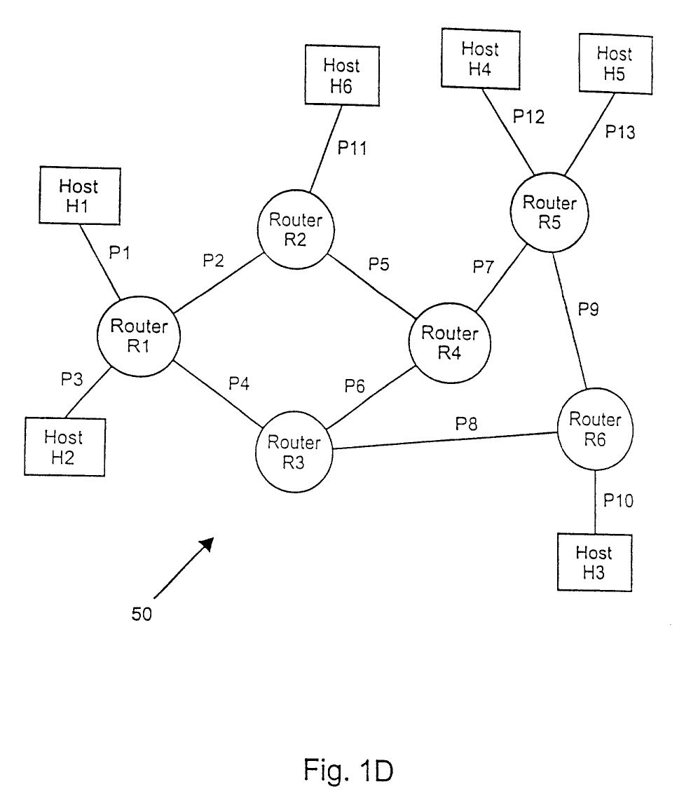

The current networking architecture of today is generally illustrated in FIG. 1D. As illustrated, the network, shown generally at 50, comprises a group of host computers H1-H6 that are interconnected by transmission links P1,P13 and routers R1, R6 to form a LAN/WAN. An aggregated group of hosts is called a domain. Domains are grouped into autonomous systems that are, in-turn, interconnected together to form a network. When these networks span a large geographic area, they are called a wide area network or WAN. An example of this network architecture is the Internet and is illustrated in FIG. 1D.

At each interconnection node is a device called a router, designated here as R1,R6. The function of the router is to receive an input packet of information, examine its source and destination address, and determine the optimal output port for the message. These receive, route determinations, and transmit functions are central to all routers.

If host H1 wants to send a message to host H3, there are a variety of paths that the signal could take. For example, the signal could be transmitted along the transmission path formed by P1-P4-P8-P1O. Other alternatives include the paths formed by P1-P2-P5-P7-P9-P1O or P1-P4-P6-P7-P9-P1O. The function of the router is to determine the next path to take based on the source and destination address. The router might use factors such as data link speed or cost per bit to determine the best path for the message to follow.

As more host computers are brought on-line, more domains are created. Each time a domain is created, any router associated with the domain must announce to its peers that it is present and ready to accept traffic. Conversely, if a domain is deleted, the system must respond by removing the paths and rerouting all messages around the removed domain. In any large network, there will be a constant addition and removal of domains. The success of the network architecture to respond to these changes is at the core of the networking problem. To this end, each router communicates with its peers to announce to the network or networks it services. This implies that a bi-directional link should exist at each router. Terrestrial telephone circuits have traditionally supplied these links on the Internet.

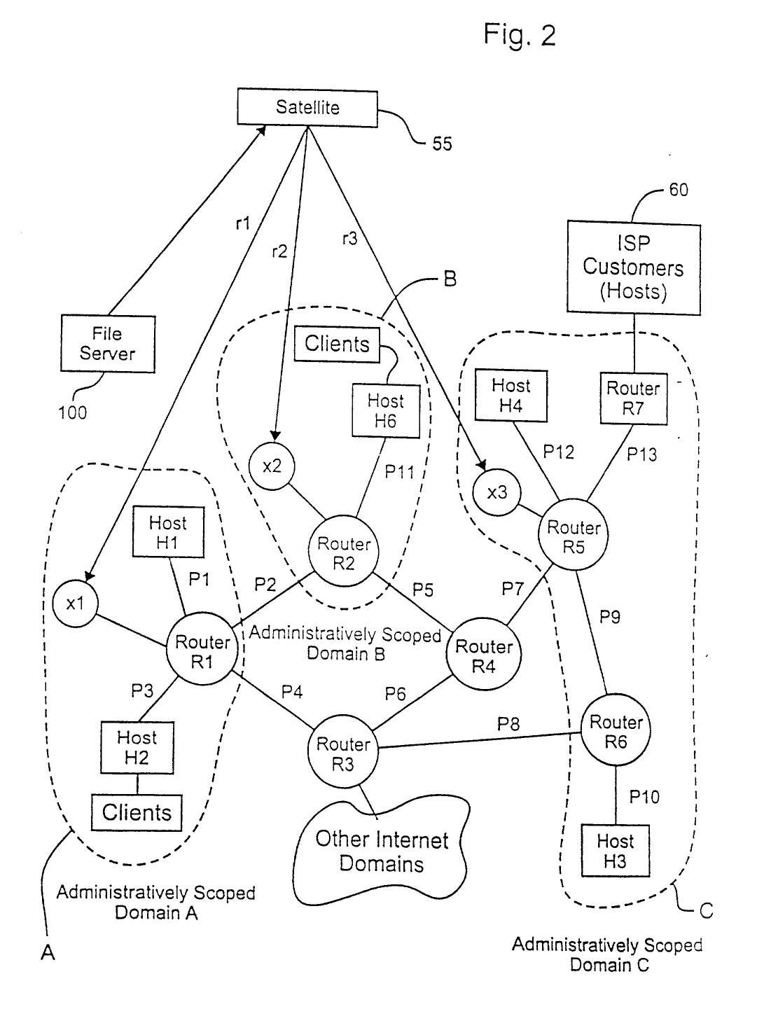

FIG. 2 illustrates a hybrid broadcast/multicast constructed in accordance with one embodiment of the present invention. The system is illustrated in the context of a plurality of interconnected Internet domains A, B, and C. As noted above, a domain is an aggregate of one or more hosts. For example, domain A may be a corporate LAN while domain B may be a LAN at an educational institution or the like. In the illustrated embodiment, domain C is shown as an Internet Service Provider (ISP) that usually sells local access to the Internet through its domain. As such, domain C includes at least one access router R7 having one or more modems through which local but remotely located ISP customers (hosts) 60 connect to the domain through POTS, T1 lines, or other terrestrial links. From domain C, the ISP customers 60 are connected to the Internet.

In the preferred embodiment, a file server station 100 is used to store and transmit broadcast transmissions to a satellite 55. As will be set forth in further detail below, the file server station 100 includes one or more file servers that can provide, for example, multimedia content in TCP/IP format. The multimedia data is then encapsulated in HDLC or similar frame format and modulated to RF for transmission over one or more uplink channels of the satellite 55. The satellite 55 re-transmits the HDSL encapsulated frames on one or more downlink' channels having different carrier frequencies than the uplink channels. The downlink transmissions are concurrently received by domains A, B, and C at local routing stations x1, x2, x3. At each routing station x1, x2, x3, the original TCP/IP data transmitted from the file server station 100 is extracted from the received HDLC frames. The extracted TCP/IP data is selectively supplied to hosts within the domain that have made a request to receive the data.

The communication paths provided by satellite 55 in effect produces an overlay network that bypasses or at least somewhat avoids congestion and limitations in at least some of the existing Internet infrastructure, such as in FIG. 1. Moreover, this overlay network provides dedicated, guaranteed bandwidth for the transmission of multimedia data through satellite 55. In the preferred embodiment, the transmissions from the file server station 100 preferably include one or more multimedia transmissions formatted in accordance with the IP multicast protocol. IP multicast is an extension to the standard IP network-level protocol. RFC 1112, Host Extensions for IP multicasting, authored by Steve Deering in 1989, describes IP multicasting as: “the transmission of an IP datagram to a “host group”, a set of zero or more hosts identified by a single IP destination address. A multicast datagram is delivered to all members of its destination host group with the same ‘best-efforts’ reliability as regular unicast IP datagrams. The membership of a host group is dynamic; that is, hosts may join and leave groups at any time. There is no restriction on the location or number of members in a host group. A host may be a member of more than one group at a time”. In addition, at the application level, a single group address may have multiple data streams on different port numbers, on different sockets, in one or more applications.

IP multicast uses Class D Internet Protocol addresses, those with 1110 as their high-order four bits, to specify groups of IPMS units 120. In Internet standard “dotted decimal” notation, host group addresses range from 224.0.0.0 to 239.255.255.255. Two types of group addresses are supported: permanent and temporary. Examples of permanent addresses, as assigned by the Internet Assigned Numbers Authority (IANA), are 224.0.0.1, the “all-hosts group” used to address all IP IPMS units 120 on the directly connected network, and 224.0.0.2, which addresses all routers on a LAN. The range of addresses between 224.0.0.0 and 224.0.0.255 is reserved for routing protocols and other low-level topology discovery or maintenance protocols. Other addresses and ranges have been reserved for applications such as 224.0.13.000 to 224.0.13.255 for Net News (a text based service). These reserved IP multicast addresses are listed in RFC 1700, “Assigned Numbers.” Preferably, transmissions from the file server 100 containing related multimedia content are transmitted using a permanent address. Even more preferably, the same multimedia content is provided by the file server system 100 at multiple data rates using different permanent addresses.

For example, a multimedia file containing an automobile commercial may be concurrently transmitted for reception at a 28.8 KB data rate, a T1 data rate, an ADSL data rate, etc. The 28.8 KB transmission is transmitted using a first group of one or more permanent addresses. The T1 data rate transmission is transmitted using a second group of one or more permanent addresses, wherein the first group differs from the second group. In this manner, a client having a high speed Internet connection may chose to receive the more desirable high data rate transmissions while a client having a lower speed Internet connection is not precluded from viewing the content due to the availability of the lower speed data transmissions. Additionally, a corresponding web page may be concurrently transmitted along with the multicast data or along the backbone of the Internet.

If permanent multicast addresses are not available, the TCP/IP addresses used for the broadcast transmissions may use a block of addresses that are normally designated as administratively scoped addresses. Administratively scoped addresses are used for the transmission of commands and/or data within the confines of a domain for administrative processes and are not supplied outside of the scope of the domain. In other words, any broadcast transmissions received using these administratively scoped addresses desirably remains within the bounds of the domain in which it is received. All addresses of the form 239.x.y.z are assumed to be administratively scoped. If administratively scoped addresses are used, provisions must be made to ensure that the domain does not use an administratively scoped address that is within the designated broadcast block for other system functions. This may be accomplished in one of at least two different manners. First, the domain can be reprogrammed to move the administratively scoped address used for the other system function to an administratively scoped address that does not lie within the broadcast block.

Second, the routing station may perform an address translation for any administratively scoped addresses within the broadcast block that conflict with an administratively scoped address used for other purpose by the domain. This translation would place the originally conflicting address outside the conflict range but still maintain the address within the range of permissible administratively scoped addresses. As above, the same multimedia content is transmitted concurrently using different transmission data rates.

With respect to the use of administratively scoped addresses, assume that the system will utilize a block of addresses that contain 65,535 addresses (16 bits of address space). This block will utilize a predetermined, default address block. For the sake of this description, assume that the system default address space is defined as 239.117.0.0 to 239.117.255.255. This address space is defined by fixing the upper two bytes of the address space (in this case 239.117) while merely varying the lower two bytes of data to allocate or change the address of a channel of TCP/IP multimedia data. This addressing scheme, in and of itself, will provide the system with 64K possible channels but it may place restrictions on the ISP environment since they would be required to have a dedicated block of 64K address space, one in which none of the 64K addresses are being used by other applications. This may not always be feasible. In order avoid this kind of limitation, the system may only actually utilize the first 16K of the predefined address space. This will allow 16K channels for the entire system, which corresponds to a minimum aggregate data rate of 470 MHz (assuming every channel is running the minimum data rate of 28.8 kbps).

Even with the limited number of addresses, there are still two potential types of problems within the ISP environment. In the first type of problem, a limited number of the system broadcast addresses are already in use at the ISP or other domain type. In the second type of potential problem, a large block of the system broadcast address space is being used at the ISP or other domain type. In either case, the IPMS must be able to provide a solution for these two types of problems. These two cases are preferably addressed differently:

The most likely address conflict to be encountered in an ISP is the first one noted above, designated here as the “limited address” conflict. This type of conflict occurs when a single address or several isolated addresses within the broadcast address range are already allocated within the ISP or other domain type. The fact that only 16K addresses out of the 64K address block are used will provide a means for routing “around” these limited address conflicts.

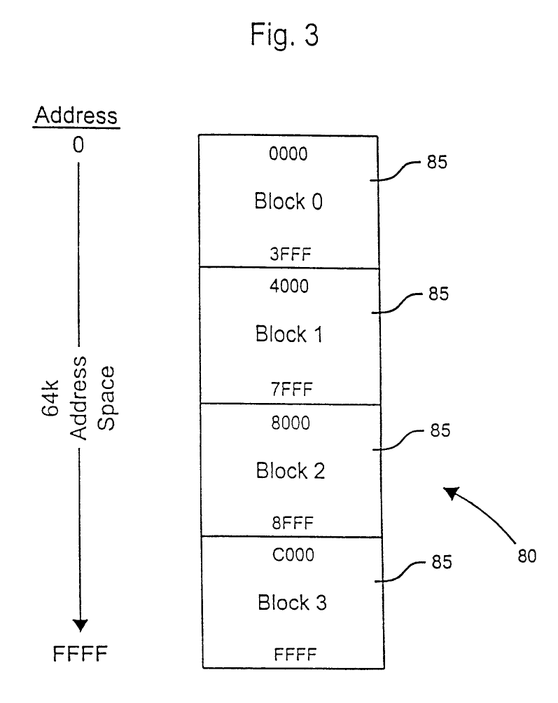

As illustrated in FIG. 3, the 64K address space shown generally at 80 will be divided into four 16K address blocks 85. The following diagram shows how the address blocks are defined. The system default addresses are all located in block 0 which begins at address 0 of the administratively scoped addresses.

The ISP or domain will setup a “routing table” within a routing station of the domain that indicates all of the administratively scoped addresses used within the ISP or domain. The routing station is programmed to re-route addresses with conflicts to the next available address block. For example, if the ISP has address 239.117.1.11 already assigned, the routing station routes this address to the next available block. The next available address block is found by adding 64 to the second byte of the IP address. For this service the next address would be 239.117.65.11. If this address is free, this is where the routing station re-routes the data associated with the conflicting address. Four alternate addresses may be assigned for rerouting a single channel having a conflicting address.

The address re-routing scheme should be implemented on both the routing station end and in any client Plug-In software used to receive the data. On the routing station side, once the ISP enters all address conflicts, the routing station performs address translation on all of the addresses that conflicts occur. All packets have their addresses re-mapped to the new location. If a single address can not be re-routed (all four address blocks are used for a given channel) then the receiver performs major address block rerouting as would occur in address block conflict management described below.

On the client software side, the client opens sockets for all four address blocks (either sequentially or simultaneously). The address that provides valid broadcast data is accepted as the correct channel. The three other sockets are closed. If none of the addresses provide valid data, the client tries the alternate address block as defined below.

Alternative strategies for reconciling addressing conflicts may also be employed. As an example, an agent might be implemented with the IPMS which could be queried by the client for the appropriate address to use at a particular location. Such a query would include a “logical” channel number associated with the desired broadcast. The agent would then respond with the specific IP Address locally employed for that broadcast.

If a large number of addresses conflict with the default system address space, an alternate block of addresses will be used. The system defines the exact alternate address space (or spaces), but as an example, if 239.1 17.X.Y is the primary default broadcast block, an address space like 239.189.X.Y might be used as an alternate. In any event, the routing station will determine, based on the address conflicts entered by the ISP, if the entire broadcast address block must be re-routed. If it does, the routing station will modify each broadcast channel's address. As described above, if the client software can not find a valid broadcast stream within the standard address block, the alternate address space will be tried.

Routing multicast traffic is different than the routing of ordinary traffic on a network. A multicast address identifies a particular transmission session, rather than a specific physical destination. An individual host is able to join an ongoing multicast session by issuing a command that is communicated to a subnet router. This may take place by issuing a “join” command from, for example, an ISP customer to the ISP provider which, in turn, commands its subnet router to route the desired session content to the host to which the requesting ISP customer is connected. The host may then send the content using, for example, PPP protocol to the ISP customer.

Since the broadcast transmission is provided over a dedicated transmission medium (the satellite in the illustrated embodiment), problems normally associated with unknown traffic volumes over a limited bandwidth transmission medium are eliminated. Additionally, the number of point-to-point connections necessary to reach a large audience is reduced since the system uses localized connections within or to the domain to allow clients to join and receive the broadcast. In the illustrated embodiment, a virtually unlimited number of domains may receive the broadcast and supply the broadcast to their respective clients, additional domains being added with only the cost of the routing station at the domain involved. In most instances, ISPs or the like need only add a routing station, such as x1 et seq. (FIG. 2), and may use their existing infrastructure for receiving broadcasts from the routing station for transmission to joined clients. This is due to the fact that most ISPs and the like are already multicast enabled using the IP multicast protocol.

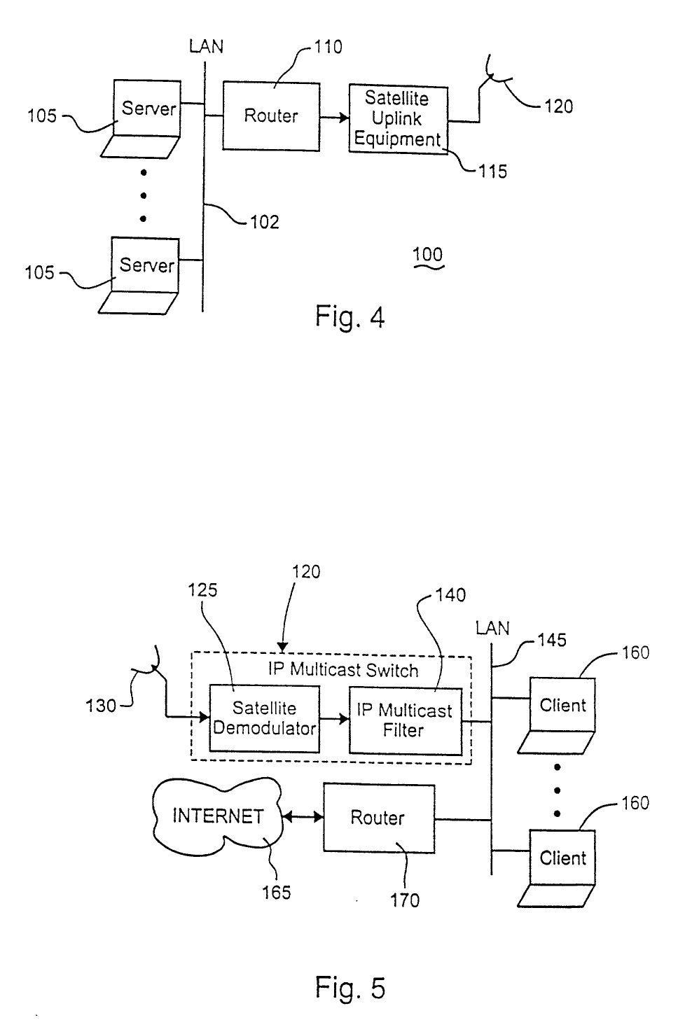

FIG. 4 illustrates a block diagram of one embodiment of a file server station, such as the one illustrated at 100 of FIG. 1. The file server station, shown generally at 100, comprises a local area network 102 with a collection of server PCs 105 connected to a router 110 over the local area network 102. The server PCs 105 include server software that either reads pre-compressed files from the local disk drive and/or performs real time compression of analog real time data. Each server 105 provides this data as output over the local area network.

The LAN 102 performs the function of multiplexing all the streaming data from the server PCs 105. The LAN 102 should have sufficient bandwidth to handle all the data from the server PCs 105. In present practice, 100 mbs LANs are common and, thus, it is quite feasible to use 100 mbs LANs to aggregate the data output to a 30 mbs transponder. A common type of LAN is or 100 BaseT, referring to 100 mbs over twisted pair wire.

The functionality required at 110 is to gather the packets of data from the LAN 102, wrap them in a transport protocol such as HDLC, and convert the HDLC packets to the proper voltage levels (such as R5422). The functionality can be provided by the composite signal provided from the router 110 usually comprises clock and data signals. The composite signals are output from the router 110 for synchronous modulation by a satellite uplink modulator 115 which synchronously modulates the data to the proper RF carrier frequencies and transmits the resulting signal through an antenna 122 to the satellite 55.

One or more server PCs 105 of the LAN 102 store the multimedia content that is to be broadcast to the domains. Alternatively, the one or more PCs 105 may receive prerecorded or live analog video or audio source signals and provide the necessary analog-to-digital conversion, compression, and TCP/IP packet forming for output onto the LAN wanted. These packets are transported over the LAN 102 in an asynchronous manner. The router 110 then receives these asynchronous packets and encapsulates them with the transport protocol and transmits them in a synchronous manner to the satellite 55. The constant conversion from one form to another is provided to fit the transmission technologies of the transmission equipment. LANs are becoming ubiquitous and low cost since it leverages the high manufacturing volumes of the consumer/corporate PC market. Satellite transmission is extremely cost effective for broadcasting signals to multiple destinations and is inherently synchronous (data is transmitted at precise intervals). Accordingly, the foregoing system is currently the most straight forward and lowest cost method to architect a system connecting computer LANs to a satellite transmission system.

A typical satellite 55 has two antennas, one for receiving the signal from the uplink and the second antenna for transmitting the signal to the downlink. An amplifier is disposed between the two antennas. This amplifier is responsible for boosting the level of the signal received from the file server station 100 (uplink). The received signal is very weak because of the distance between the uplink and the satellite (typically about 23,000 miles). The received signal is amplified and sent to the second antenna. The signal from the second antenna travels back to downlinks which are again about 23,000 miles away. In the illustrated embodiment of the system, the downlinks are the routing stations.

The signal is transmitted by the uplink at one frequency and shifted to a different frequency in the satellite before amplification. Thus, the signal received by the satellite is different from the frequency of the signal transmitted. The transmitted information content is identical to the received information.

A typical satellite has approximately 20 to 30 RF amplifiers, each tuned to a different frequency. Each of these receive/transmit frequency subsystems is called a transponder. The bandwidth of each of the transponders is typically about 30 MHz but can vary satellite to satellite.

At the file server station 100, the composite signal from the router 110 is preferably QPSK modulated by the satellite uplink modulator. During the modulation process, extra bits are usually added to the original signal. These extra bits are used by a receiver at the downlink to correct any errors which might occur during the 46,000 mile transmission. The extra protection bits that are a added to the data stream are called Forward Error Correction bits (FEC).

The resulting modulation and error correction process typically allows about 1 megabit/second of data to occupy about 1 megahertz (MHz) of bandwidth on the transponder. Thus, on a 30 MHz bandwidth transponder, one can transmit about 30 mbs of data. The aggregate data rate of the signals generated by all server PCs 105, including the overhead Qf the underlying transmission protocols (IP and HDLC), must be less that the bandwidth of the satellite transponder.

FIG. 5 illustrates one embodiment of a routing station and its connection within a domain. Here, the routing station is called an IP multicast Switch (IPMS), labeled as 120 in FIG. 5. The IPMS 120 is comprised of a demodulator 125 that receives the radio frequency signals from the satellite 55 over receive antenna 130 and converts them into the original TCP/IP digital data stream. These digital signals are then input to a device called a IP multicast Filter (IPMF) 140 that in turn selectively provides the signals as output onto a LAN, shown generally at 145, having sufficient capacity to handle all the received signals. The IPMS 120 is multicast enabled, meaning that data is only output from the IPMF 140 onto the LAN 145 if a client 160 requests a connection to receive a broadcast channel. As noted above, this multicast protocol may be one such as defined in RFC 1112.

As illustrated, the LAN 145 can be connected to the Internet 165 through a router 170. If the broadcast data output on the LAN 145 uses administratively scoped addresses, the router 170 can prevent forwarding of the data to the Internet 165. This is a desirable feature associated with the use of administratively scoped addresses, as the broadcast can be localized and blocked from congesting the Internet 165. If other addresses are used, such as permanent IP multicast addresses, the router 170 is programmed to prevent data having an IP multicast address from being broadcast on the Internet 165.

The software of the IPMS 120 is capable of operating in an IP multicast network. In the embodiment described here, the control structure of the multicast software in the IPMS 120 has four main threads: initialization, multicast packet handling, LAN packet handling, and multicast client monitoring. In the initialization thread, a table used to determine whether a client has joined a broadcast has its content set to an empty state, Initialization is performed before any of the other threads are executed.

The multicast packet handling thread is responsible for reading data from the satellite demodulator and deciding what is to be done with it. To this end, the thread reads each multicast packet received from the satellite demodulator 125. If the multicast group address specified in the received packet is not in a group table designating the groups received from the satellite 55 by the demodulator 125, the group address is added to the group table and set to “not joined.” If the multicast group address specified in the packet is specified in the join table as having been joined by a client, the packet is output through the IPMS 120 to the LAN 145 for receipt by a requesting client 160. If none of the foregoing tests are applicable, the packet is simply ignored.

The LAN packet handling thread is used to determine whether a join command has been received from a client 160 over the LAN 145. To this end, the IPMS 120 reads an IP packet from the LAN 145. If the packet is a request from a client 160 to join the multicast session and it is in a group table (a table identifying groups which the IPMS 120 is authorized to receive), the group address is added to the list of joined addresses in the join table. In all other circumstances, the packet may be ignored.

The multicast client monitoring thread is responsible for performing periodic checking to ensure that a multicast client who has joined a broadcast is still present on the LAN 145. In accordance with RFC 1112, every predetermined number of seconds, or portions thereof, for each group address in the group table which has joined the multicast session a query is sent to that address and the IPMS 120 waits for a response. If there is no response, the IPMS 120 assumes that all joined clients have terminated and removes the group address from the joined list.

It will be recognized that other further software threads and variations on the foregoing threads may be used. However, in the simplest form of the illustrated embodiment, the four threads described above are all that is practically needed for effective IPMS operation where the IPMS 120 is disposed at an outer edge of a domain network. This simplification provides a reduction in complexity in the IPMS 120.

If there are one or more routers between the IPMS 120 and the multicast client 160, then the IPMS 120 is programmed to understand the various multicast protocols such as DVMRP, MOSPF and RIM. These protocols are well known and can easily be implemented in the IPMS 120.

In either configuration, the IPMS 120 appears to the domain network as the source of the data, and the satellite link effectively places an identical server at each downlink location in the separate domains described in connection with FIG. 2.

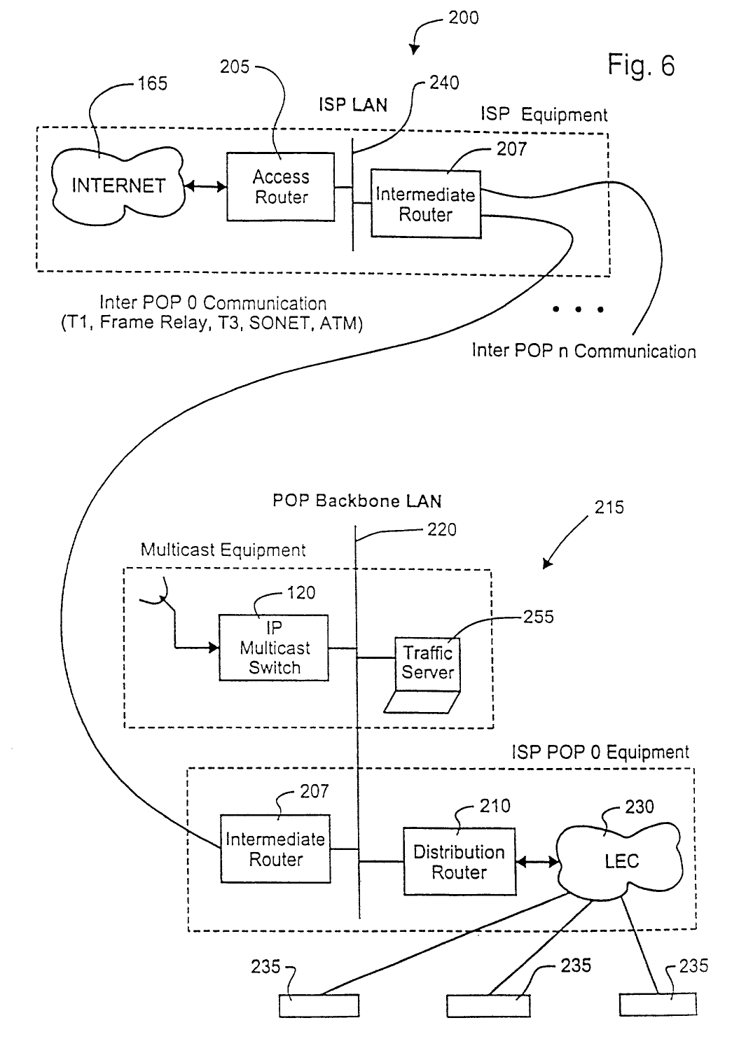

It is generally preferable to have the IPMS 120 as close as possible to the last point in the network before transmission to a client. This close proximity to the client minimizes the traffic burden on other system routers and the overall local LAN. The Internet Service Provider's (ISP) local Point of Presence (POP) is generally the optimum location for placement of the IPMS 120 at an ISP. Such a configuration is illustrated in FIG. 6.

As shown in FIG. 6, the ISP, shown generally at 200, is connected via an access router 205 to the Internet 165. If a distribution router 210 is located some distance from the Internet access router 205, then inter-POP communications are required through one or more intermediate routers 207. These inter-POP communications may take place via frame relay or SMDS (Switched Multimegabit Data Service) since these are relatively inexpensive communication methods. In the POP 215, the IPMS 120 is connected to the backbone LAN 220. This LAN 220 is connected to the distribution router 210 and provides the connectivity to the customer base. Typically, the distribution router 210 is connected to a Local Exchange Carrier (LEC) 230 through telephone company interconnects such as T1, T3, and ATM lines and, thereafter, to remotely located home users/clients 235.

The architecture of FIG. 6 allows customers 235 to place local (free) calls into the distribution router 210 that, in turn, allows the customers 235 to access the Internet 165 through some remote access point. If the POP 215 and the Internet access at access router 205 are co-located, then the ISP LAN 240 and the POP Backbone LAN 220 are one in the same and there are no intermediate routers or intervening inter-POP communications.

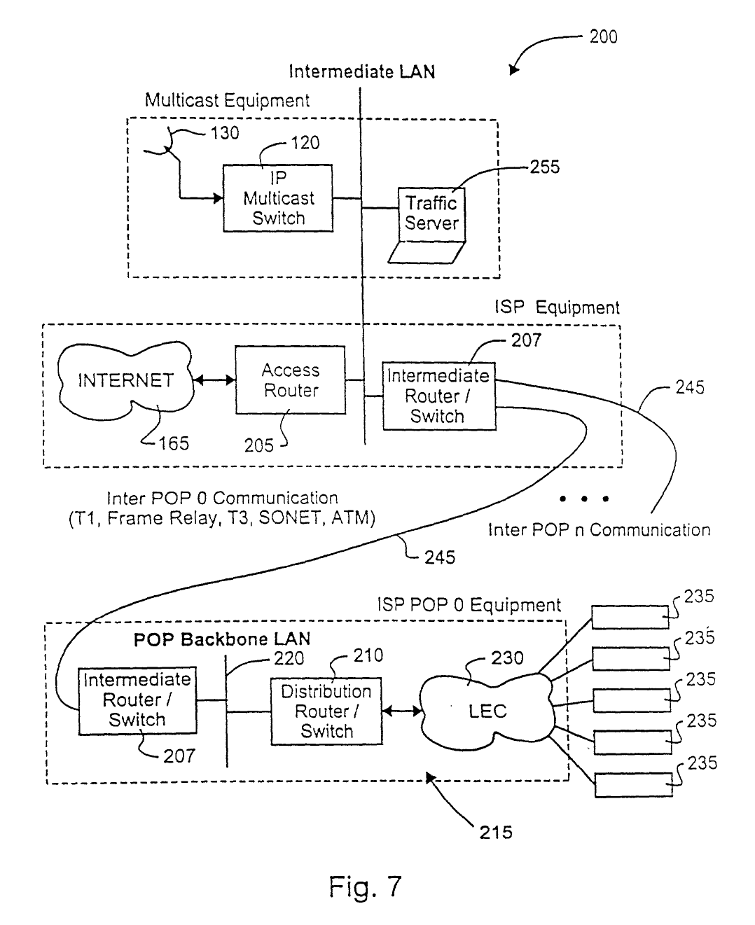

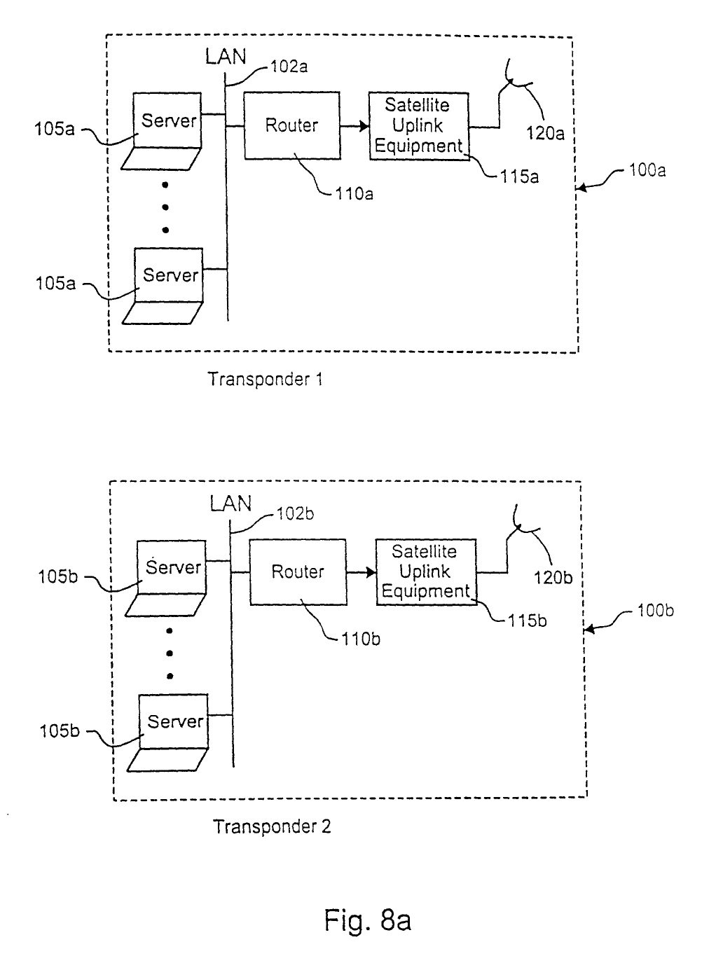

FIG. 7 illustrates a system in which the IPMS 120 is not disposed at the POP 215 location. This arrangement is functional, but requires a large amount of bandwidth over the inter-POP communication lines 245. The configuration shown in FIG. 6 minimizes the bandwidth requirements of the router interconnections relative to the configuration shown in FIG. 7 since only the POP Backbone LAN should include both the traditional Internet traffic as well as the multicast traffic.

As can be seen from examination of FIGS. 6 and 7, the addition of multicast equipment to the ISP's POP 215 is minimal. It is also possible and desirable to add a traffic server PC 255 onto the LAN of the ISP 200 having the IPMF 120 (also known as a multicast switch). This traffic server 255 can be used for a variety of purposes, but in the embodiment shown here, it is used to store information received from the satellite 55 and the Internet 165 for later playback. It also can be used to monitor the number and identification of a connected user as well as performing other functions. For example, when a user selects a video/audio multicast channel to view/hear, it sends a specific IGMP message over the LAN that is directed to the IPMS 120. This message can also be monitored by all systems connected to the LAN. Specifically, the traffic server 255 may monitor the communication between the router 210 and any connected clients and may also monitor the number of connections to the multicast channels. The connection information gathered by the traffic server 255 is preferably relayed to a central server or the like over the Internet 165 at periodic intervals for consolidation at a central facility.

One advantage of the foregoing system architecture is that it provides a scaleable architecture that may be scaled to deliver a small number of megabits as well as further scaled to deliver nearly a gigabit of content to a large number of host computers. This architecture is only constrained by satellite transponder capacity, which is typically about 30 mbs per transponder.

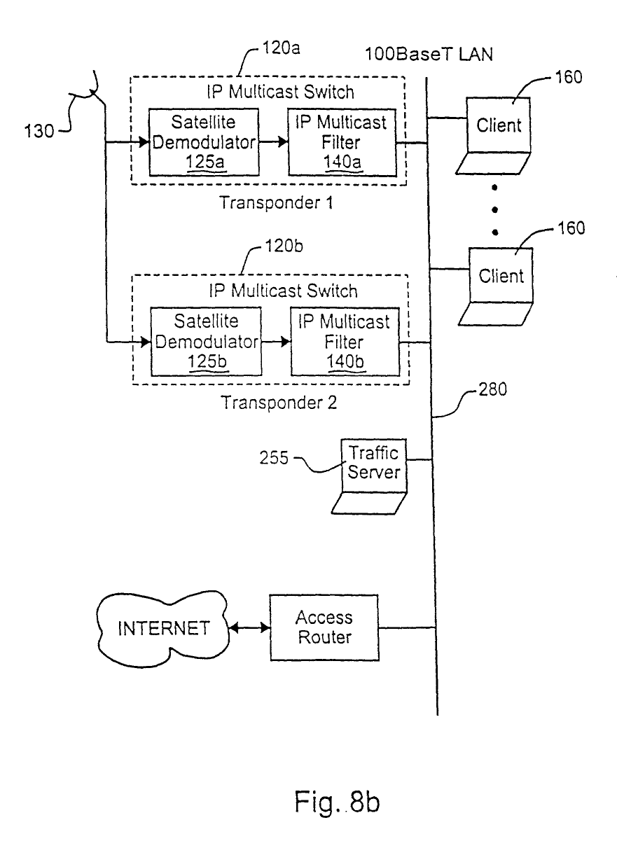

Since, conventional server stations may typically provide a capacity of only about 30 mbs, a preferable uplink contemplated for the present invention may use, for example, two or more server stations 100a and 100b. FIGS. 8A and 8B illustrate an example uplink and downlink system arrangements capable of handling at least 60 mbs. On the uplink side, first and second clusters of server PCs 105a and 105b are connected to a first and second router 110a and 110b, which in turn are connected to the uplink equipment 115a and 115b. The uplinked signal may be transmitted over the same satellite 55 using a different transponder frequency or, alternatively, the transmission of signals from second router 110b may be directed to a different satellite than the one used by the server station 100a. If the two signals are uplinked onto the same satellite, then it is possible to share a common antenna.

At the downlink side of the transmission, as illustrated in FIG. 8B, there are two IPMS units 120a and 120b, which are each identical to that described above. If the two signals are uplinked on the same satellite, it is possible to share an antenna 130 on the downlink as shown in FIG. 8b. If not, then two separate antennas are required, one pointing to each of the different satellites. In the example scenario depicted in FIG. 8b, two IPMSs 120a and 120b are connected to a 100baseT LAN 280. The maximum bit-rate delivered to the LAN 280 is the sum of the individual bit rates of the IPMSs 120a and 120b, or about 60 mbs. This is a convenient arrangement since a realistic maximum capacity for a 100BaseT LAN is about 60 mbs.

Additional server stations and IPMSs may be added to the foregoing system to increase the number of available multimedia multicast channels available to the ISP clients. For example, a 90 mbs system may be constructed by adding a further server station at the uplink side of the system and adding a further IPMS at the ISP POP. This third IPMS, however, presents a problem for a 100BaseT LAN since the total possible throughput can now exceed the allowable LAN bandwidth. The traffic server 255 can be used to assist in eliminating this problem.

At the heart of the multicasting protocol is the fact that generally no unnecessary traffic is forwarded unless someone has requested it. This means that even if there is 90 mbs of total data received from the satellite, there would be no data output to the 100BaseT LAN if there were no clients requesting a connection to it. On the other hand, it is possible that there could be clients requesting placement of the entire 90 mbs on the LAN. Such traffic would saturate the LAN 280. To mitigate the problem, there are at least two potential solutions. The first solution is to modify the client software so that it first contacts the traffic server 255 to determine how much bandwidth is already delivered to the LAN 280. If the LAN is already delivering the maximum possible data to other clients, then the client currently trying to connect is given a message stating that the system is too busy.

A second solution is to have an IPMS first contact the traffic server 255 to check the load on the LAN 280 before providing a channel of multicast data on the LAN 280. To this end, the IPMS 120 contacts the traffic server 255 after a request has been made for a channel of multicast data but before the data is supplied on the LAN 280. If the traffic server 255 deems that the load is too high, it instructs the IPMS 120 to ignore the join request and refrain from transmitting the requested group on the LAN 280. As a result, the requesting client would not receive the requested video/audio stream. The client software may indicate the failure to receive the requested data upon termination of a predetermined time period and indicate this fact to the user. Nevertheless, the applicants believe that there is a high probability that 90 to 120 mbs of data could be uplinked with no downlink overload on the LAN, since it is highly unlikely that all data rates of all channels would be simultaneously used.

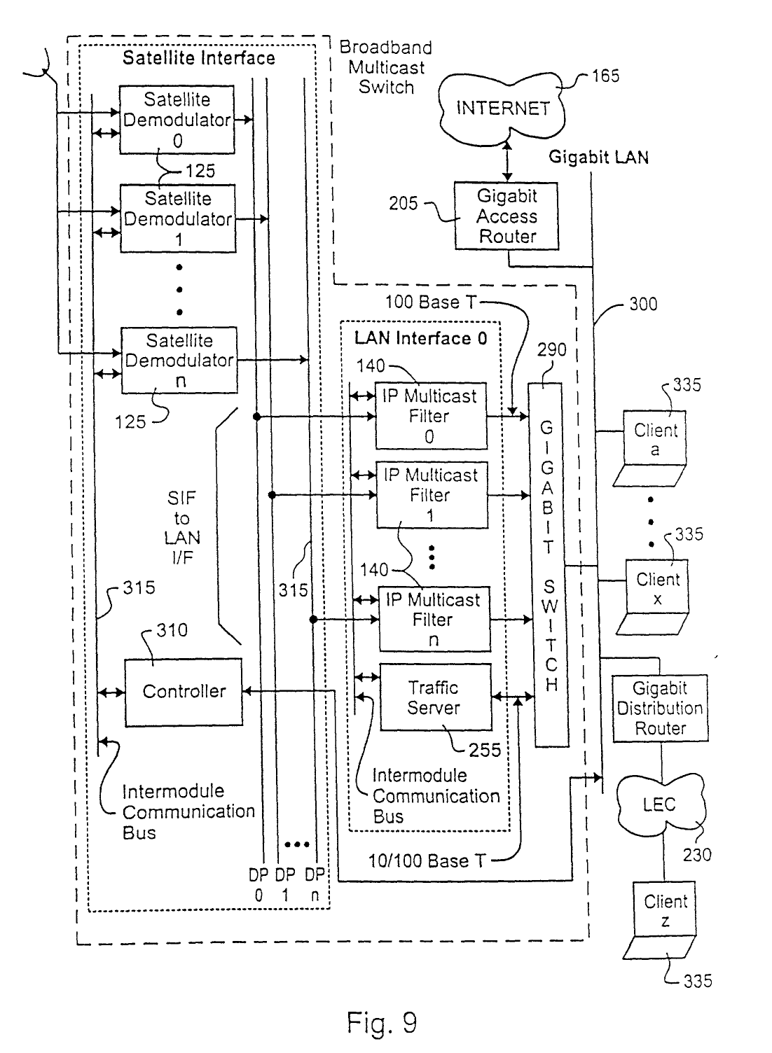

The traffic server software could be imbedded into one of the IP multicast Switches 120 and thus eliminate separate traffic server hardware 255. If the system data is scaled even higher, then the architecture shown in FIG. 9 is used at the downlink side of the system. The transmission data rate at the uplink side is obtained by merely adding further file server stations 100. The system shown in FIG. 9 adds a new piece of hardware called gigabit switch 290. On the right side of the switch 290 is a connection to the LAN 300. The LAN 300 in this embodiment is capable of handling the total aggregate bandwidth output by all IPMSs 120. For the case where each IPMS 120 is receiving 30 mbs and there are 10 IPMSs, then the aggregate bandwidth is 300 mbs. This implies that the LAN 300 is capable of handling such traffic.

As further illustrated in FIG. 9, a controller 310 may be used to communicate with the LAN 300 and, further, with the demodulators 125 and IPMFs 140 over a communication bus 315. Such an architecture allows the controller 310 to program the specific operational parameters used by the demodulators and IPMFs. Additionally, the demodulators 125 and IPMFs 140 may communicate information such as errors, status, etc., to the controller 310 for subsequent use by the controller 310 and/or operator of the routing station. Still further, the traffic server 255 may be used to facilitate inter-module communications between the IPMFs 140.

The connections between the IPMF 140 and the switch 290 may be the 100BaseT connections shown in the previous FIGURES. This implies that the switch 290 requires n-100BaseT input ports to accommodate the n-IPMS inputs. The system proposed in FIG. 9 assumes the use of gigabit access and distribution routers, gigabit LANs and gigabit switches. Such network components are in the very early stages of deployment.

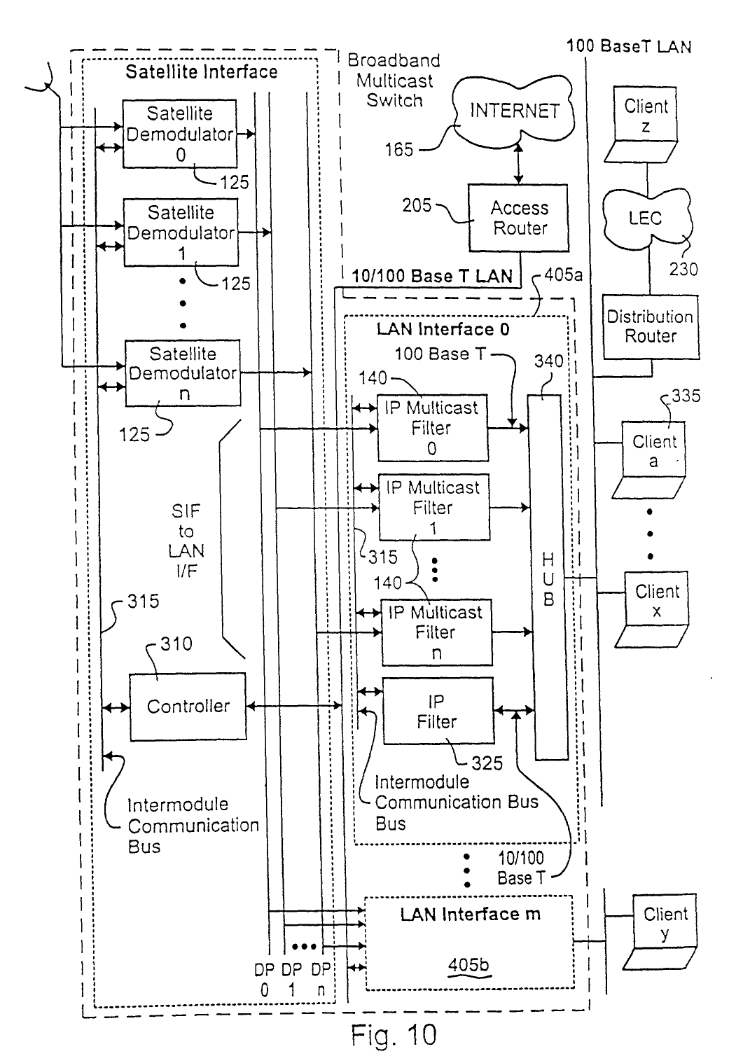

A second architecture that can be used to scale to a large number of users is shown in FIG. 10 and is similar to the architecture shown in FIG. 9 in that they both include the satellite demodulators 125 and the IP multicast Filters 140. The system of FIG. 10, however, replaces the traffic server 255 with an IP filter 325 and the gigabit switch 290 with a standard 100BaseT hub 340. Another significant difference between the two architectures is that the Internet access router 205 of FIG. 10 is directly connected to the backbone of the gigabit LAN while the connection for the Internet access by the clients 335 is through the IP filter 325 within the LAN interface module. The IP filter 325 may be implemented by a PC or the like, or by a microcontroller, The IP filter 325 performs the functions of the traffic server 255 as well as simple IP packet filtering. It passes each packet received from the Internet without examination or modification. This includes multicast as well as unicast traffic.

Packets received from the hub 340 are examined on a per packet basis. Multicast packets with a group address used by the satellite delivered multicast system (shown here as the Satellite Interface Unit (SIU) ) are blocked from traversing onto the Internet. This prevents the Internet Access LAN from overload and serves the function of administratively scoping the multicast traffic to one segment. This architecture also has an added advantage in that the routers used in the domain do not have to be multicast enabled.

The architecture shown in FIG. 10 can be viewed as dividing an ISP into smaller ISP's within the larger ISP. Each of these mini-ISPs has its own LAN Interface Unit (LIU) 405. This architecture places a performance requirement on the IP filter in that it must be capable of processing all packets flowing through it via the 100BaseT LANs to which it is connected.

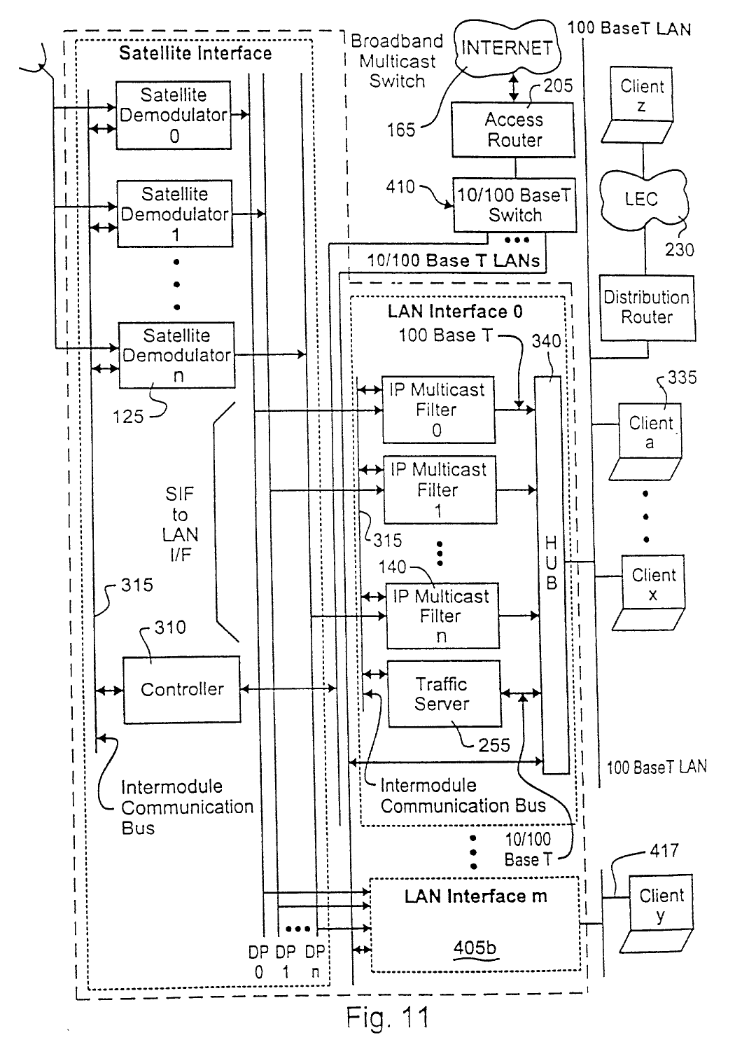

FIG. 11 illustrates a further system architecture that replaces the IP filter 325 of FIG. 10 with a traffic server 255 and uses a 10/100BaseT switch 410 in place of the IP filter 325. This architecture requires the 10/100BaseT switch 410 to perform the IP multicast filtering that was done in the IP filter 325. The interface point 417 of FIG. 11, between the IPMS and a particular ISP LAN segment, may also be facilitated in cases where that LAN segment is remotely located. Standard digital telecommunications services may be employed to serve as electrical “extension cords” to bring the output of the IPMS onto the remotely located segment. This is done through commonly available “CSU/DSUs” that can transform the LAN output of the IPMS into a digital signal compatible with the Network Interface requirements of common communications carriers, and at the remote location, a subsequent translation back into the required 100BT LAN signal.

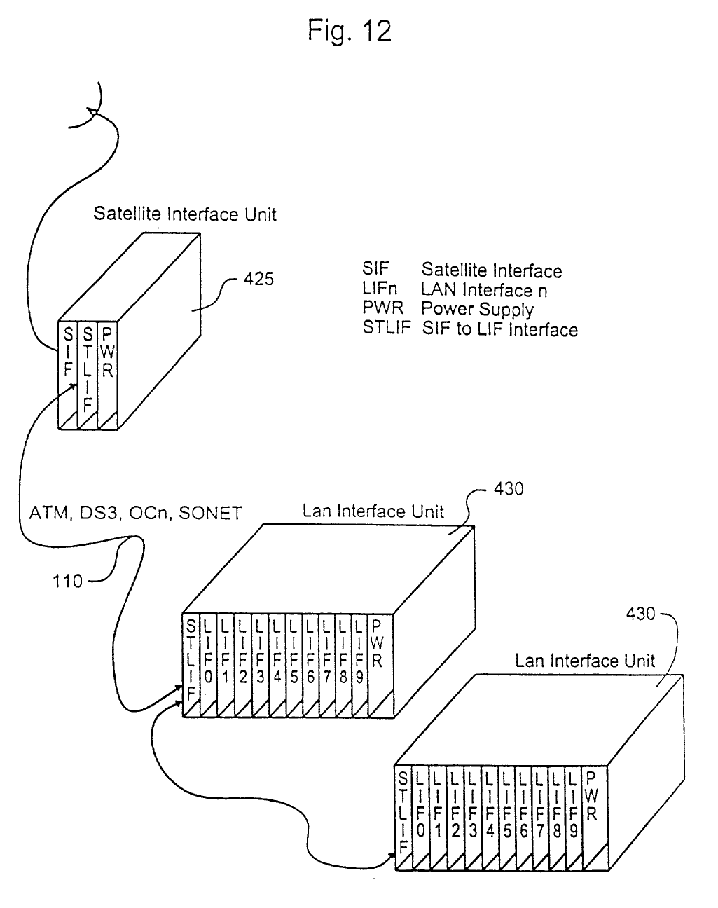

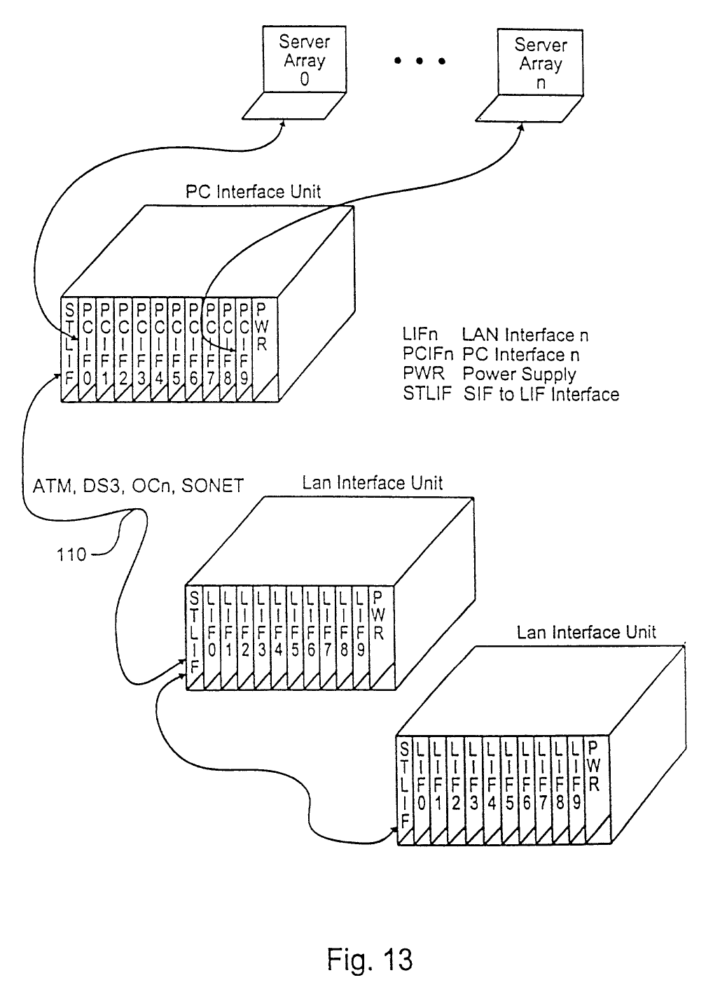

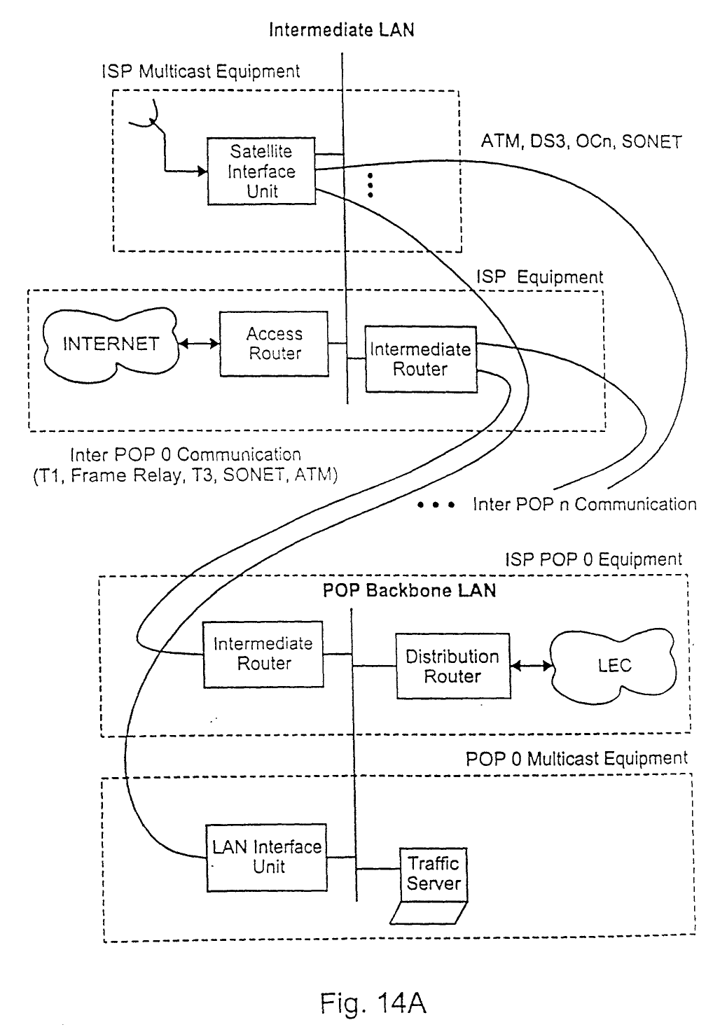

FIG. 12 shows one manner of implementing the architectures for the satellite downlink. The IP multicast Switch 120 can be functionally and physically divided into a satellite interface unit 425 and a LAN interface unit 430. Multiple LAN interface units 430 may be connected to a single satellite interface unit 425. This allows the satellite reception equipment to be located at a first location and its output distributed to various remotely located LAN interface units. As illustrated by FIG. 13, the basic system architecture of FIG. 12 also allows for the distribution of content via an alternate transmission facility such as terrestrial fiber 110. Alternatively, these two modules can reside in the same chassis and use the chassis backplane for intermodule communication.

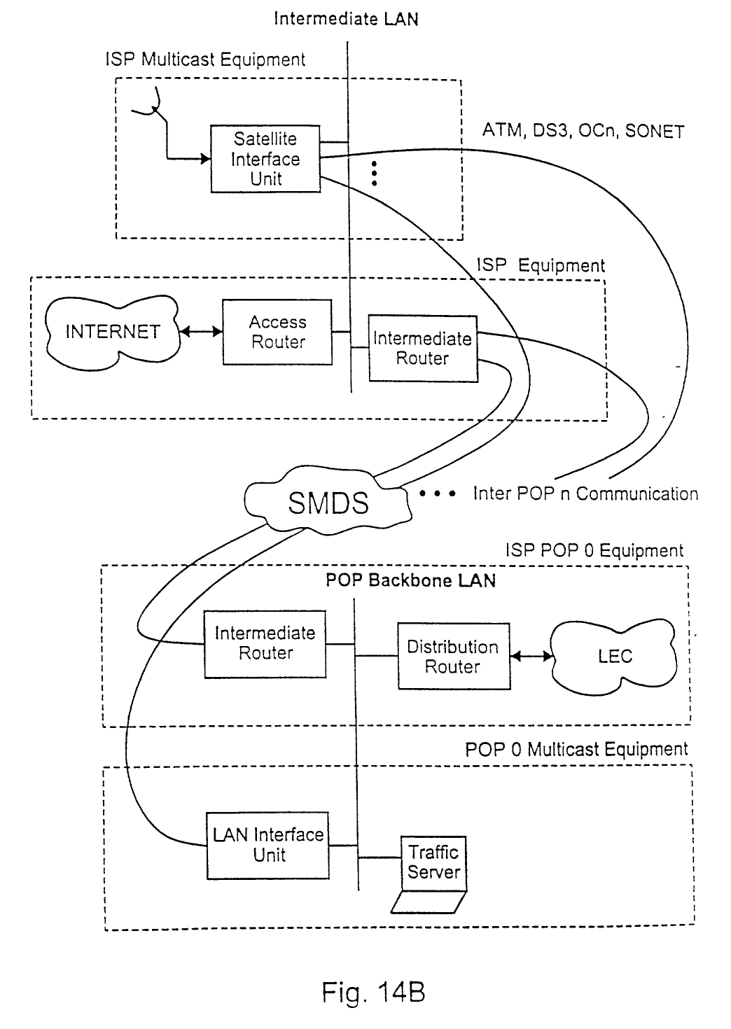

FIGS. 14A and 14B show an example arrangement for an embodiment of the multicast system of the present invention having an ISP with distributed POPs that are interconnected with one another. In this example system arrangement, the multicast traffic is isolated from the unicast traffic and inter-POP multicast traffic is carried on a separate transmission facility.

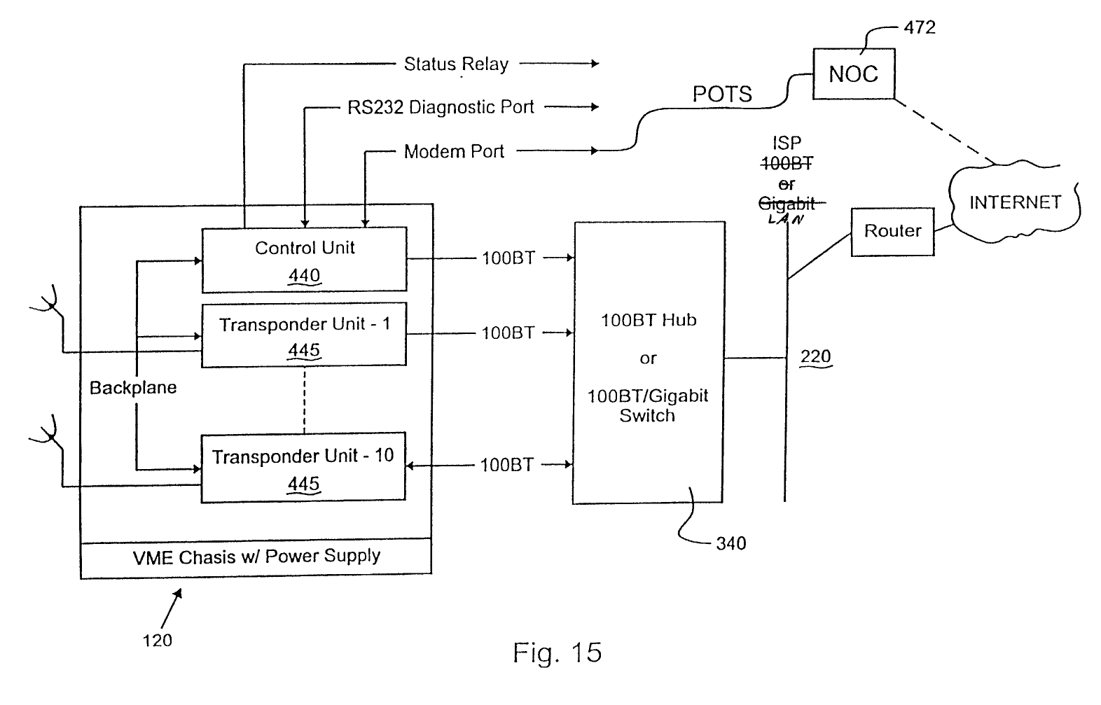

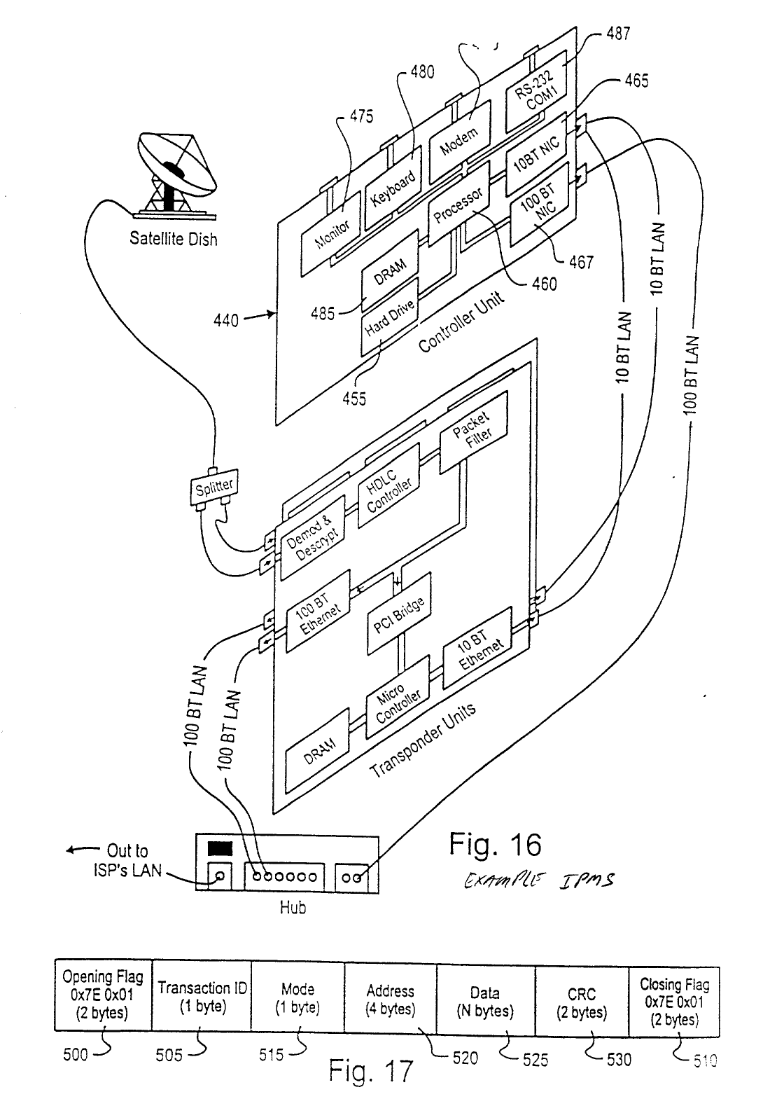

A more detailed example of IP multicast switch (IPMS) 120 is illustrated in FIGS. 15 and 16. The example IPMS unit 120 illustrated and described herein is comprised of a controller unit 440 and one or more transponder units 445. The controller unit 440 handles the monitoring, control, and configuration of the IPMS unit 120. The transponder units 445 performs demodulation and de-packetization of the RF signal data received from the satellite 55 and provides the demodulated data to the hub 340 of a 100BT LAN 220 when directed to do so by the controller unit 440. In some implementations of the system, there may be a need for a splitter unit 450 that divides the RF signal for supply to several transponder units 445.

As noted above, the controller unit 440 handles all monitor, control, and configuration of the IPMS unit 120. It maintains logs of all of the events in the system and processes all incoming TCP/IP protocol messages to the IPMS unit 120. These messages include the IGMP join requests from remote clients, individually addressed commands to the controller unit 440, and packets destined to individual transponder units 445. The controller unit 440 is responsible for logging all of the trace type events in a non-volatile memory device, such as a hard disk drive 455.

As illustrated, the controller unit 440 is comprised of a microprocessor unit 460, two network interface cards (NIC) 465 and 467, a modem 470 for connection to a remote port, a video controller 475 for connecting a video monitor, a keyboard interface 480 for connection to a keyboard, a DRAM 485 for storage, an RS-232 port 487 for external communications, and the hard drive 455.

The microprocessor unit 460 may be an Intel Advanced ML (MARL) Pentium motherboard. This board has two serial ports, a parallel port, a bus mastering IDE controller, a keyboard interface, a mouse interface, support for up to 128 MB of DRAM, and a socket for a Pentium microprocesser. The board supports 3 ISA extension boards and 4 PCI extension boards. The MARL motherboard is designed to fit into the standard ATX form factor.

RS-232 port 487 supports commands from a remote port that can be used for both monitor and control functions. This interface supports standard RS232 electrical levels and can be connected to a standard personal computer with a straight through DB-9 cable. The software used to implement the interface supports a simple ASCII command set as well as a packet protocol that can be used to send commands that contain binary data.

Monitor and control interface software 490 executed by the microprocessor unit 460 supports multiple communications settings for the RS232 port 487 by allowing the user to change the baud rate, the number of data bits, the number of stop bits, and the type of parity. These settings are saved in non-volatile memory so that they are preserved after power has been removed from the receiver.

Monitor and control interface software 490 preferably supports both a simple ASCII protocol and a more complex packet structure. The ASCII protocol is a simple string protocol with commands terminated with either a carriage return character, a line feed character, or both. The packet protocol is more complex and includes a data header and a terminating cyclic redundancy check (CRC) to verify the validity of the entire data packet.

The ASCII protocol is preferably compatible with a simple terminal program such as Procomm™ or HyperTerminal™. When an external terminal is connected to the RS-232 port 47, the controller unit 440 initially responds with a sign-on message and then displays its “ready” prompt indicating that the is ready to accept commands through the monitor and control interface software 490. Commands are terminated by typing the ENTER key which generates a carriage return, a line feed, or both. The controller unit 440 interprets the carriage return, as the termination of the command and begins parsing the command.

Controller unit 440 may also communicate through the monitor and control interface software 490 using a predetermined packet protocol. One such protocol is illustrated in FIG. 17. The illustrated protocol is an asynchronous character based master-slave protocol that allows a master controller to encapsulate and transmit binary and ASCII data to a slave subsystem. Packets are delimited by a sequence of characters, known as “flags,” which indicate the beginning and end of a packet. Character stuffing is used to ensure that the flag does not appear in the body of the packet. A 32-bit address field allows this protocol to be used in point-to-point or in point-to-multipoint applications. A 16 bit CRC is included in order to guarantee the validity of each received packet.

Referring to FIG. 17, opening flag 500 includes a 7E_{H} 01_{H} flag pattern indicating the start of packet or end of the packet at 510. A transaction ID 505 follows the opening flag 500 and is, for example, an 8-bit value that allows the master external computer to correlate the controller unit 440 responses. The master computer sends an arbitrary transaction ID to the controller unit 440, and the controller unit 440 preferably responds with the l's complement of the value received from the master. Following the transaction ID 505 is a value that allows the master to identify the addressing mode of the packet. This portion of the packet is called the mode byte and is shown at 515. These addressing modes include broadcast, physical, and logical modes. An address field 520 and data field 525 follow the mode byte 515. The address field value is used in conjunction with the mode field to determine if the slave should process the packet. The data field 525 contains information specific to the application. This field can be any size and is only limited by the application. Finally, a CRC-16 field 530 follows the data field 525. The CRC-16 field 530 allows each packet to be validated. Each byte from the mode byte 515 to the last data byte is included in the CRC calculation.

The monitor and control interface software 490 supports the same command set as both a remote port and a TCP/IP in-band signaling channel. This allows the IPMS 120 to be controlled identically using any of the possible control channels (although the physical connection and physical protocol vary by connection) which provides redundant means of monitor and control. These commands are described in further detail below.

The controller unit 440 includes the hard drive 455 for its long-term storage. This drive is preferably at least 2.1 GB in size and uses a standard IDE interface. The drive 455 is preferably bootable and stores the operating system, the application(s) running the IPMS 120, and all long-term (non-volatile) data such as history/trace data.

The network interface card 465 is used to communicate with all of the transponder units 445 in the IPMS 120. The network interface card 465 is comprised of a 10 based-T LAN interface running standard TCP/IP. Individual commands are issued using the same protocol as set forth above in connection with the monitor and control interface software 490 as well as any remote port connected through modem 470. This protocol is encapsulated into TCP/IP and sent via an internal LAN 532 over transmission line 535.

The network interface card 465 supports both broadcast and individual card addressing. This interface also supports two-way communication that can be initiated by any unit on the internal LAN 532. Individual transponder units 445 may communicate with each other over the internal LAN 532, although this interface is not truly intended to be used in this fashion in the embodiment shown here. The 10 Based-T interface card 465 may be implement using any off-the-shelf network interface card.

The modem 470 of the controller unit 440 may also support commands that can be used for both monitor and control functions. The modem 470 supports standard phone modem electrical levels and can be connected to a standard phone jack with a straight through RJ-11 cable. Both the ASCII and packet protocols noted above are supported by the modem 470. The modem 470 thus provides another communications route to the IPMS 120 in case a standard TCP/IP link over the Internet to the IPMS 120 fails.

The modem interface 470 is implemented, for example, by an off-the-shelf modem and auto-negotiates all communications settings with a Network Operations Center or NOC 472 at a location that is remote of the ISP. The Network Operations Center 472 preferably uses an identical modem.

The IPMS 120 may include several miscellaneous input and output (10) functions that are not specifically illustrated in FIG. 15 and 16. Such functions may be handled, for example, either on a plug-in ISA board or a front panel board. For example, such functions may include status LEDs, a status dry contact closure, and a panic button. The status LEDs may be set through an I/O card. LED indicators may include Power Present, Power OK, Fault, Test, Carrier OK, and LAN Activity. The Power Present LED may indicate that the IPMS 120 is plugged into its main AC source. The Valid Power LED may indicate if the power within the IPMS 120 is within valid tolerance levels. The Fault LED may indicate if a major fault is occurring in the IPMS 120. The Test LED may indicate that the IPMS 120 is in a test mode, either its power up test or an on-line test mode. The Carrier LED may indicate that all transponder units 445 that should be acquired (have been programmed to lock onto a carrier) are, in fact, locked. If any single transponder unit 445 is not locked, this LED will be off. The LAN activity LED may indicate that the IPMS 120 has activity on its 100 based-T LAN.

A Form C dry contact closure may be provided to indicate the status of the IPMS 120. If the IPMS 120 goes into a fault condition, the IPMS 120 will provide an output signal along one or more lines at 540 to drive closure to a closed state. This provides a means of monitoring the overall operational integrity of the IPMS 120 with an external device triggered by the contact closure. Devices that could be used include automatic pagers or alarm bells.

The IPMS 120 may also have a “panic button” that is used to turn off outgoing multicast video/audio content. This will provide the ISP with a quick and efficient way of stopping the IPMS 120 data flow onto the ISP LAN 240 in cases of extreme LAN congestion or a when a malfunctioning IPMS 120 inadvertently congests the LAN 240. This button preferably will not take the controller unit 440 link off of the network. This ensures that the controller unit 440 will still be susceptible to monitoring and control through the TCP/IP port connected to the ISP's LAN 240. Once the panic button has been pressed, the IPMS 120 issues a “LAN shutdown” to every transponder unit 445 through the network interface card 465. The individual transponder units 445 are responsible for shutting their LAN output off.

An overview of software functionality used to operate the controller unit 440 is discussed in greater detail in commonly assigned U.S. Pat. No. 6,101,180 to Donahue et al., entitled “High Bandwidth Broadcast System Having Localized multicast Access To Broadband Content”, the entire content of which is incorporated by reference into this specification. Such software may be developed, for example, in accordance with conventional object-oriented, C++, methodology. Controller unit 440 may run, for example, under a Microsoft WindowsNT™ Workstation operating system, or under any such operating system that supports all of the needed networking protocols and the example hardware configuration for controller unit 440.

Commands for interfacing with controller 440 may be provided through the RS-232 port 487, the 100baseT LAN network interface card 467, the 10baseT backplane LAN network interface card 465, or through the modem 470. An example command set is disclosed in U.S. Patent to Donahue et al. mentioned above which is incorporated herein by reference. Through the 100baseT network card 467, commands can be issued either through a SNMP interface, an HTTP interface, or raw commands through TCP/IP.

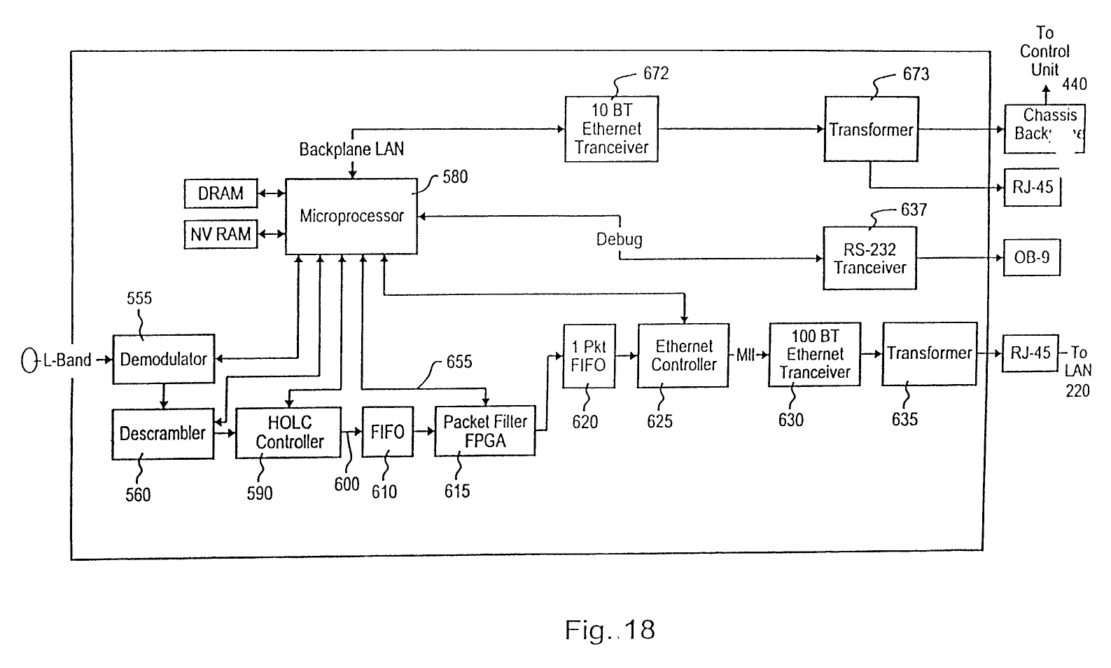

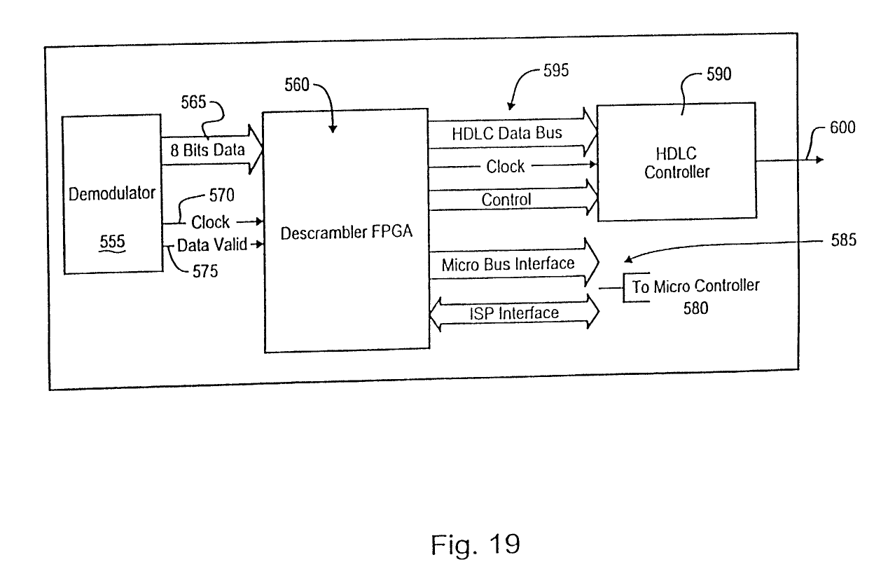

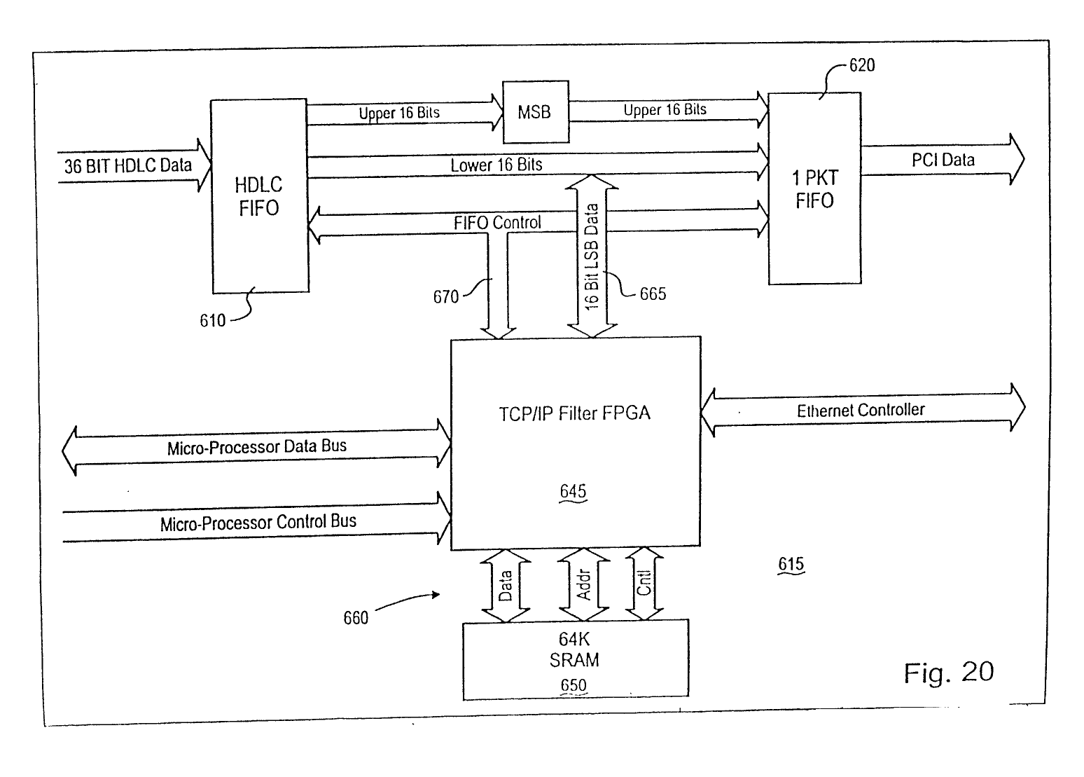

FIGS. 18 through 20 illustrate example transponder unit 445 components and implementations. Such components and implementations are discussed in greater detail in the above mentioned commonly assigned U.S. Patent to Donahue et al. which, as mentioned above, is incorporated herein by reference.

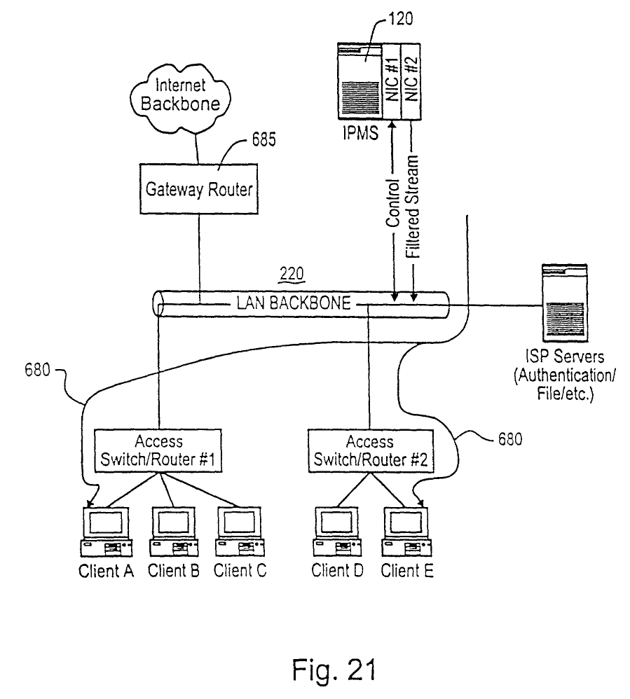

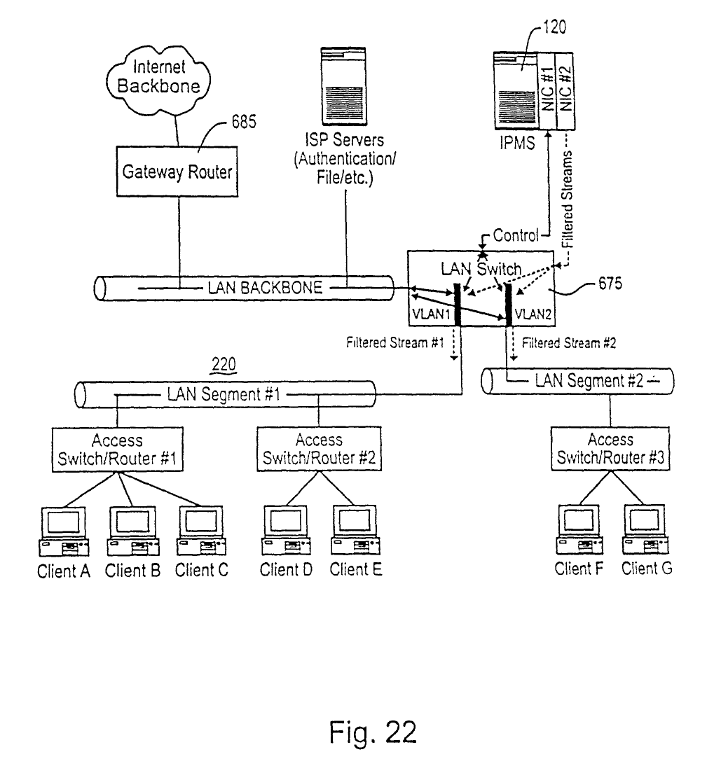

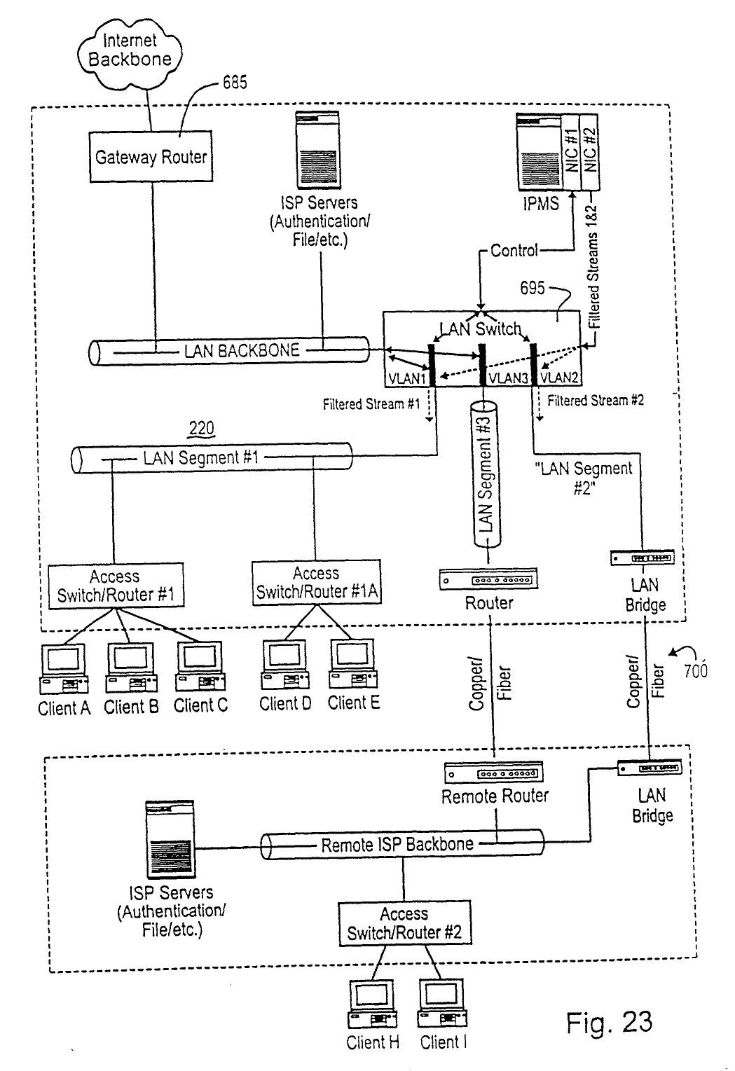

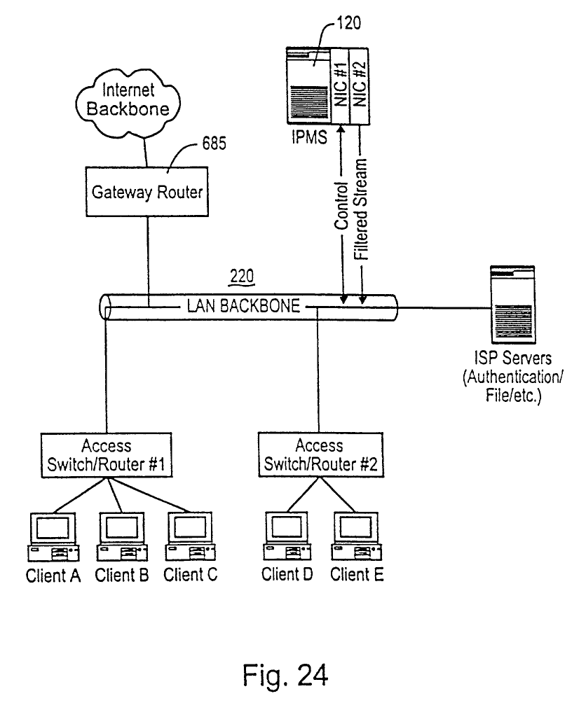

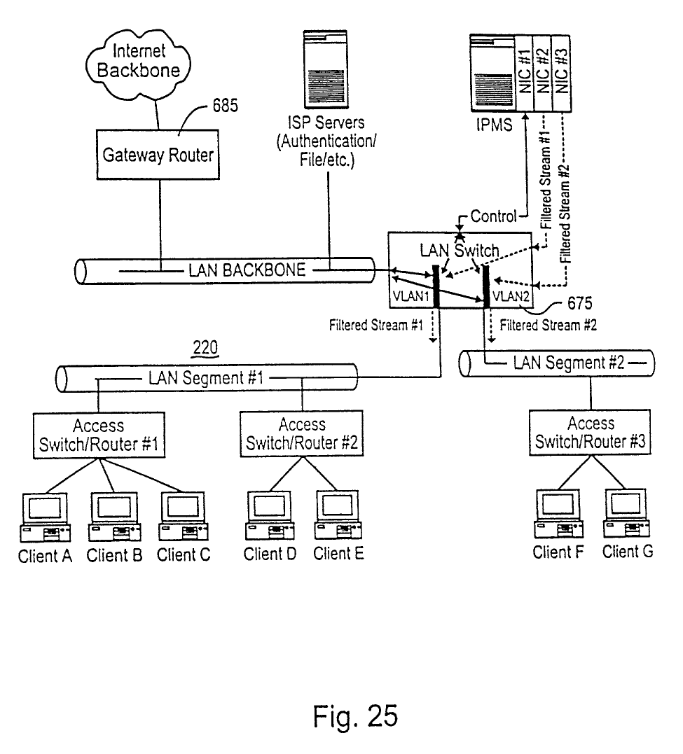

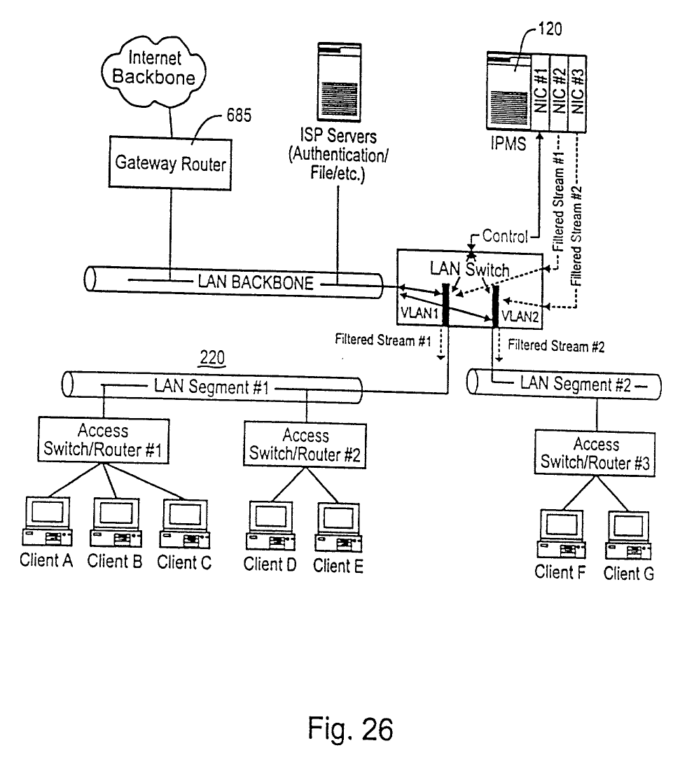

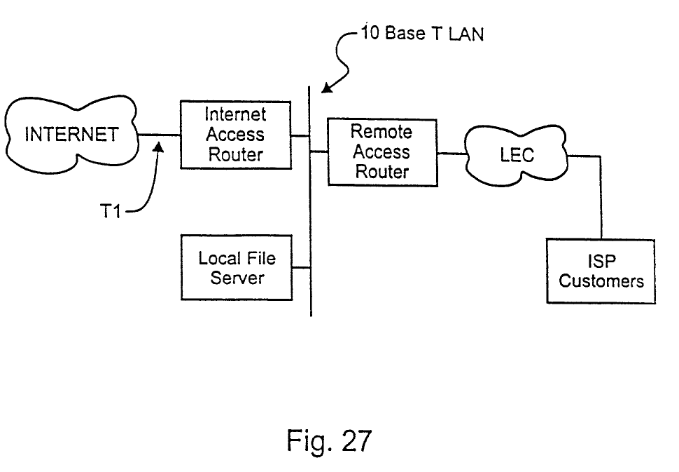

FIGS. 21 through 26 illustrate various ISP configurations and scenarios using IPMS 120 which are also discussed in greater detail in the above mentioned U.S. Patent to Donahue et al., incorporated herein by reference. A variety of characteristics are provided by the various ISP configurations and scenarios of FIGS. 21 through 26 which, for example, may include:

Delivering streams to clients on demand, and quickly removing these streams from the ISP backbone when the client is finished;

Delivering streams to clients while minimizing the traffic on the local backbone of the ISP;

Delivering streams to clients while minimizing additional traffic to other clients; and

Delivering streams to clients while not introducing any additional traffic to the Internet.

Achieving these goals requires that the networking equipment utilized in the communications system support various protocol interactions such as, for example, IP, IGMP and PIM. In each scenario, an IP multicast system application delivers IP multicast streams to Internet Service Providers' (ISPs) clients. The stream content is received, for example, over a satellite by the IPMS which is directly attached to an ISP's local backbone. The stream flows over the local backbone and through the ISP's networking equipment to the client's desktop browser as illustrated, for example, at arrow 680 of FIG. 21.

FIG. 27 shows an example basic ISP configuration. In this example, the Internet is connected to an ISP's internal system 10BaseT LAN via a T1 line and a router. This internal LAN has a local file server that is used for locally served Web pages. Also on this LAN is connected a remote access server (modem pool) which is used to connect the ISP's customers via the LEC (local exchange carrier the local phone company) to the Internet.

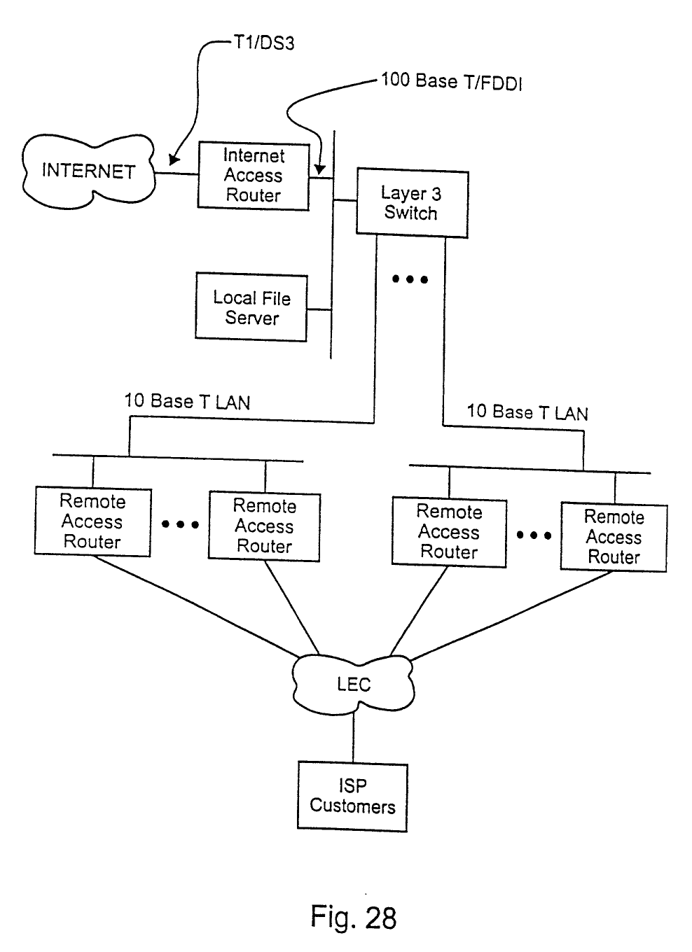

FIG. 28 shows how this ISPO grows to serve more customers. A layer 3 switch is added to the Internal ISP LAN. This LAN is usually interconnected by 100BaseT added to the internal ISP LAN. This LAN is usually interconnected by 100BaseT or FDDI transmission technology. The switch is used to interconnect multiple 10BaseT LAN segments to the ISP LAN. Each of these segments have multiple remote access servers that are used to connect users to the Internet.

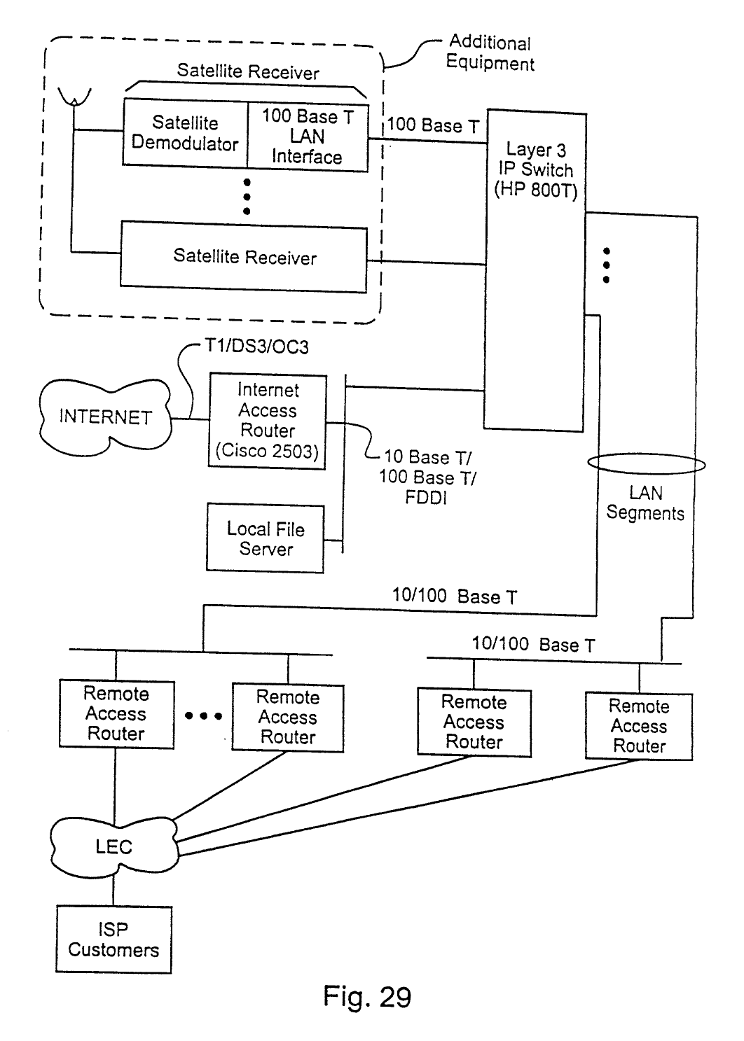

FIG. 29 shows how broadband multimedia data is inserted into an ISP using the ideas described in this application. This configuration takes advantage of current ISP architectures. Contemporary ISP's have system arrangements as shown in FIGS. 27 and 28. For example, they may have one remote access router serving a few customers (FIG. 27) or they may have expanded capabilities with multiple remote access routers (FIG. 28).

FIG. 29 shows the addition of multiple satellite receivers that receive multicast data. In this configuration, the Layer 3 IP switch performs several functions. One function is to connect the proper multicast stream form the appropriate satellite receiver to the appropriate LAN segments. This requires the switch to implement the IP multicast Protocol (RFC1112). A second function is to connect the proper Internet traffic to the appropriate LAN segment. A third function of the Layer 3 switch is to perform the IOMP query function as specified in RFC1112. If the existing Layer 3 switch meets the above requirements, then it can be used. If not, then the ISP must upgrade the switch with one that meets these requirements. The commercially available HP800T switch is one example of such a layer 3 multicast enabled switch.

Such a configuration has the advantage of simplicity since the satellite receiver only needs to strip the HDLC (or other) encapsulation from the incoming data and electrically convert the data to the ethernet format. It does not need to have any knowledge of IP multicasting protocols. Some example enhancements that may also be incorporated into the receiver are multicast address translation and data de-scrambling. For such cases, the receiver must understand the IP multicasting protocol to perform the appropriate functions.

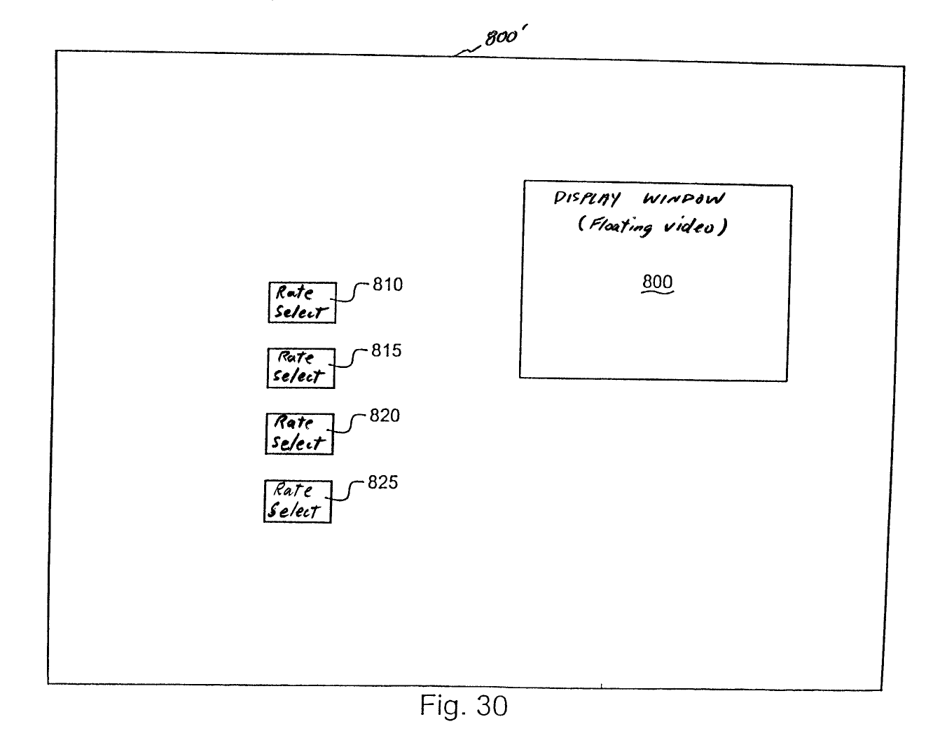

FIG. 30 illustrates the layout of an exemplary, traditional web page suitable for use in the present multicast system. As illustrated, the web page includes a video/audio content display window 800 that accepts and displays/plays a video or audio data stream from the broadcast transmission. External to the display window 800, text, and graphic content relating to the content of the video/audio content is displayed. Such content can be provided in the broadcast transmission itself, over the backbone of the Internet, or from storage at the ISP.

The web page is also provided with a plurality of baud rate selection buttons 810,815, 820, and 825. Each button corresponds to a baud rate of a broadcast video/audio content stream, each stream having the same multimedia content. For example, button 810 may correspond to transmission of the media content for the display window 800 at 14.4K. Similarly, buttons 815, 820, and 825 may correspond to baud rates of 28.8 K, 56.6 K and 1.5 MB, respectively. This allows the client to select a baud rate for the video/audio content transmission rate that is suited to his system.

The use of such a web page provides substantial information and versatility to the user. For example, the user may be presented with a substantially continuous flow of video/audio content information while concurrently having text and other information presented to him that may or may not be related to the video/audio content to allow the user to select other web pages, audio information, further video content, etc. Such further selections may relate to the particular topic, product, etc., provided in the video/audio content. The user may also be given an option to select multiple video/audio channels that may be supplied concurrently. The user may also be provided with a substantial number of channels to choose from, thereby allowing the user to select the desired video/audio content.

The web page needed not necessarily be provided with buttons for the selection of baud rate. Rather, a software plug-in for the web browser used by the client may be used to automatically join the appropriate multicast group depending on the data rate at which the client communicates with the ISP. In such instances, the plug-in software first detects the data rate at which the client is communicating with the Internet service provider. When a client wishes to view/listen to a particular video/audio stream content, the software compares this detected data rate against a table of different data rates for the same content, each data rate corresponding to a unique multicast Group address. The software joins the client to the multicast group having the maximum data rate that does not exceed the data rate at which the software detected the communications between the client and the Internet service provider. An example of software that may be used for this purpose is set forth in Appendix A of U.S. Pat. No. 6,101,180, which includes listings of software source code in C++ for automatically detecting the baud rate at which the client is connected to the system and selecting the proper multicast join group.

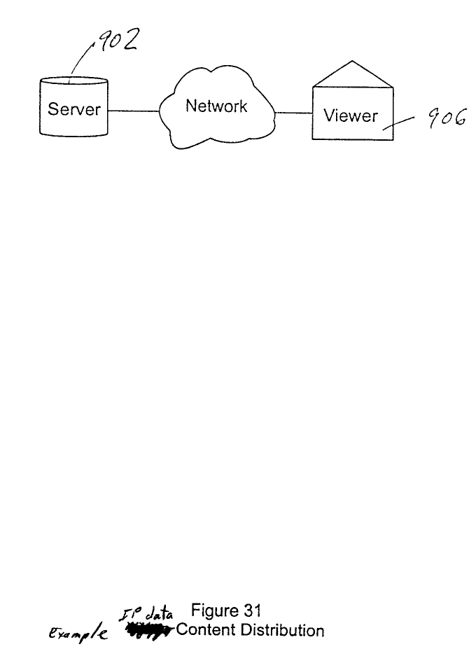

The IP broadcast architecture shown in FIG. 31 allows the transport of content to viewers. The role of the transport network is to deliver information from the server (902) to a viewer (906). Example systems are either Video-On-Demand (VOD) or broadcast. In the VOD system, the viewer communicates with the server and instructs the server to start delivering the selected content to the viewer. Such an arrangement requires bi-directional communication links between the viewer and server. Such conventional one-to-one systems typically use the Internet as the transport network with the underlying TCP/IP two-way protocol.

Such systems do not easily scale as the number of simultaneous users increase. To provide a system that scales, the one-to-one two-way model must be abandoned in favor of a one-to-many one-way model. For the one-to-many one-way model, the IP broadcast architecture looks basically the same as the architecture shown in FIG. 31, except that the communication channels only need to be a one-way communication “channel” or “channels.” Such broadcast systems are commonly based on the UDP/IP protocol instead of TCP/IP and are called “multicast” systems if data is delivered to just viewers that have requested a connection to the one-way “channel.” As contemplated for the present invention, such a one-way channel is preferably a dedicated one-way transmission bandwidth over any data transmission medium that is substantially separate from the Internet backbone.

Commercials may be embedded in the video/audio content server 902 and delivered as part of the content received at 906. This type of commercial is called a “national” commercial since all viewers receive the same commercial.

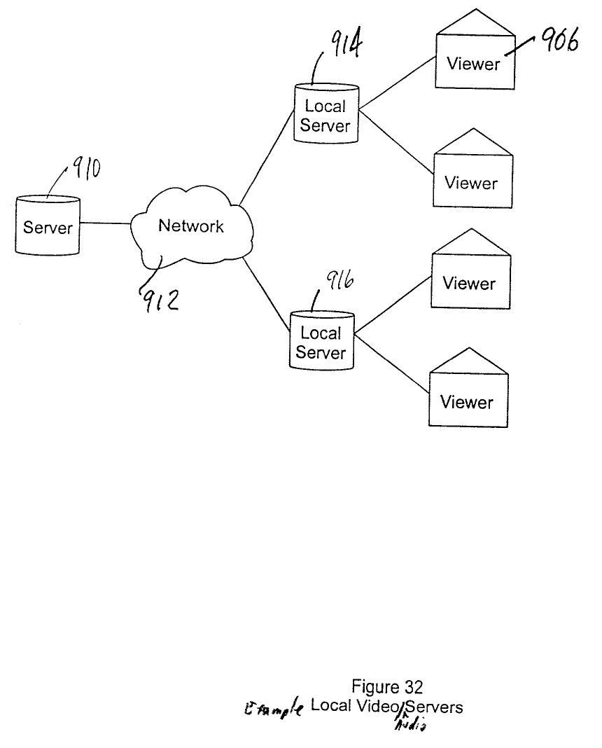

The architecture shown in FIG. 32 shows the addition of “local” servers 914 and 916. These local servers may be, for example, situated at a remote Internet point-of-presence (POP) of an ISP or other Internet connected entity. Using this architecture, the data from server 910 now flows through the national distribution network 912 and feeds the local servers. The local servers relay the content to the viewers.

The addition of the local servers permits the insertion of “local” commercials intermixed with the video/audio content. In normal operation the audio or video from the network to the local server flows unaltered through the local server to the viewer. If local commercials are not inserted at the local servers, then the national commercials are played. If local insertion is desired, then the stream from the network to the local server is ignored and content stored on the local server is delivered to the viewers.

This local insertion can be done for both unicast (one-to-one) and multicast (one-to-many) systems. Local commercial insertion has tremendous economic value since the revenue associated with local commercial sales is greater then that of national commercial sales.

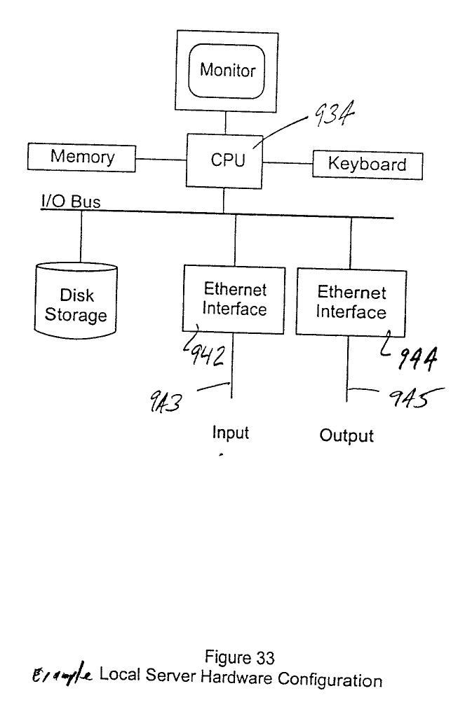

Example local server hardware that may be used for multicast local content insertion is shown in FIG. 33. A key element of this system is the use of two Ethernet interface cards, 942 and 944. This architecture allows input to the system, via 943, local insertion under the control of the CPU 934 and the resulting stream with the local commercial(s) inserted output via interface 944 to line 945.

An example local server arrangement suitable for multicast local content insertion may use the so-called “Wintel™” platform. The “mother board” for such a system may use, for example, a Intel Pentium III processor running at 450 mhz with 128 KB of memory and 9 GB of Disk storage. Conventional Ethernet interface cards such as the 3-COM 3C905 may be used. The monitor and keyboard are generic and may be any type that interfaces with the motherboard. Such example hardware or its equivalent may be used for all of the local server configurations described herein.

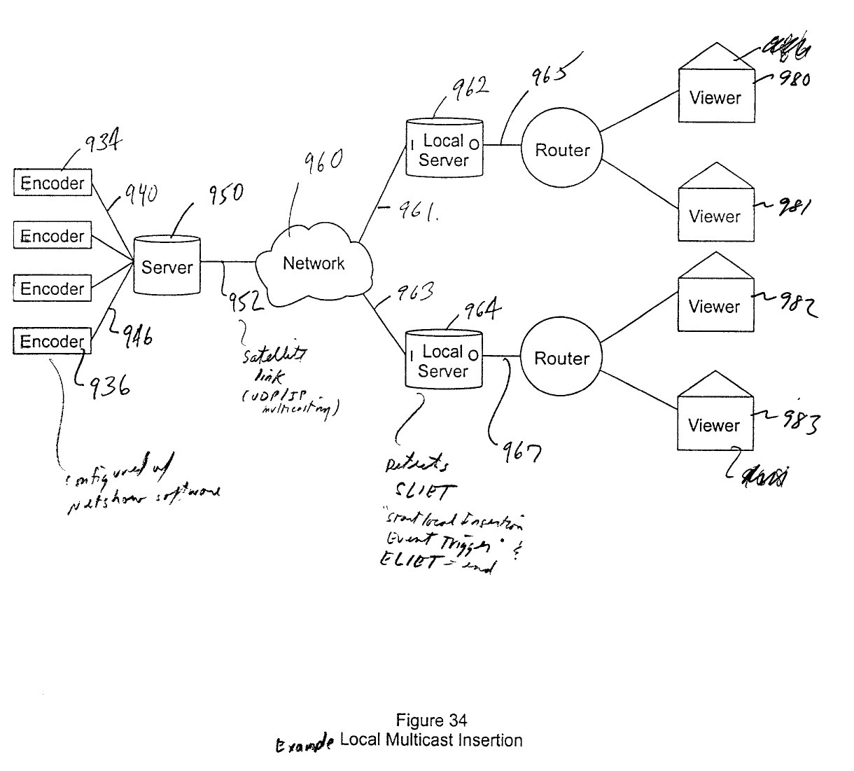

An example of local insertion in a multicast environment is now described with reference to FIG. 34. In the system shown in FIG. 34, encoders 934 . . . 936 are connected to server 950. Server 950 operates to aggregate the information from the encoders 934 . . . 936. Server 950 also schedules the content playlist so that content is delivered in a predetermined manner. The server and the encoders in this example may also be configured with Microsoft Netshow™ software. Server 950 is also configured to output multicast IP streams. Input links 940 . . . 946 from the encoders to the server are typically two-way in a NetShow™ system to insure the reliable transformation for information from the encoders to the server. The encoders may be live encoders or servers that contain stored information.

Data link 952 from the server to network 960 is assumed to be a UDP/IP multicasting link as are links 961 . . . 963 from network 960 to the local servers, 962 and 964, and from the local servers to the viewers 966 and 968. Data link 952 is preferably a one-way satellite link with no back channel for the link or the UDP/IP or multicasting data delivered through link 952 to the network 960. Data link 952 may be provided by a private or commercial multicasting service such as, for example, CoolCast, Inc., a wholly owned subsidiary of StarGuide Digital Networks, Inc., of Dallas, Tex., and Reno, Nev. The CoolCast™ multicasting service utilizes StarGuide MX3TM Multiplexers and Network Management Systems, StarGuide(® II or III Satellite Receivers and associated StarGuide Ethernet or eDAS™ cards and CoolCast™ browser plug-in software provided by StarGuide Digital Networks, Inc., of Dallas, Tex., and Reno, Nev.

The above mentioned NetShow™ streams use the well known “ASF” file format for transmitting the audio, video and other content information. One feature of the ASF format is the ability to embed data as well as audio and video. This data can be associated temporally with the audio and video information. Often such embedded data is used to deliver a caption for a video/audio stream. The caption can also be made to vary with time to display dynamic content related information. A particular type of embedded data is called an Event Trigger. This event trigger is typically used to trigger something to occur at the viewer. There can be different kinds of Event Triggers imbedded in the streams to effect different actions at the viewer.

In the example system, an Event Trigger, called Start Local Insertion Event Trigger (SLIET) is inserted at server 950. This trigger is inserted before each commercial. The SLIET is detected at the local server 962 and 964 instead of at the viewer(s) 980, 981, 982 or 983. When the local server detects the SLIET, it begins streaming local audio or video content from the local server instead of passing the content received from the network 960 directly to viewer(s) 980-983.

A second trigger, End Local Insertion Event Trigger (ELIET) is embedded at the end of the national commercial to allow notify the local insertion server to switch back to the pass through mode. With such architecture, Local Server 962 and Local Server 964 can contain different local commercials. When each received the same SLIET, the viewers would observe different local commercials.

Example pseudo code which may be used by a local server for implementing the above functions is shown immediately below:

Initialize to receive multicast traffic on input I

Initialize to output multicast traffic on output 0

Top: Wait for a data packet from input I

If the data packet is a Start Local Insertion Event Trigger

Set to play from the hard drive

Begin reading local content specified by trigger

Else if data packet is End Local Insertion Event Trigger

Set to pass data from I to 0

Stop reading local content specified by event trigger

If data packet is audio or video

If playing network feed I

Pass packet to output 0

Else

Ignore the received data packet

GoTo Top

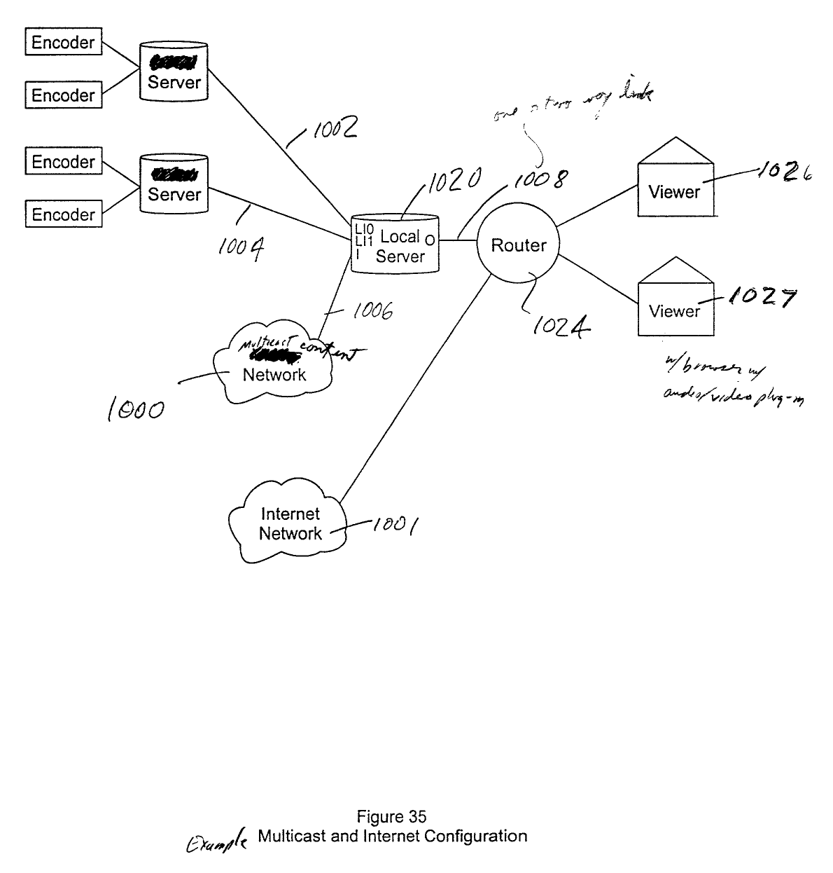

Referring now to FIG. 35, the architecture depicted illustrates how a multicast network 1000 may be combined with the Internet network 1001 to form a powerful local content insertion system. Using this architecture, Local Server 1020 can output either stream 1002, 1004, or 1006 based on the local event trigger. The output 1008 of 1020 is a multicast stream and is input to router 1024 where it is combined with input from the Internet 1001. The combined signals are then routed to the appropriate “viewers” 1026 or 1027 depending on their requests. Connection 1008 may be a one-way (i.e., no back channel) UDP-only connection, thus carrying only IP multicast traffic, or it may be a two-way TCP link, which can also transmit UDP data. If it is a two-way link, then local server 1020 can control and/or be controlled by external devices whose input flows from router 1024.

In this example system, content viewers (1026, 1027) may, for example, be standard Internet browsers viewing web pages with embedded audio/video plugins. The HTML web pages may be delivered via the Internet 1001 in the conventional manner using TCP/IP links. A separate multicast video/audio network 1000 provides the video/audio content to the local server where it is either passed to the router or an alternate local stream is substituted. The viewers (1026, 1027) may also be stand-alone media players that interact with the Internet 1001 to receive program guide information and interact with the multicast network 1000 to receive multicast audio and/or video information.

Local server 1020 in FIG. 35 also allows other functionality such as delayed playing (“delay play”) of multicast audio/video content. Since 1020 sits between the network feed, 1002 and router 1024, it (1020) can also delay any signal received from the network and replay it at a fixed time delay. In this fashion, the users 1026 and 1027 would see a delayed version of the network feed. Such a system allows a single network feed to originate on the east coast and be delivered to local servers in central, mountain and pacific time zones, delayed appropriately for each time zone. Viewers in each of these time zones would, for example, see the six o'clock network news at the correct time in their respective local time zones.

The storage resources at the network feed stores the multicast audio, video and graphics as well as the event triggers that are sent in the network feed. When the stored information is later retrieved and processed by local server 1020, all embedded event triggers will behave as described above.

Delay play processing occurs before event trigger processing. A first-in-first-out (FIFO) queue is used as a delay play queue which, due to the magnitude of the information and length of the time delays, it is preferably implemented on hard disk or other suitable high speed mass storage. Example pseudo code which may be used for implementing the delay play feature on a server is shown immediately below:

Initialize to receive multicast traffic on input I

Initialize to output multicast traffic on output 0

Top: Wait for a data packet from input I

// delay play processing

Timestamp and save packet at end of delay play queue

Retrieve packet from head of queue with correct timestamp

// local insertion processing

If the data packet is a Start Local Insertion Event Trigger

Set to play from the hard drive

Begin reading local content specified by trigger

Else if data packet is End Local Insertion Event Trigger

Set to pass data from I to 0

Stop reading local content specified by event trigger

If data packet is audio or video

If playing network feed I

Pass packet to output 0

Else

Ignore the received data packet

GoTo Top

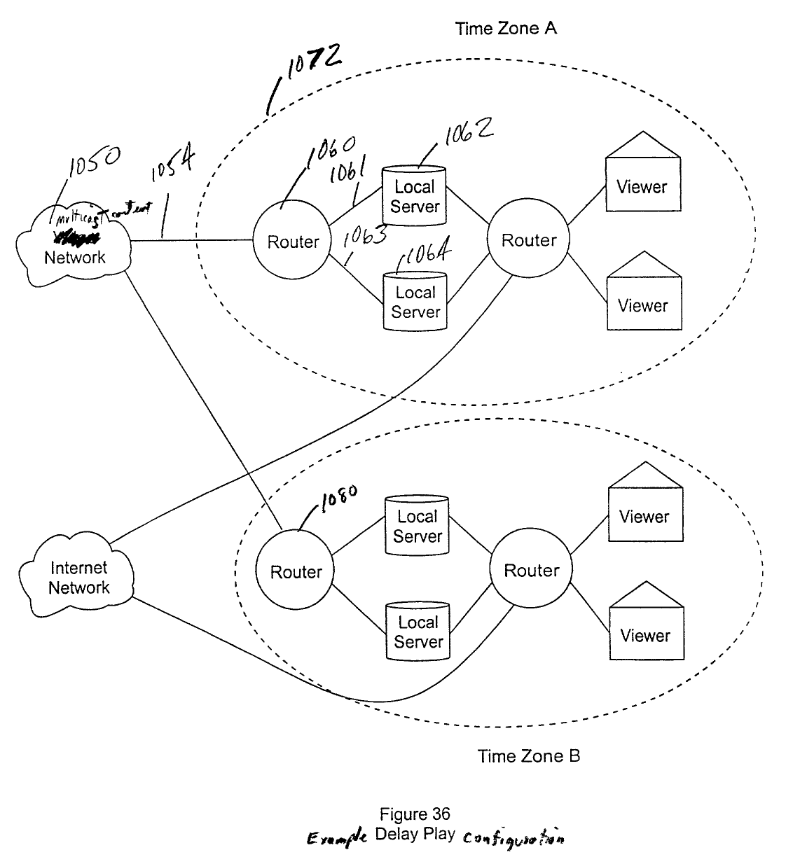

The above example system concept may be scaled as the bandwidth delivered by the network is increased. For example, FIG. 36 illustrates an example arrangement for commercial insertion and delay play systems in different time zones each with multiple local servers that were added to handle increased bandwidth from the multicast video/audio network. In time zone 1072, local servers 1062 and 1064 receiver the inputs from router 1060. This router receives its input from multicast video/audio network 1050. Router 1060 functions to split the multicast traffic received from network 1050 into multiple flows that can be accommodated by local servers 1062, 1064. For example, router 1060 may be any appropriate mechanism that delivers and limits the traffic delivered to each local server to a manageable number. In the case of a router, splitting of multicast data traffic is performed based in the multicast address of the various content flows. Each flow (1061, 1063) has an associated 1Pv4 multicast address of the form a.b.c.d, where a is any address in the range of 224 through 239. in this example, the b, c and d components of the multicast group address are arbitrary. The router 1060 can examine each incoming packet on link 1054 and determine which output link it go to (1061 or 1063).

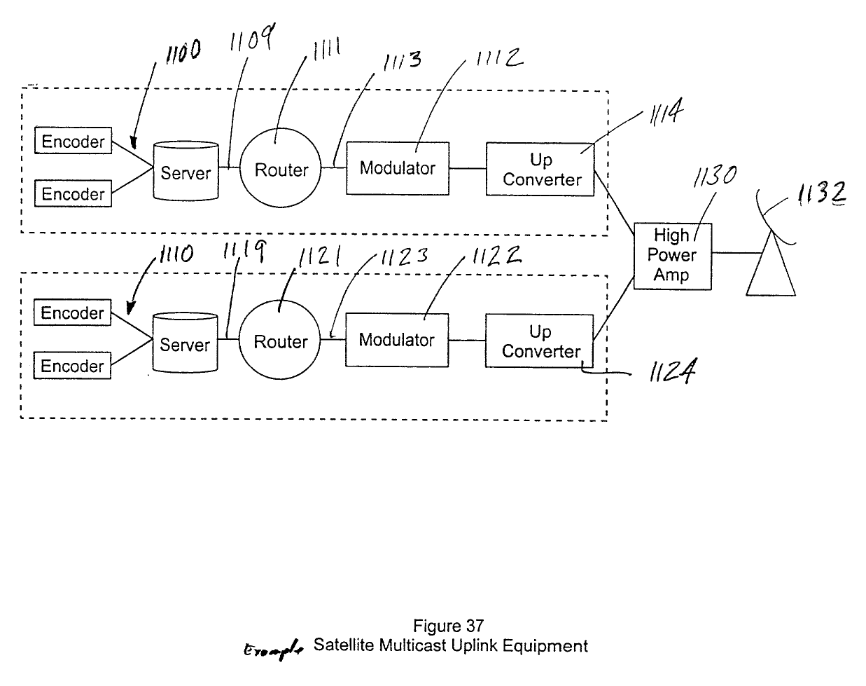

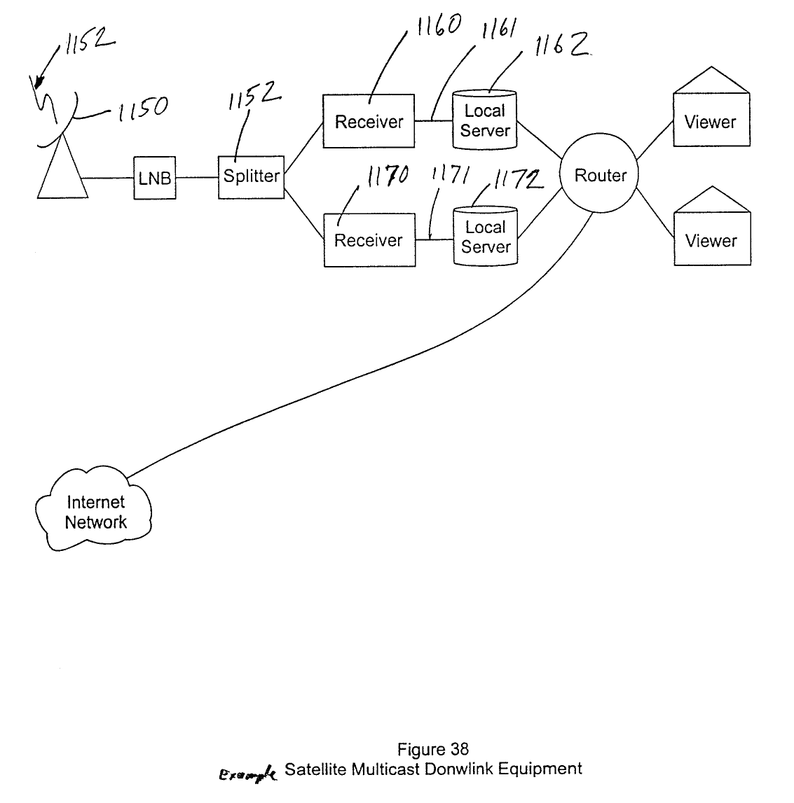

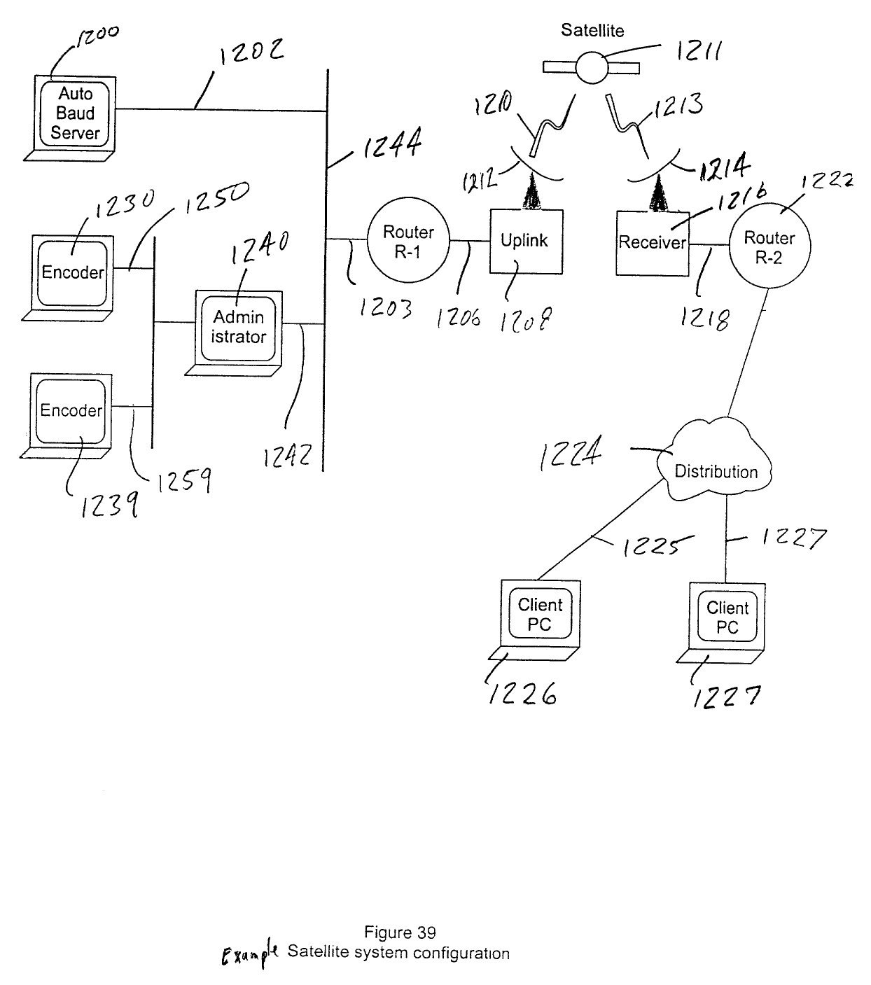

When using a satellite backbone arrangement in a multicast content distribution network, such as shown in FIG. 37, the multicast data/content may be pre-segregated at the satellite uplink by transmitting pre-defined groups of encoded signals at different frequencies as determined by the upconverters 1114 and 1124. In the example satellite backbone distribution network of FIG. 37, two groups of encoded signals, 1100 and 1110, are used. Routers 1111 and 1121 are used to filter out all non-multicast traffic. The routers outputs 1113 and 1123 is only IP multicast traffic. Each of these flows are modulated (by 1112 and 1122) and upconverted (by 1114 and 1124) and fed to a high power amplifier, 1130 and fed to antenna 1132 for transmission to the satellite. The routers, 1111 and 1121 also perform other functions in this system. For example, they provide an electrical conversion from the Ethernet signals (1109 and 1119) to the voltage levels necessary for the modulators 1112 and 1122. Additionally the routers encapsulate the IP multicast packets in the HDLC error detection protocol for transport via the satellite. In an example system shown in FIG. 38, satellite receivers 1160 and 1170 remove the HDLC wrapper.

Referring now to FIG. 38, an example downlink receiver system is disclosed. A downlink signal is received by antenna 1150 and in turn passed on to a low noise block down converter (LNB). The LNB brings the frequency of the signal into the range acceptable for receivers 1160 and 1170. The splitter 1152 divides the input signal equally for input to the receivers, These receivers (for example StarGuide II) convert the received radio frequency (RF) signal into electrical signals for the format necessary to feed into local servers 1162 and 1172. The signals (1161 and 1171) present at the output of the receivers are IP multicast packets on ethernet and are an identical copy of signals 1113 and 1123 of FIG. 37. The local servers and the remainder of the system may be the same as used in the previously described uplink arrangement. The example multicast system of FIGS. 37 and 38 as described above eliminates the routers (1160 and 1180) of FIG. 36.

Referring now to FIG. 39, a preferred example of a satellite backbone implementation of a multicast content distribution system satellite uplink is described in greater detail. In this example, one or more video/audio encoders 1230 . . . 1239 are connected to administrator server 1240. The administrator assembles various inputs 1250 . . . 1259 from the encoders into a multicast stream 1242. The various segments, 1202, 1242 and 1203 are connected together by a hub or a switch (1244) and form a LAN segment. The multicast output from the administrator flows into router P-i where it strips off the Ethernet protocol from the IP packets and encapsulates the packets with the HDLC protocol. The HDLC encapsulated packets are then sent to the uplink facility 1208. The uplink converts the signal received from 1206 into a radio frequency (RF) signal 1210 where it is sent to a satellite 1211.

The satellite effectively acts a mirror and reflects the RF signal to the downlink antenna 1214 where the RF signal is converted into an electrical signal by satellite receiver 1216. The receiver also strips off the HDLC protocol wrapper and adds the Ethernet protocol around the IP multicast data. The output of the receiver, 1218, is nearly identical to the signal present at 1203. The satellite acts as a transmission system and could be replaced by any transmission system such as fiber optics.

The output of receiver 1218 is connected to router 1222. In accordance with RFC1112, this router does not output the received IP multicast signal until it receives a IGMP join request from client/recipient computer(s) 1226, 1227. This join request could arise from a media player such as, for example, Microsoft NetShow™ Media Player on a user/client system. Distribution cloud, 1224, could be ADSL, cable modems or dial up modems. This cloud consists of switches, routers, DSLAMS and/or other networking gear. It is the responsibility of this distribution infrastructure to distribute the information received by router R-2, 1220, to the proper client PC through networking techniques.

The last mile connections, 1225 and 1227, may consist of ADSL connections that operate at different data rates. These same connections may be dial up analog modems using V.90 transmission technology and each of their connections may be at different data rates. Since the last mile connections 1225 and 1227 support different and unknown bit rates, a system to determine the bitrates of these last mile connections is necessary since the client PC's (1226 or 1227) must connect to a video/audio stream whose bitrate is less than the bitrate of the last mile connection. The system shown in FIG. 39 simulcasts the same video/audio content at various bit rates. If the client PC knows the bit rate of his/her transmission path, then it can connect to a compatible video/audio stream.

Various systems have used round trip packet transit times to estimate the data rate of the transmission facilities. The system shown in FIG. 39 has components, 1212 and 1213, that are inherently one-way. A method of determining the bitrate of the transmission path from 1244 to a client PC such as 1226 is needed so that the client PC can connect to a compatible video/audio data stream.

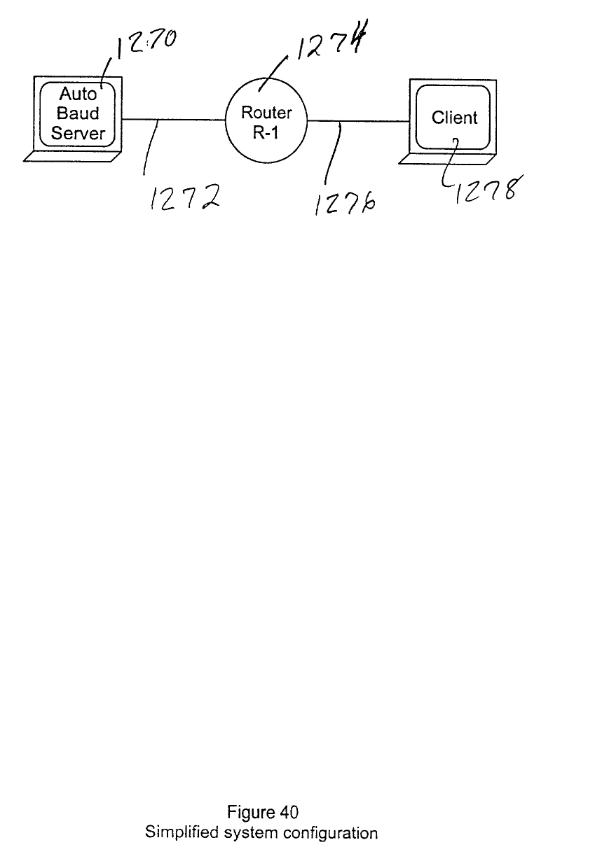

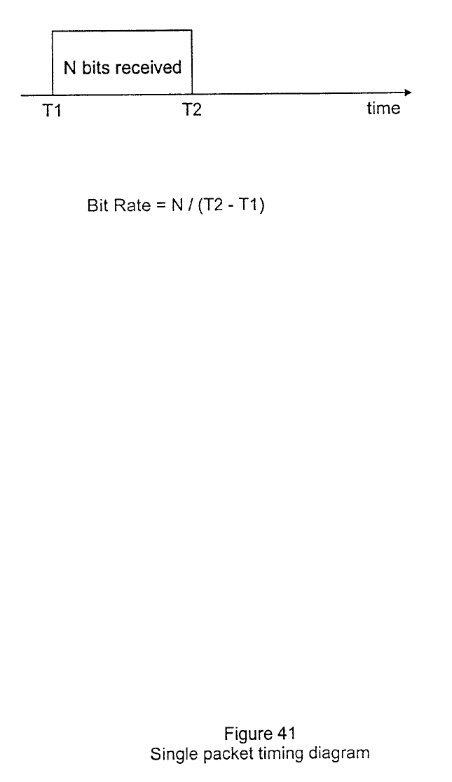

FIG. 39 shows the AutoBaud server 1200 connected to hub 1244. This server forms the heart of the automatic bit rate detection system. FIG. 40 illustrates an example AutoBaud system arrangement which is basically is a simplified version of the transmission system shown in FIG. 39. One function of AutoBaud server 1270 is to occasionally send out a data packet of a known number of bytes. In a typical arrangement, a packet of 1024 bytes (8192 bits) is sent out every second. For this example, assume connection 1272 is a 100BaseT Ethernet line going into router R-1 (1274) and connection 1276 from router 1274 operates an unknown bandwidth. For purposes of this explanation, assume also that the bandwidth on line 1276 is 300 kbs. The AutoBaud server 1270 outputs the 1024 byte packet in 81 microseconds (1024*8/100* 10⁶) to the router. The router outputs the packet over link 1276 in 27 milliseconds (1024*8/300*10³).

As can be seen from the above example, router 1274 receives the entire packet and outputs and entire packet. The speed at which router 1274 receives the input packet has no effect on the time it takes to deliver the entire packet to client 1278. In this case, only the speed of link 1276 effects the packet transmission time to client 1278.

The following formula can be used to describe the bit rate on line 1276:

Bit Rate=bits received/time to receive the packet

The number of bits in the received packet is determined by client software such as, for example, WinSock™. The time to receive the packet is a number that is much more difficult to obtain form standard Internet software. It requires that the reception software start a timer at the beginning of the packet and terminate the timer at the end of the packet. The timer must be a high resolution timer since the times involved are short. An example timing diagram is shown in FIG. 41.

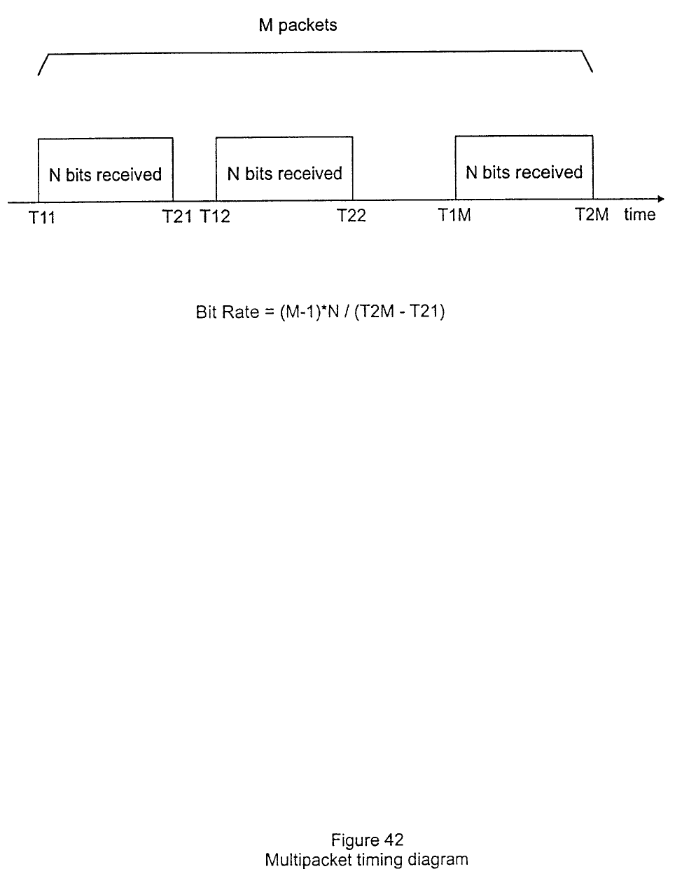

Typical Internet software only has the time that the last bit has arrived. Referring to FIG. 41, this means that only time T2 is available for measurement. An example implementation of a bit rate measurement system that is based only on the end of packet time utilizes AutoBaud server 1270 to transmit M packets each of N bits in length as fast as possible. These packets arrive at router 1274 and are retransmitted on link 1276. If there is no congestion at 1274, the packets are output at the fastest rate allowed by the inherent bit rate of link 1276. Such is illustrated by the timing diagram of FIG. 42. In this case, only the times T21, T22, . . . T2M are available for measurement. Assuming that the interpacket times are small compared to the total packet times, the bit rate of link 1276 is defined by the following formula:

Bit Rate=(M−1)*N/(T2M−T21)

If there is congestion in the router and the inter-packet time grows, then the effective throughput from server 1270 to client 1278 is reduced. This approach can be used to measure the effective throughput for the entire link from the server to the client including all the intervening networking equipment.

The packet transmission scheme shown in FIG. 42 has the added benefit that the average bit rate can be made as low as desired by spacing the M packet bursts by a predetermined value. Ambiguity in the above bit rate calculation is reduced as the number (M) of packets transmitted per burst is increased. It is important that the total number of bits transmitted (M−N) be kept to reasonable values to prevent buffer overflow on the input side of router 1274. A typical value for M is 4 and N is 8192 for a total of 32,768 bits per burst. Assuming that the M packets, are burst at 1 burst every 3 seconds, then this gives an average bitrate for the measurement stream of 10.9 kbs (32,768/3).

Often transmission systems have the capability of compressing data before transmission and decompressing the data after transmission. This is done to reduce the number of bits transmitted. Such compression would result in an erroneous estimate of the link data rate since the time to transmit the compressed packets could be substantially less than the uncompressed packets. (To minimize the possibility of compression occurring when determining data rate, the packets should consist of pseudo random numbers of sufficient period to prevent the compression equipment from performing any compression—which relies in part on the fact that random data values cannot be effectively compressed). A practical value for the repeat length of the bit patterns for this example is 32,768 bits.

Broadcasting (verses unicasting) is an efficient method of distributing information. In the broadcast model, such as radio and television, information is transmitted even if no listeners are “tuned in.” Such a broadcast model is impractical in the digital networking world because of the enormous network bandwidth requirements. Consequently, multicasting is a more practical method of implementing broadcasting in the digital network environment. The multicast model only forwards traffic to users that are “tuned in.” If no users are tuned to a channel (or in networking terms, connected to a group address), then no information is transmitted to that user and no bandwidth is used. This simplistic view of multicasting is meant to under score the fact that multicasting attempts to minimize the network bandwidth needed for a one-way broadcast of information. multicasting as such is specified in RFC-1112 and is an Internet standard implemented in all modem networking equipment such as routers and switches.

In a video/audio on demand (VOD) system, each client receives only the information requested from the server. This system is in contrast to a multicast system in which the information constantly flows. Conventional VOD systems typically require two-way information flows while conventional multicast systems are inherently one-way. Conventional television and radio broadcast systems are also examples of one-way systems since there is no path from the listener back to the sender. A problem with conventional broadcast and multicast systems is that a signal is typically broadcast only once or at specific times and is generally not readily accessible by a consumer at a convenient or subsequent time or available on demand. The VCR somewhat solves this classic problem for the conventional television/cable broadcast industry, since a VCR can be programmed to record information broadcast at specific times and on specific channels. Newer devices have come to market which may replace the VCR by a hard disk recording system. Unfortunately, most if not all of such equipment is primarily designed to record analog video/audio signals. Although one recently available system is capable of recording digital content (e.g., the TIVO™ system), it is not operable or practicable for use in obtaining multicast or conventional digital content from the Internet or other digital network.

One following further aspect of the present invention provides an improved solution to the above problem. An example arrangement of the present invention is disclosed below for recording digital video/audio IP multicast information for later playback. Although a preferred environment in which the present system operates encompasses the Internet and the associated world wide web (WEB), it is not necessarily limited to the Internet environment. The disclosed example arrangement includes, for example, at least one or more of the following features:

Display of program play times and channels (Electronic Program Guide)

An ability for selecting the content to record

An ability for recording the content

An ability for playing the content at a later time

An ability for deleting recorded data.

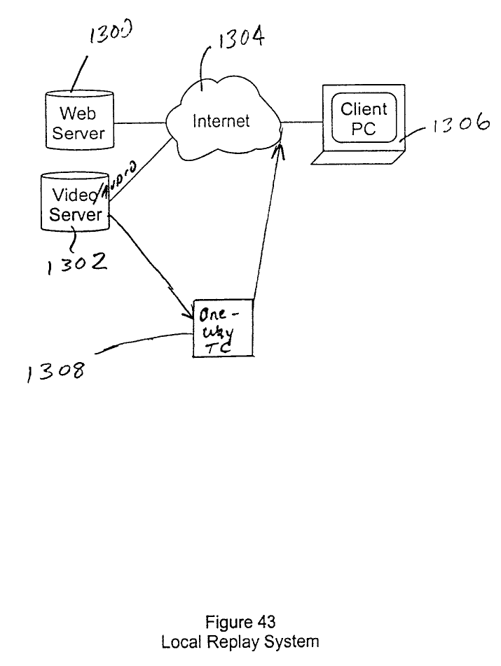

The high level view of an example embodiment of a local replay and/or demand play system arrangement is shown in FIG. 43. Web pages are served by the web server 1300, video/audio multicast streams are served by the Video/audio server 1302 and the web pages and video/audio are delivered to client PC 1306 by the network 1304. FIG. 43 illustrates an example arrangement for serving web pages, video/audio and displaying both on a client PC and shows how multicast video/audio content may bypass the congestion of a digital network, such as found on the Internet, and be combined at an ISP for delivery to a client PC. This alternate arrangement for digital content delivery results in text, video and/or audio delivered to a client PC via 1308. The client PC may use standard web browser software such as Microsoft Explorer 5.0 and a media player such as the Microsoft Media Player 6.0. Web pages written in HTML or the newer XML markup languages are adequate for displaying an Electronic Program Guide (schedule of times, dates and channels). However these markup languages are insufficient to allow the user to select several of the channels for later recording and perform validation on the selections.

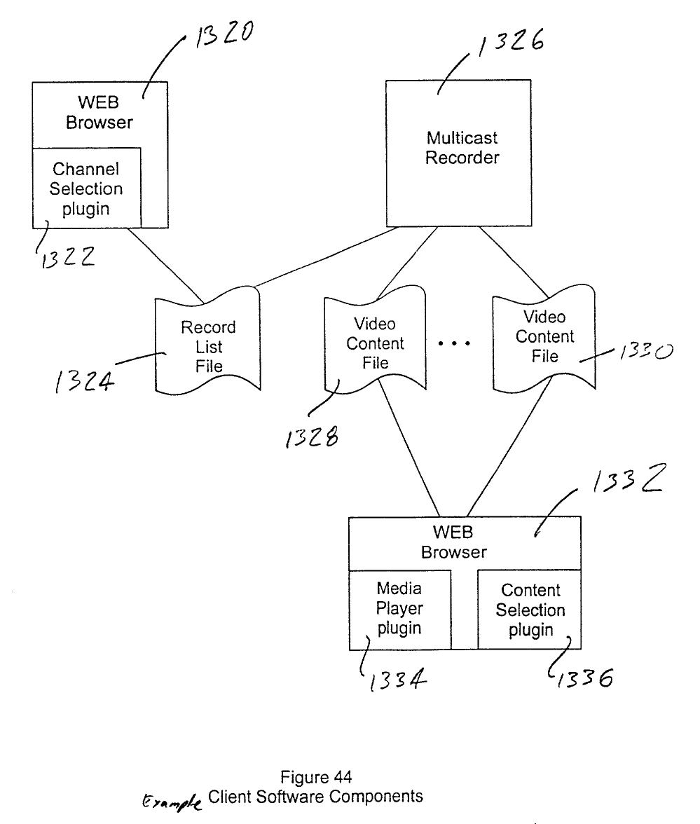

FIG. 44 shows example client software components of the system. Extending WEB browser 1320 via a Channel Selection “Plugin” or active-x control 1322 provides the channel selection functionality. The Channel Selection plugin 1322 writes the channel selections to the Record List file 1324 on the Client PC for use by multicast recorder 1326. In a preferred example embodiment, the multicast recorder 1326 is an executable program which is launched at system startup and is continually reading the Record List file to determine what recording actions are to be performed. The multicast recorder “tunes into” the proper channel at the specified times and records the incoming data stream in a Video/audio content file 1328 . . . 1330. The name and location of this file is specified by the Channel Selection plugin 1322.

The multicast recorder 1326 continuously operates in the background to record the specified information into Video/audio content files. These files may be stored in an encrypted format and its playback can be restricted. Storing the file in an encrypted form, allows the file to be played on computers that have permission to play the file. This permission may be optionally granted to any computer or playback may be restricted to computers that have paid for the right to play the file. In this example embodiment, the Microsoft Netshow 4.0 encoding with Digital Rights Management is used to perform the security functions used in this recording device. WEB browser 1332 with the Media Player plugin 1334 and the Content Selection plugin 1336 is used to select and playback the recorded content.

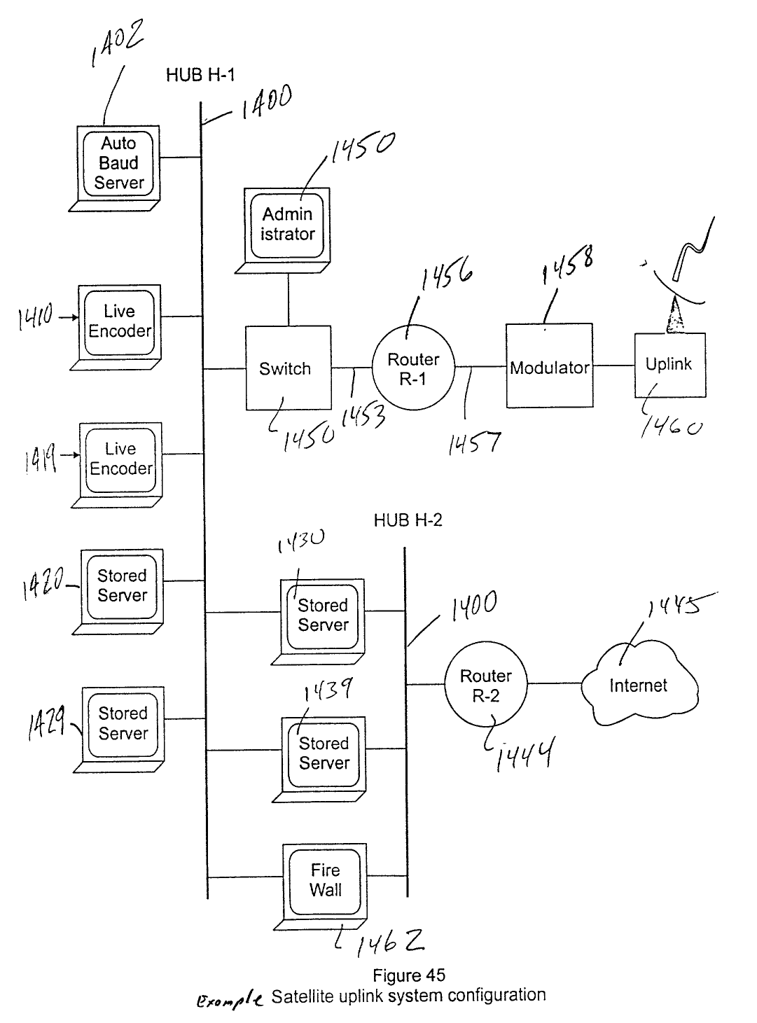

An example uplink portion of a one-transponder satellite multicast system is shown in FIG. 45. Hub H-1 (1400) connects AutoBaud server 1402, live encoders 1410 . . . 1419, stored content servers 1420 . . . 1429 and switch 1452. Switch 1452 is used to isolate the Ethernet collision domains thereby reducing network collisions and improving network performance. An administrator 1450 may also be used in conjunction with switch 1452 for transmission scheduling and control.

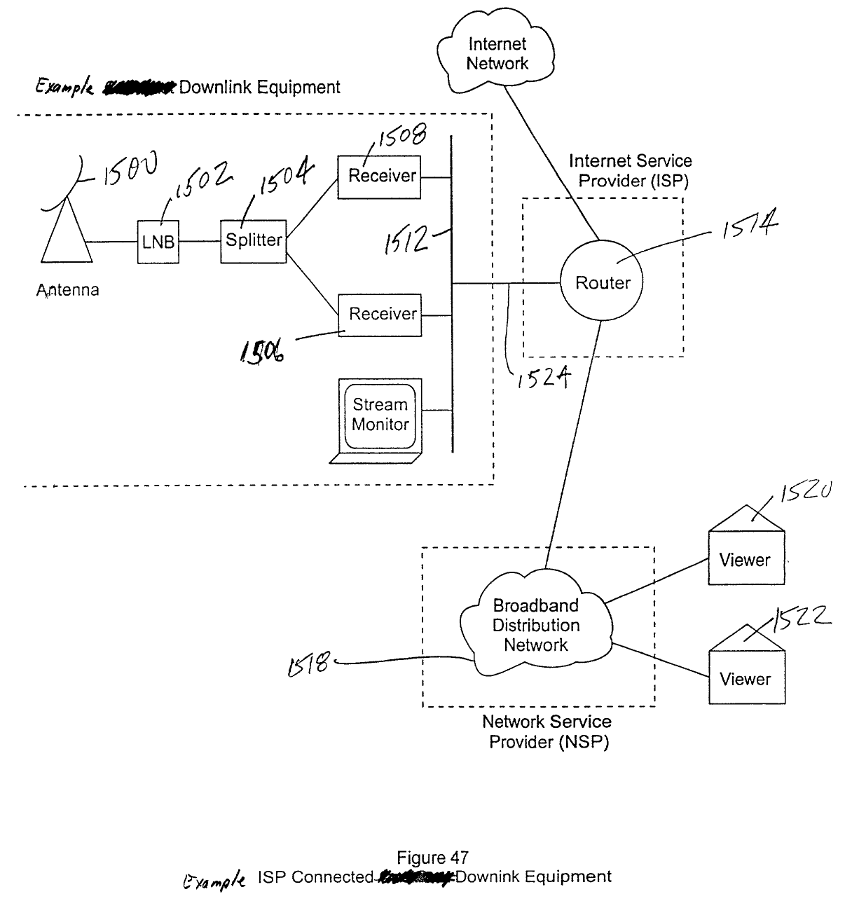

Router 1456 takes Ethernet signal 1453, strips the Ethernet encapsulation, adds HDLC encapsulation and outputs the signal via HSSI onto line 1457. The router is used to filter all unwanted traffic so that the only packets flowing on 1457 are IP multicast packets. Modulator 1458 converts the incoming HSSI level signals into 70 mhz RF signals with the appropriate error correction and modulation compatible with the satellite downlink receiver 1506 (FIG. 47). The uplink facility 1460 receives the IF signal 1459, upconverts the signal to the KU band frequency range, amplifies the signal and feeds the signal to an antenna where it is transmitted to a satellite. Multiple live encoders, 1410 . . . 1419, stored receivers 1420 . . . 1429 and stored content servers 1430 . . . 1439 feed their content into administrator 1450 that schedules the content for transmission. The output of administrator 1450 is sent to router 1456 for transmission.

In this example, router 1444 is connected to the Internet for providing communications for maintenance, control and bulk file transfers. This arrangement allows complete access to the network segment 1400 from the Internet. To insure security, all access to the internal network is made through Firewall 1462. A Virtual Private Network (VPN) is setup between firewall 1462 and the Network Operations Center (NOC) not shown in this diagram. No multicast content flows over the Internet, which in this case is used only for monitor, control and bulk file transfers.

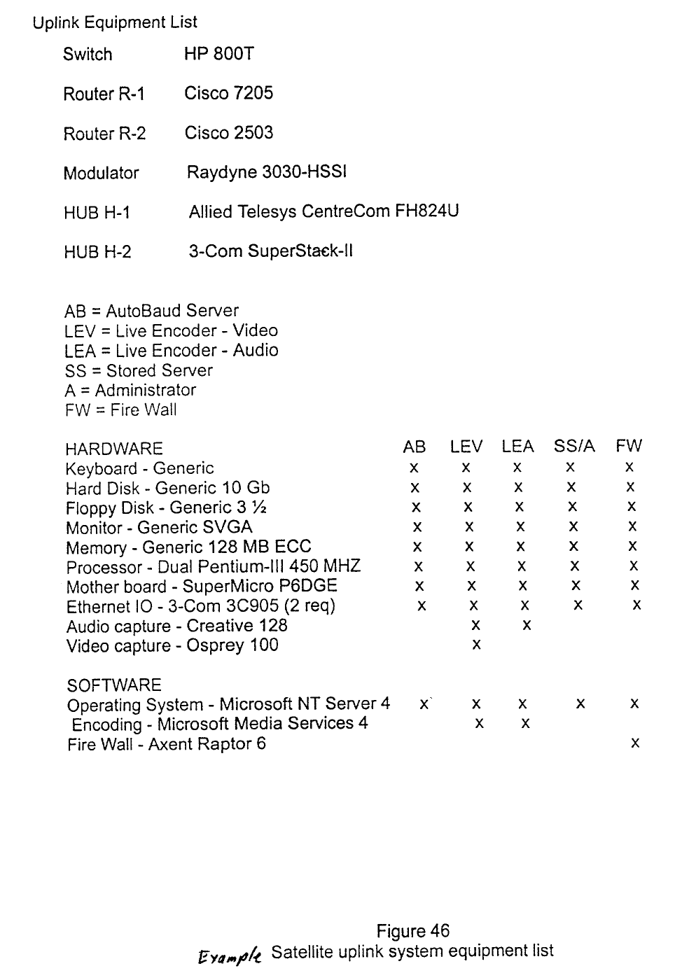

Stored content servers 1430 . . . 1439 are directly connected to the Internet via router 1444. Content providers that are external to the example multicasting system can FTP their content to these servers without being part of the VPN. In this example, five basic example server computer configurations are illustrated in FIG. 45: an AutoBaud Server, a Live Encoder, a Stored Server, a Fire Wall and an Administrator. Example equipment and software which may be used in each of these servers is shown listed in FIG. 46. The uplink facility (1460) may use, for example, Microsoft NetShow™ version 4 software for video/audio compression and distribution. With NetShow™, the stored content servers are themselves administrators. NetShow™ also allows a hierarchical tree structure of encoders.

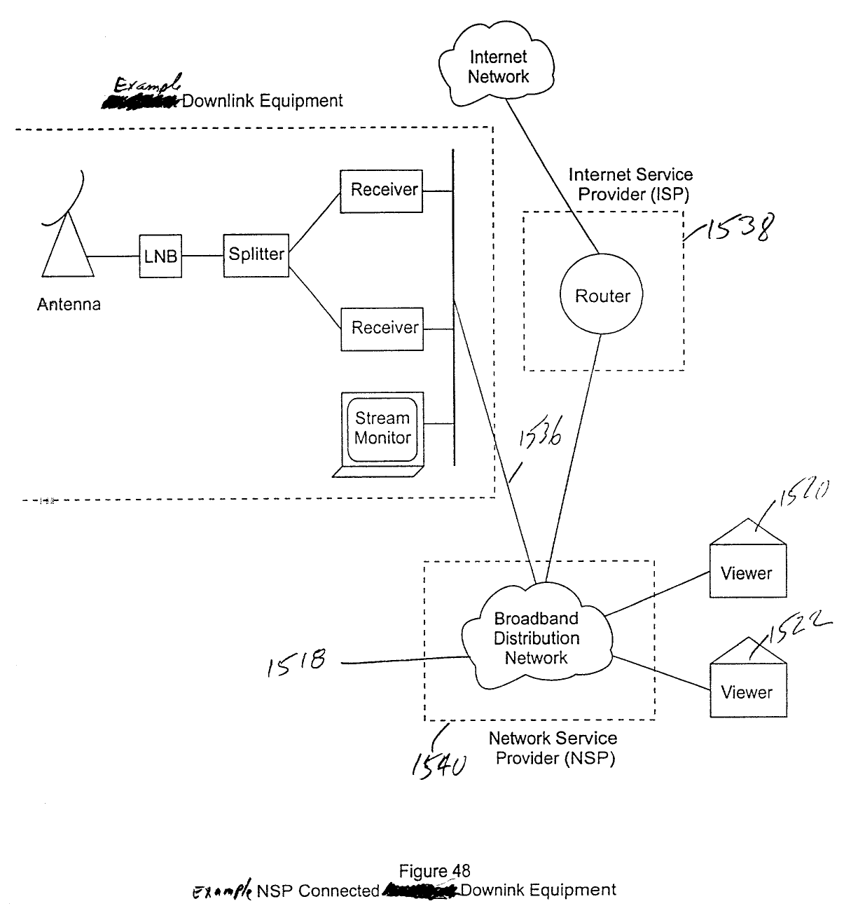

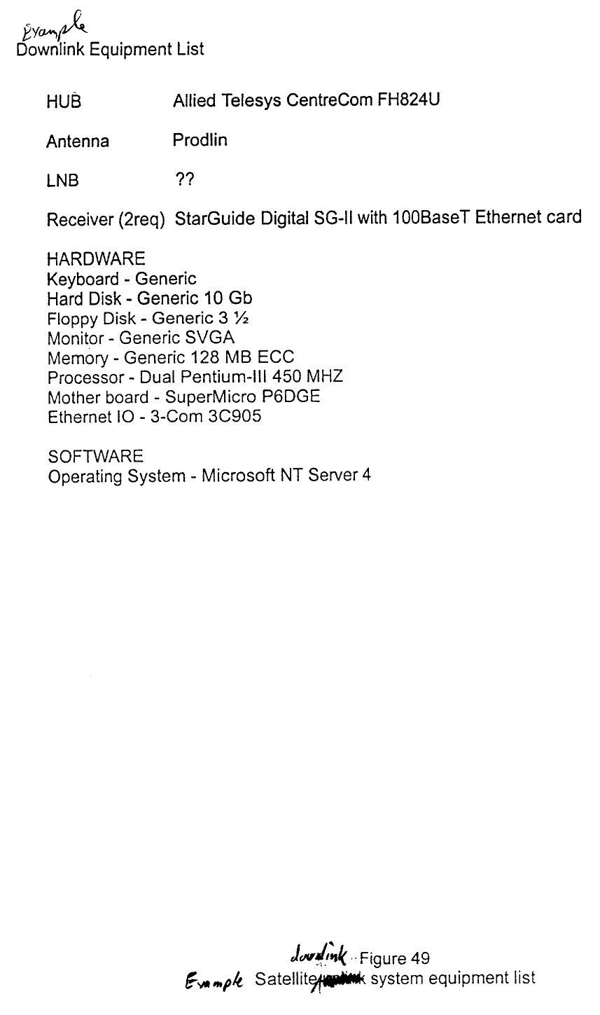

An example downlink side of a one-transponder satellite multicast system is shown in FIGS. 47 and 48. An example hardware equipment list for such a system arrangement is shown in FIG. 49. A satellite downlink signal is received via antenna 1500. This is the signal that was transmitted by uplink 1460 of FIG. 46. This received signal is in the KU frequency band and is down-converted to the L band frequency range by LNB 1502. The down-converted signal is output to splitter 1504 where an equal portion of the signal is sent to receivers 1506 and 1508. These “redundant” receivers output their signals onto HUB 1512 where they are connected to router 1514. In the example embodiment, the output of the receivers is 100BaseT Ethernet. This output format is used because it inexpensively connects into other network devices.

Only one receiver at a time outputs its multicast traffic onto the LAN 1512. Maintenance and control traffic flows to both receivers. The simplest method of providing redundancy is to disconnect the input of the receiver from the splitter and the output of the receiver to HUB 1512 until the receiver is needed. Conventional sophisticated switching equipment is known and available for performing such a sparing.

In the example of FIGS. 47 and 48, computer users 1520 and 1522 connect into distribution cloud 1518. This distribution cloud has traditionally been the POTS circuit switched telephone network. Such POTS based networks are limited to less than 64 kbs of bandwidth per user. Modem broadband transmission technologies such as DSL, wireless and cable modems have changed this distribution cloud so that transmission rates of several hundred kilobits per second an higher can easily be achieved. Such broadband distribution infrastructure may be provided, for example, by a Network Service Provider (NSP) or CLEC (competitive local exchange carrier) such as COVAD or an ILEC (incumbent local exchange carrier) such as Bell Atlantic.

The Broadband distribution network is connected to a ISP (Internet Service =Provider) that has a connection to the Internet. FIG. 47 shows the connection 1524 of the multicast data into the router of the ISP. This allows all users (1520 and 1522) to receive the multicast traffic originating from uplink 1460 as well as web traffic from the Internet.

FIG. 48 shows the connection of the received multicast content 1536 being injected into the NSP's cloud. This architecture has the advantage that customers of both ISP 1538 and 1540 can receive multicast traffic. Such architecture is possible through the use of a device such as the Cisco 6400 router within the NSP's distribution cloud. Another advantage of the present invention is that it allows the injection of multicast content into either type architecture.

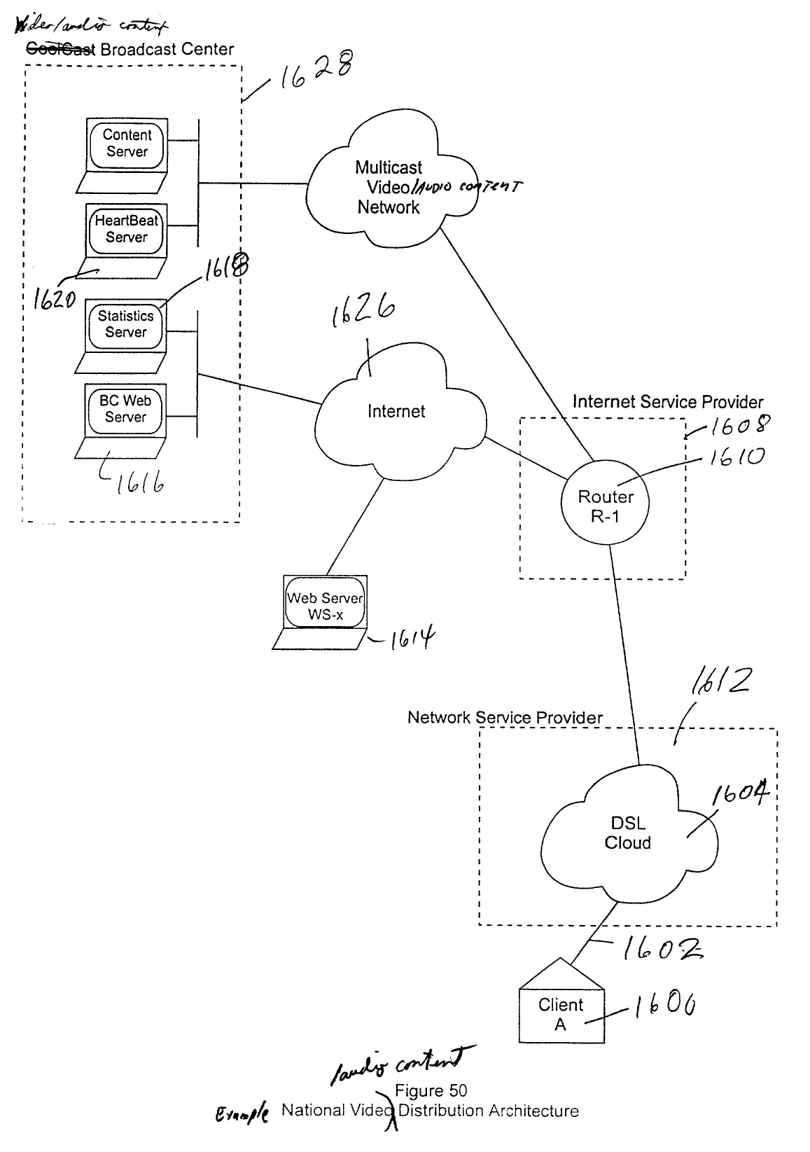

Referring now to FIG. 50, an example system configuration for “national” content distribution is illustrated. User A at a client computer 1600 is illustrated as being connected to a digital communications network via a broadband connection 1602. In this example, the connection is through DSL cloud 1604 and then to router 1610 that in turn connects to the Internet (1626). Often an ILEC (incumbent local exchange carrier) or a CLEC (competitive local exchange carrier), both of which are network service providers (1612), own the broadband DSL cloud 1604 and router 1610 is owned by an ISP (Internet service provider) 1608. In this example, a “national” audio/video multicast content broadcast center 1628 may consist, for example, of video/audio content serving, statistics gathering and web hosting equipment.

In an example implementation, the video/audio content is organized under a “portal” page. This is a web page with an organized list of content providers. The organization of the content is used to facilitate a user's ability to access the content quickly. For the following discussion, assume that the portal page has a URL (uniform resource locator) of, for example, “www.coolcast.com” and the web page content is hosted on web server 1616. The content entries in this example implementation are hyperlinks to content pages which contain the necessary plugins to receive the video/audio content. These plugins may consist of, for example, a media player and the multicast plug-in software. The multicast plugin is responsible for measuring the data rate of the data link to the users computer. It also is responsible for transmitting user statistics back to the broadcast center. The media player plugin renders the audio and video on the users computer.

Client/user A (1600) may request web pages from the broadcast center web server 1616 or web pages from a content providers web server such as 1614 and these web pages are displayed on a conventional browser at client/user 1600 (e.g., a customer's PC) The web pages may contain, for example, standard HTML, DHTML, JAVA, JAVA SCRIPT, etc. and may be transported across the network in a conventional manner using HTTP protocol.

If the web page contains a IP multicast enabled video/audio player plugin such as, for example, the Microsoft Media Technologies Version 4 player, then an IGMP multicast join request will flow from the client/user browser 1600 to router 1610. This web page also may contain the multicast plugin. This plugin is responsible for measuring the data rate of the last mile connection utilizing the techniques described above. This plugin also transmits a UDP packet every n seconds (where n is nominally 15 seconds) back to the statistics gathering server 1618. The information transmitted back to this server is the registration information provided by the user when he/she registered for the first time to this video/audio broadcast service. An example of such registration information may include information such as:

user gender (M/F)

user age group (0-17, 18-24, 25-34, 35-54, 55 or older)

user zip code

user email address

data rate of the user connection if known

Owing to the flexibility of this implementation, other desired information may be similarly gathered and reported to statistics gathering server 1618.

Broadcast center 1628 delivers streaming audio/video content directly to ISP 1608, where it is injected in to router 1610 using the methods described above. The IP multicast address used to deliver the content from broadcast center 1628 to the ISP is in the administrative scope address range (224.0.0.0-239.255.255.255). This allows router 1610 to easily prevent the distribution of multicast content toward the Internet through the administrative scoping mechanism of the router.

The multicast content appears to router 1610 as a local IP multicast server. The distribution of the IP multicast traffic to the customer is accomplished via the DSL cloud 1604 which may consists of ATM, IP, Ethernet or any other transmission technology capable of forwarding multicast and unicast packets simultaneously.

To support the ability to determine the bit rate delivered to the consumer, a low bit rate “heart beat” packet is sent periodically by 1620 and its properties are measured by a browser plugin at client PC 1600. This allows the determination of the bit rate from the content source at broadcast center 1628 to the client computer and encompasses all the intervening network elements.

In this example embodiment, the multicast content is organized into channels. broadcast center 1628 simulcasts the content at multiple bit rates to support video/audio content which may be viewed over data links of varying speeds. All of these simulcasted versions are considered to form a single channel. This multiple bit rate simulcasting technique is particularly useful since a user that has 1.5 mbs data connection expects to see an improvement in the video/audio quality over that of a user connected at 384 kbs. For example, in the example embodiment described herein, the disclosed arrangement supports the ability to simulcast audio, video or other data content at up to 8 different data rates.

In present example, the multicast plugin software determines the appropriate data rate to receive the content based on either the measured data rate of the link or a user supplied data rate and data rates of the simulcasted video/audio. To support content usage tracking, a periodic UDP packet is sent from the multicast plugin at the client PC to a specific predetermined IP address, the target of which is a statistics gathering server typically located at the broadcast center.

A “tear away” feature may also be implemented as a separate web page. This feature allows for use of web page authoring features, for example, to customize the appearance of the “floating” video image displayed on a recipient's computer screen. It also allows embedding of the multicast plugin in the “torn away” video/audio.

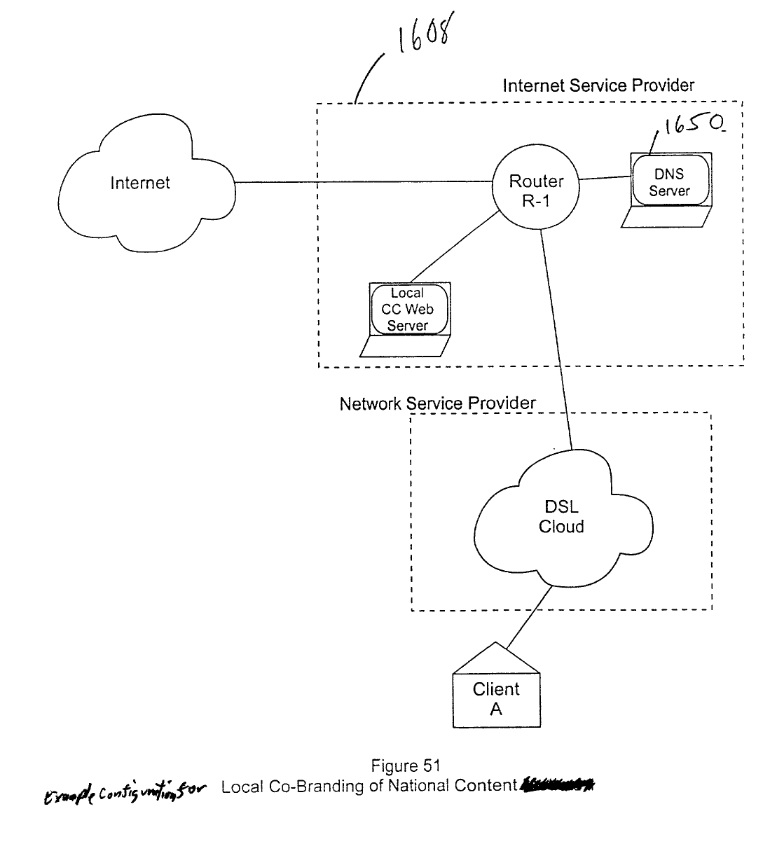

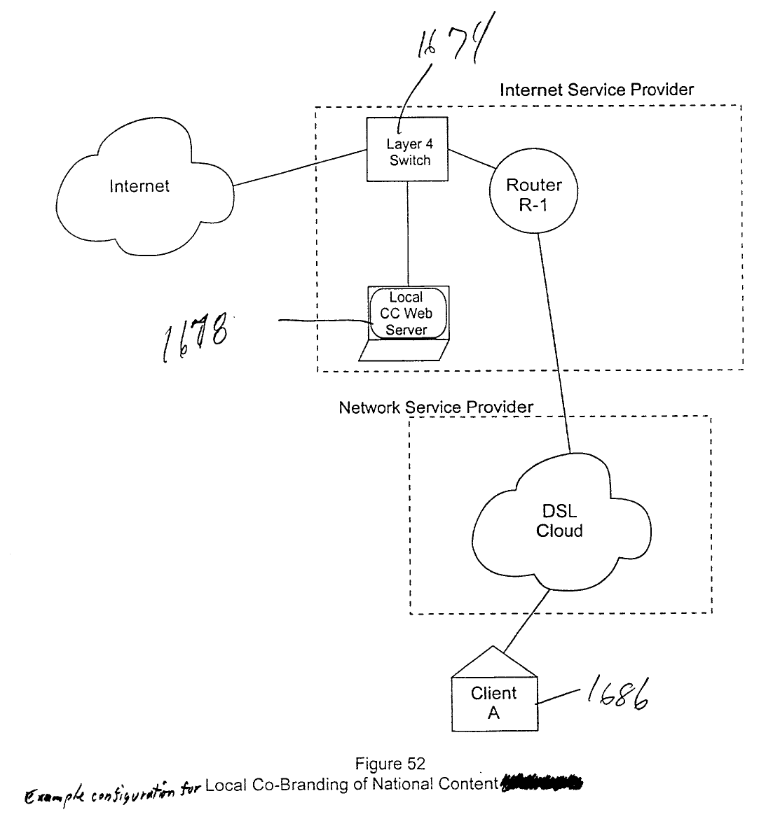

Often a local ISP desires that his/her customers have a localized version of the portal page. This portal page contains the look and feel of the portal page served by 1616 but contains the logo or other information particular to the local ISP. This is often called a “branded” web page or “co-branding.” An example illustration of an arrangement for providing the capability for local co-branding of national content is shown in FIGS. 51 and 52.

For the purpose of explanation with respect to FIGS. 51 and 52, assume that the URL for the portal page is, for example, “www.coolcast.com.” Normally the DNS (domain name server) in ISP 1608 would contain the IP address of server 1616. For the example shown in FIG. 51, DNS server 1650 resolves the domain name “www.coolcast.com.” The DNS entry for the URL “www.coolcast.com” is manually modified by the ISP to point to a local copy maintained by ISP. For the example shown in FIG. 52, a layer 4 switch is provided before the connection to the Internet. The DNS at the ISP receives the request for URL “www.coolcast.com” and resolves it to the IP address of web server 1616. The HTTP request from the browser at consumer 1686 is intercepted by the layer 4 switch 1674 for “www.coolcast.com” is intercepted and is provided by local web server 1678. This method is similar to that used in web site mirroring architectures.

In the example embodiment, each content providers web page announces the data rates that the content is being delivered. This announcement is in the form of additional parameters on the multicast plugin embed statement. Example parameters may include one or more of the following:

the channel number (0 . . . 2047)

the bit rate of the data link to the client PC (0 . . . 10000 kbs)

the type encoding (e.g., Microsoft NetShow, Real Networks G2, . . . )

the version of the encoding method (0 . . . )

a list of the data rates at which the video/audio or audio is encoded

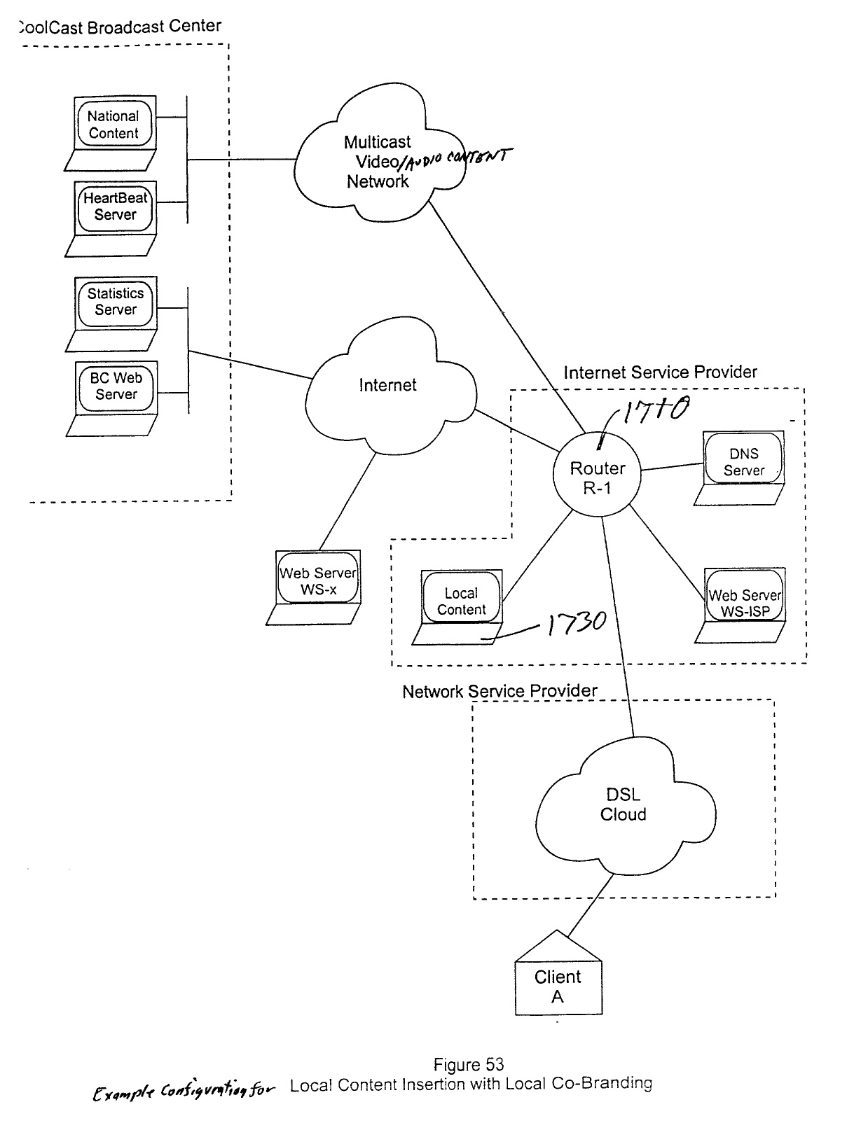

FIG. 53 illustrates an example system configuration for the insertion of local content/programming. In this example, local content insertion may include local co-branding. The primary difference between the system of FIG. 53 and the system of FIG. 50 is the addition of local content insertion into the ISP router 1710 via server 1730. This content utilizes the same address space as the “national” content and the channel (and thus the IP multicast address) assignment is dictated by the broadcast center. In this example, the co-branded portal page and channel summaries may be hosted on the local ISP web server as discussed above (FIGS. 51 and 52). Information on the available data rates of the multicast content (both local and national) may be provided as a part of the content provider's web page and is made available to the multicast plugin software used by the client/recipient.

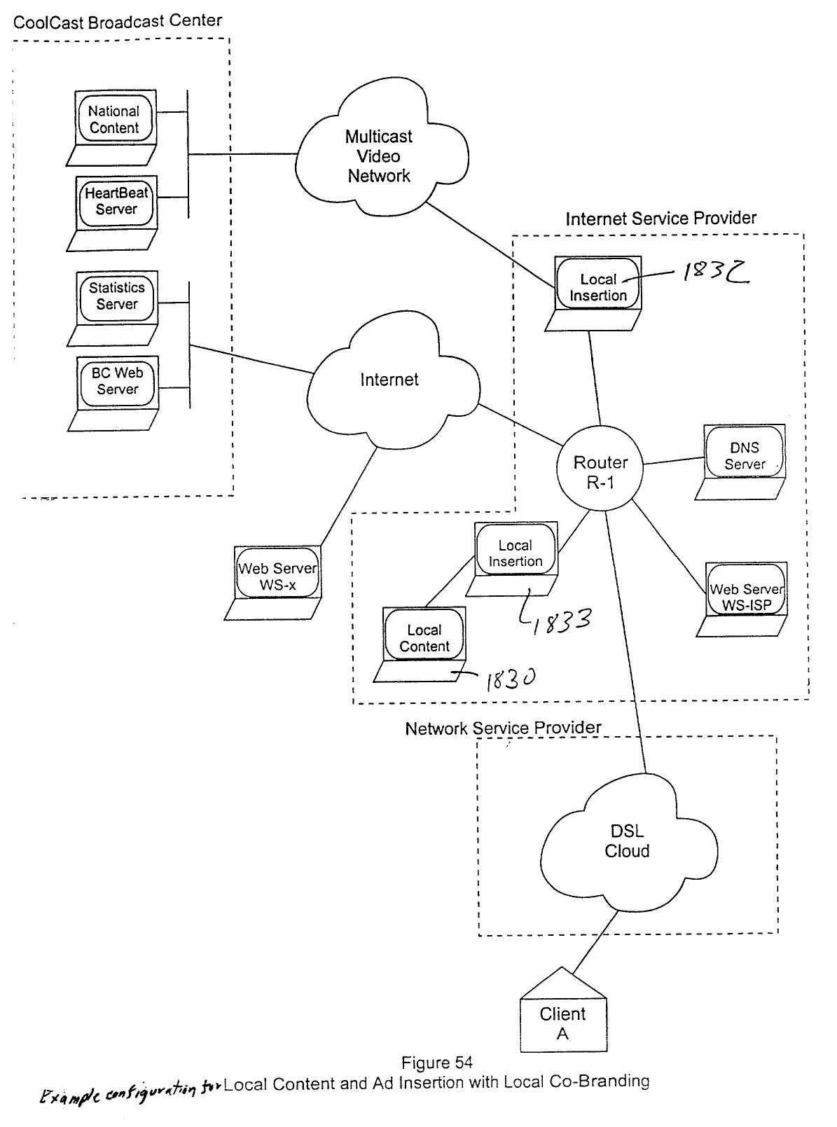

FIG. 54 illustrates an example system configuration for the insertion of local content/programming and/or advertisements (commercials). In this example, local content and advertisement insertion may include local co-branding. Local IP digital data content insertion is accomplished by using server device 1832 which reads an incoming video/audio stream and looks for local content insertion instructions. When a local content insertion instruction is detected, the output of server device 1832 switches from the national feed to a local feed that contains the local content to be inserted. A similar insertion process may occur using server device 1833 which inserts local commercials into local content/programming supplied by server 1830.

The above described architecture(s) effectively elevate the multicast video/audio distribution network of the present invention to the status of a national television or cable network. The implications are that national and local programming and advertising are supported in a similar manner to that of today's traditional media networks, resulting in a richer content experience for the customer and a more targeted advertising model. Such a distribution system as described above has distinct advantages over the cable and television distribution model by providing to the consumer both high speed broadband video/audio and interactivity through an associated web page.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the scope of the appended claims:

What is claimed is:

1. A method of inserting local digital data content into a stream of digital data multicast to a plurality of separate users who can access an Internet connection at least in part via an Internet backbone, the method comprising the steps of:
a) formatting digital data, including video information, in accordance with an IP protocol to generate IP digital data;
b) transmitting, in a relatively time-sensitive manner, the IP digital data from a transmission site to a remote Internet point of presence via dedicated one-way transmission bandwidth substantially separate from the Internet backbone;
c) multicasting the IP digital data from the remote Internet point of presence for delivery to a plurality of separate receiving Internet user apparatus connected to but distal from the remote Internet point of presence;
d) substituting local IP digital data originating from a local server at the remote Internet point of presence for at least a portion of the IP digital data from the transmission site, the local IP digital data being separate from the IP digital data from the transmission site; and
d) multicasting the substituted IP digital data from the remote Internet point of presence for delivery to a plurality of separate receiving Internet user apparatus connected to but distal from the remote Internet point of presence.

2. The method of claim 1 wherein the digital data of step a) includes video and/or audio information and the transmission of step b) is substantially a one-way data-flow transmission.

3. The method of claim 1 wherein the step d) substituting of local IP digital data is initiated by an event trigger command embedded in the IP digital data.

4. A method of inserting local digital data content into a stream of digital data multicast to a plurality of separate users, the method comprising the steps of:
a) receiving digital data for multicasting at a remote Internet point of presence;
b) multicasting the received digital data from the remote Internet point of presence for delivery to a plurality of separate receiving Internet user apparatus connected to but distal from the remote Internet point of presence;
c) substituting local digital data originating from a local server at the remote Internet point of presence for at least a portion of the received digital data; and
d) multicasting the substituted local digital data from the remote Internet point of presence to a plurality of separate receiving Internet user apparatus connected to but distal from the remote Internet point of presence.

5. A method of delaying digital data content multicast to a plurality of separate recipients, the method comprising the steps of:
a) receiving digital multicast data for multicasting at a remote Internet point of presence;
b) storing the received multicast data at the remote Internet point of presence; and
c) multicasting the digital data stored in step b) from the remote Internet point of presence after a predetermined delay for delivery to a plurality of separate receiving Internet user apparatus connected to but distal from the remote Internet point of presence.

6. The method of claim 5 wherein the delaying of received digital multicast data content is initiated by a command at the remote Internet point of presence.

7. A method of providing multicast digital data content to one or more separate recipients on demand, the method comprising the steps of:
a) receiving digital multicast data for multicasting at a remote Internet point of presence;
b) storing the received multicast data at the remote Internet point of presence; and
c) providing the digital data stored in step b) from the remote Internet point of presence to a recipient in response to a request command from the recipient to the remote Internet point of presence.
